(19) United States
(12) Patent Application Publication
(10) Pub. No.: US 2017/0316842 A1
(43) Pub. Date: Nov. 2, 2017

(54) Absolute Technologies Maximizing Cycled Energy

(71) Applicant: Svetozar B. Petrovich, Chicago, IL (US)

(72) Inventor: Svetozar B. Petrovich, Chicago, IL (US)

(21) Appl. No.: 15/731,310

(22) Filed: May 22, 2017

Related U.S. Application Data
(63) Continuation-in-part of application No. 14/545,930, filed on Jul. 9, 2015.
Application No. 14/545,930 is a continuation-in-part of application No. 13/999,086, filed on Jan. 10, 2014, now abandoned.
Application No. 13/999,086 is a continuation-in-part of application No. 13/135,617, filed on Jul. 11, 2011, now abandoned.
Application No. 13/135,617 is a continuation-in-part of application No. PCT/US2012/000188, filed on Jan. 25, 2010.
Application No. PCT/US2012/000188 is a continuation-in-part of application No. 15/330,085, filed on Aug. 2, 2016.
Application No. 15/330,085 is a continuation-in-part of application No. 13/999,105, filed on Jan. 13, 2014.
Application No. 13/999,105 is a continuation-in-part of application No. PCT/US2012/000572, filed on Dec. 6, 2012.
Application No. PCT/US2012/000572 is a continuation-in-part of application No. 15/530,056, filed on Nov. 28, 2016, now abandoned.
Application No. 15/530,056 is a continuation-in-part of application No. 15/330,085, filed on Aug. 2, 2016.
Application No. 15/330,085 is a continuation-in-part of application No. 14/545,930, filed on Jul. 9, 2015.
Application No. 15/330,085 is a continuation-in-part of application No. 14/545,930, filed on Jul. 9, 2015.
Application No. 14/545,930 is a continuation-in-part of application No. 13/999,105, filed on Jan. 13, 2014.
Application No. 14/545,930 is a continuation-in-part of application No. 13/999,105, filed on Jan. 13, 2014.
Application No. 13/999,105 is a continuation-in-part of application No. 13/999,086, filed on Jan. 10, 2014, now abandoned.
Application No. 13/999,105 is a continuation-in-part of application No. 13/999,086, filed on Jan. 10, 2014, now abandoned.
Application No. 13/999,086 is a continuation-in-part of application No. PCT/US2012/000572, filed on Dec. 6, 2012.
Application No. PCT/US2012/000572 is a continuation-in-part of application No. PCT/US2012/000319, filed on Jul. 11, 2012.
Application No. PCT/US2012/000319 is a continuation-in-part of application No. 13/506,098, filed on Mar. 27, 2012, now abandoned.
Application No. 13/506,098 is a continuation-in-part of application No. 13/136,140, filed on Jul. 25, 2011, now abandoned.
Application No. 13/136,140 is a continuation-in-part of application No. 13/135,617, filed on Jul. 11, 2011, now abandoned.
Application No. 13/135,617 is a continuation-in-part of application No. 13/068,587, filed on May 16, 2011, now abandoned.
Application No. 13/999,086 is a continuation-in-part of application No. PCT/US2010/000319, filed on Jul. 11, 2012.
Application No. PCT/US2010/000319 is a continuation-in-part of application No. 13/135,617, filed on Jul. 11, 2011, now abandoned.
Application No. PCT/US2012/000572 is a continuation-in-part of application No. PCT/US2012/000319, filed on Jul. 11, 2012.
Application No. PCT/US2010/000319 is a continuation-in-part of application No. 13/135,617, filed on Jul. 11, 2011, now abandoned.
Application No. 13/136,140 is a continuation-in-part of application No. 13/135,617, filed on Jul. 11, 2011, now abandoned.
Application No. 13/135,617 is a continuation-in-part of application No. 13/068,587, filed on May 16, 2011, now abandoned.
Application No. 13/068,587 is a continuation-in-part of application No. PCT/US2010/001379, filed on May 10, 2010.
Application No. PCT/US2010/001379 is a continuation-in-part of application No. PCT/US2010/000188, filed on Jan. 25, 2010.
Application No. PCT/US2010/000188 is a continuation-in-part of application No. PCT/US2010/000187, filed on Jan. 25, 2010.
Application No. 13/135,617 is a continuation-in-part of application No. 13/068,587, filed on May 16, 2011, now abandoned.
Application No. 13/068,587 is a continuation-in-part of application No. PCT/US2010/001379, filed on May 10, 2010.
Application No. PCT/US2010/001379 is a continuation-in-part of application No. PCT/US2010/000188, filed on Jan. 25, 2010.
Application No. PCT/US2010/000188 is a continuation-in-part of application No. PCT/US2010/000187, filed on Jan. 25, 2010.
Application No. PCT/US2010/001379 is a continuation-in-part of application No. PCT/US2010/000188, filed on Jan. 25, 2010.
Application No. PCT/US2010/000188 is a continuation-in-part of application No. PCT/US2010/000187, filed on Jan. 25, 2010.

(51) Int. Cl. G21D 3/00; G21D 3/10; G21D 3/04; G21D 3/14; G21C 11/08

(52) U.S. Cl. CPC G21D 3/001; G21D 3/14; G21C 11/08; G21D 3/04; G21D 3/10

(57) ABSTRACT

A super plant absolute technologies, comprising an ultra-transport system total energy of displacements embodied in electromagnetic fluids creep stiffness, cycle bulk power ultra-cycling light fluids by cosmological global gravitational dynamics conforming nullities, energy relativity structures, a relativity energy, a minimum energy balancing, a minimal energy displacement and:
a reactor to and from steam generators (SGs) primary coolant loops piping, Regions 1;
Regions 1, radial inline hot legs from the SG to turbines, condenser units, return to the SGs, cold legs, secondary coolant loops Regions 2;
a containment, an annex building Regions 3;
cooling water cycling gravitational field, the hydrosphere Regions 4;
bulk power electrical distribution Regions 5;
and opposing global air warming, effecting Heat Rate maximum efficiencies of the ultra-transport system and Regions 1-5 ultra-longevity boundaries an ultra-fluxing, an ultra-conserving the bulk power, the mega bulk power sustaining a boundaries perfection.

### BACKGROUND OF THE INVENTION

Nuclear power utilization, ultimate energy conservation can potentially save life on Earth. “Global warming” cosmological roots are not understood. Applied science technologies explain. The Universe cosmological gravitational dynamics cycle plasma. Earth gravitational field cycles light molecular fluids and plasma. The light molecular fluids, the plasmas cycle incompatibly; in time domain, Earth gravitational field energy dynamics climate changes outflow plasma to space.

First and foremost, the Universe, the Earth are essentially energy device precise cycling the light fluids energy wherein the Earth's light molecular fluids cycling supports life and sets up the light molecular fluids, the plasmas energy transports longevity issues respective incompatible cycling.

A nuclear power plant, the Earth and the Universe embody similarities, comprising inventions or applied science innovations, and theoretical sciences understanding cosmological energy cycling. It turns out with extraordinary regularity, theoretical science theoreticians misconstrue cycling of the cosmological gravitational dynamics; at advent of science because not much is known; in last eight decades, because elite theoreticians ‘do know better’ by ignoring fundamental Laws. In the meantime, the applied science practitioners languish motivated by—good enough is good enough.

Earth life existence cycling molecular fluids imperfections faces a challenge by the cosmological gravitational dynamics cycling plasma fluids flux unyielding mass energy insistences on absolute perfection. Applied sciences absolute and unprecedented par excellence technologies perfection, and on par with those of theoretical science best, offers the life existence imperfections a chance.

“We choose . . . and do the other things, not because they are easy, but because they are hard . . . . The greater our knowledge increases, the greater our ignorance unfolds . . . ” Inventions innovation and declarations support that. A decade is a very long time and most likely time ‘We’ have, also.

### SUMMARY OF THE INVENTION

A super plant absolute technologies, comprising an ultra-transport system total energy of displacements embodied in electromagnetic fluids creep stiffness, cycle bulk power ultra-cycling light fluids by cosmological global gravitational dynamics conforming nullities, energy relativity structures, a relativity energy, a minimum energy balancing, a minimal energy displacement and:
a reactor to steam generators (SGs), primary coolant loops radially inline piping hot legs to the SG, cold legs return portions inside a primary containment, comprising Regions 1;
the reactor, primary coolant loops piping Regions 1, radial inline hot legs from the SG to turbines, condenser units to the SGs, secondary coolant loops cold legs return, Regions 2;
a containment, an annex building a light negative pressures Regions 2 portion, Regions 3;
cooling water cycling gravitational sink, the hydrosphere, mega bulk power in Regions 4;
and bulk power electrical distribution and epigene environment cycled energy, Regions 5; and means for opposing global air warming, effecting Heat Rate maximum efficiencies of the ultra-transport system and Regions 1-5 ultra-longevity boundaries an ultra-fluxing, an ultra-conserving the bulk power, the mega bulk power sustaining a boundaries perfection.

These: Hydrogen, Helium, Nitrogen, Oxygen atomic weight 1, 4, 14, 16 form light fluids and water, water vapor or steam molecular weight 18, in mixtures of 78% nitrogen, 21% oxygen, and nigh 0.04% of CO₂ and other gases and the nitrogen, oxygen, water based molecules and ions, in mass with energy mixtures engendering cycling nullities, including radiations, in space and time. In the ultra-transport system, claiming very high efficiencies Heat Rates excludes the reactor, the SGs, the high pressure pumps, the turbines, the condenser units, secondary piping coolant loops a cold legs return and pump house pumps, which all of mechanical machinery fabricating imposes. Primary, secondary, coolants are the light fluids water threated, processed, specific compositions. A tertiary mega bulk power cycling coolant loop gravitational field cycled fluids in environment. The Regions 1, the Regions 3 comprise the containment building annexing of the annex building. Epigene surface, atmosphere, ionosphere, magnetosphere embodies the mega bulk power fluxing and cycling by underground aqueducts, effecting the Regions 4 boundaries in space time domain; Geographical areas Regions 5 portion fluxes gravitational sink mass energy and electrical power; gravitational sink, mass energy potential bounds the mega bulk power. An electromagnetic fluid, the electromagnetic fluid, the electromagnetic fluids, and the fluid are, herewith, all synonymous.

Cosmological gravitational dynamics, nonradioactive atomic elements ultra-conserve energy, mass to ultra-retain subatomic particles eternal longevities absolute boundaries absolute spinning and cycling of electrons mass about nuclei. Conversely the radioactive atomic elements emitting quantum energy through atomic boundaries spawn cycling mass and energy half-life phenomena.

The ultra-longevity boundaries binds the light fluids within the boundaries perfection cycling energy in gravitational fields. The cosmological gravitational dynamics cycle and flux energy of everything infinities upon infinities, comprising quantum paths-of-passage (PP) lengths of the PP lengths least sum (PPLLS) nullity, the PPLLS nullity sum. The boundaries perfection constitutes compiling all of quantum all sums of nullities, constituting respective mass quantal quanta which spawn the ultra-fluxing, the ultra-cycling mass energy sums' nullity, nullities nullity, the nullities nullity, the nullities' sums, which effects the bulk power respective Regions 1, Regions 2 and the mega bulk power cycling in the energy relativity structures in the stratosphere boundaries and the magnetosphere. The cosmological gravitation dynamics, the First (FL) and the Second (SL) Law of Thermodynamics (FSLT) science reaffirm the ultra-longevity boundaries comprising nullities.

Each quantum flows directionality lengths' cycling energy, bound in the paths-of-passage lengths (PPLs), compiling the PPLLS entirely reliant on energy of the ultra-cycling and the ultra-conserving and the ultra-fluxing. The PPLLS entirely reliant unique compiling inside boundaries yields atoms, Ions and Isotopes, which in individual, joint and in common compiling in the ultra-longevity boundaries embody any of the energy relativity structures or the boundaries perfection.

Advanced and fundament Fluid Elements, mass energy highest conserving (MEHC), the MEHC, energy environment effects the ultra-longevity boundaries, the boundaries perfection to cycle the Universe in absolute conformance to the FSLT, the cosmological gravitational dynamics cycling the nullities' sums. the super plant absolute technologies, the super plant, cycling the bulk power, the light fluids cycling the nullities nullity to the ultra-longevity boundaries sequent cluster as the fundamental Fluid Elements Regions 1-5 as the Advanced Fluid Elements, Advanced Processors, the Universe celestial bodies do energy to the ultra-fluxing, the ultra-cycling of the sums' nullity.

Gravitational fields, gravitational sink grids with associating magnetic fields concomitant energy sources and sinks cycling energy and radiations with radiations wind pressures comprises individually, jointly and in common the ultra-conserving mass energy nexuses which embody the relativity energy, embodying Newton's universal gravitation proportional energy in the Universe, between any two and all mass energy quanta and mass energy nexuses, including Black Holes; in all instances, the quanta, the nexuses and Black Holes effect the boundaries perfection respective eternal longevities which start with atoms and electrons and ends with Galaxies mass and energy.

In all instances, energy of displacement and volume change stay undefined unless elastic deformation and volume change plastic distortion are defined and structure or system boundaries are defined. In the Universe space time domain quantifying that energy is an impossibility; even for a simple structure, it is cumbersome. However, recognizing its presence is entirely sufficient.

The prior art preferred methodology computes materials elastic range stresses, accounting indirectly for energy. Herein declaims the applied sciences energy technologies simplest account by omitting article ‘the’ in front of ‘energy of distortion and volume change’ as undefinable mass energy volume flux until the ultra-longevity boundaries or the boundaries perfection mass energy and volumes make that energy quantifiable; many occurrences in Nature vary continuously, such as cycling directionalities, energy gradients. In turn, mass energy, volume and pressures on fluid boundaries by interactions energy—the relativity energy—is displacements energy quantifiable; at interfaced boundaries, design fluids balance displacements energy by independent and calibrated energy sources balancing energy of the interactions energy which embodies the minimum energy balancing and the minimal energy displacement. Herein structure technologies balance the ultra-transport system by configuring energy in displacements effected by the relativity energy effects.

In Regions 3, in situ measurements account for each in situ construction deviation, which by itself is a very important advancement over the prior art. The minimum energy balancing and the minimal energy displacement is time domain present energy cycle and in situ measured, only, and their quantified presence indispensable, as ensuing further explain. Likewise, the light fluids impurities concentration fluxing deposited by such energy forms merit no definitive article ‘the’.

The minimum energy balancing, the minimal energy displacement collective sums equals Newton's universal gravitation proportional energy, the universal gravitation proportional energy force between two celestial bodies, the universal gravitation proportional energy attraction forces in space environment. In the Earth, the super plant common terminology analogy quests think of the primary coolant loops as the troposphere, the secondary coolant loops and the tropopause, the stratosphere as the containment building a dome wall thickness and magnetic field's cusps as two safety valves, and elastoplasticity of the stratosphere correlating to the design fluids mass energy.

Then, terminologies of the minimum energy balancing, the relativity energy pertain to the ultra-longevity boundaries, the boundaries perfection distinctive relativity energy domains, in the Advanced Processors, the super plant; the former is natural, the latter is to herewith technologies, one and the same technologies, the former, the latter cycle plasma, molecular fluids, respectively. Paragraphs' pertaining to one or both domains cite the terminologies in respective domains cited.

Universe two celestial bodies and the super plant embody terminology analogies. One or both of the two celestial bodies, comprising the relativity energy inside the boundaries perfection larger mass and energy, can comprise any number of celestial bodies embodying a common mass energy centroid, their invariable disk plane angular momentum. The primary, the secondary high energy piping coolant loop, cycling the bulk power ultra-cycling light fluids' nullities, effects the interactions energy, the relativity energy, the minimum energy balancing and the minimal energy displacement, which unify and bolster overall integrity of the ultra-transport and all of Regions 3.

The relativity energy is the interactions energy; it equals cumulative sums of the minimal energy displacement and the minimum energy balancing. Emplace electromagnetic composition design fluids, the electromagnetic fluids, embody all of Regions 3 elastoplasticity displacements, which, in turn, effect the minimum energy balancing and the minimal energy displacement. Said terminology analogy correlates the electromagnetic fluids and magnetic lines reconnect portions; herein, the electromagnetic fluid, the electromagnetic fluids, or simply the fluid are synonymous.

The relativity energy spawning tridimensional space infinities energy field of the interactions energy comprising interactions-lattice energy flowing plasmas and radiations and wind pressures energy spawns the relativity energy. An interactions lattice with an inter-reactions lattice relative energy actions, relative reactions relative inter-reactions yields everything levitating in space, the Universe comprising first and foremost the boundaries perfection energy cycling energy devices.

In space, everything levitates, cycling energy of the nullities' sums, within the boundaries perfection, initiated by atoms and molecules, continuous in galaxies and galaxies clustering. The scientific community curving space time mechanisms in the tridimensional infinity's energy field of the relativity energy, the relativity energy field, cannot exist, especially at interfacing of and in specificities of the boundaries perfection, thru continuous clustering of the boundaries perfection.

The cosmological gravitational dynamics, the energy relativity field spawning the energy directionalities are effecting the ultra-longevity boundaries, the boundaries perfection of celestial bodies, concomitantly effecting infinities upon infinities of concomitant energy algorithms which by ubiquitous plasmas flowing palliate the energy peaks into energy of the relativity energy field. All such embody supreme energy in Nature comprising the cosmological gravitational dynamics.

Here, the terminology analogy pertains to science and the absolute technologies to an MEHC absolute conserving effecting the cosmological gravitational dynamics, the relativity energy field energy which, in turn, spawn the boundaries perfection, also. Said supreme energy in Nature, the cosmological gravitational dynamics, concomitantly palliate the relativity energy peak of Earth's gravitational sink to re-impose the MEHC absolute conserving in gravitational sink mass energy.

AGW energy abstracting the MEHC absolute conserving in Earth's gravitational field is most basic fundamental and root cause of global air warming, energy phenomena among many energy indications of deficient energy cycling thru Earth's gravitational sink, including plasma outflows. the energy indications exist, since flaws in the prior science obfuscate existence of the Advanced Fluid Elements and the relativity energy, which embody the absolute technologies many facets of global warming root causes the prior science amiss. Intelligence must minimize the gravitational sink, relativity energy peak, the relativity energy peak, by the MEHC an absolute conserving, the MEHC, the absolute conserving, embracing the absolute technologies the prior art entirely amiss.

Globally, corporate and scientific communities could not have selected less preferred devices than solar panels and wind turbines to combat global air warming. These devices block, obstruct cycling energy cycling inflowing into gravitational sink and epigene surfaces mass. In fact, such devices, by nigh entirely sapping cycling energy and converting it to electrical power, oppose the MEHC, the absolute conserving, and the gravitational sink cycling energy in environment, which magnify concomitantly insolation energy. An opposing of the MEHC or the absolute conserving of energy boosts the relativity energy, the relativity energy peak, comprising locally the relativity energy field energy pool, the relativity energy peak local peak and impurities concentration; each and all effects extremely harmful global environment, which, in turn, warrants immediate action.

Tridimensional infinities' energy field of the relativity energy field has voids and vacuum and energy peaks, concomitantly spawning sources, sinks and Black Holes. The celestial planets gravitational sinks may affect the relativity energy peak rounded summit by cycling energy about respective gravitational sinks, as the tropopause does. Energy flowing flows, as fluid, away from such summits; and, that energy, the relativity energy portion, outflowing the Earth's gravitational sink global air warming spawns, in spite of Earth's energy budget 5% to 6% radiation into space.

In time domain, days' durations lengthen, from 19 hr to 24 hr; likewise, the Moon continues to spin away from the Earth, comprising prima facie credibility that the Earth's gravitational field is weakening. In turn, Earth's spin slowing, energy decreasing, unavoidably weakens the magnetic field. In turn, the relativity energy, the plasma fountains outflowing mass energy directionalities, which are orthogonal to those cycling inside the troposphere and the tropopause, spawn mass and energy cycling that saps energy from the energy directionalities effecting the gravitation sink. In turn, cycling slowing rate magnifies insolation energy, which, in turn, effects global air warming.

The relativity energy field during the Milankovich cycles show the early Pleistocene time domain the relativity energy, comprising the energy directionalities compiled energy consistently quantifies quanta which break from Earth's gravitational sink at 41 ka frequency. Energy cycling solely about Earth's gravitational sink free of outflows plasma energy directionalities that oppose that cycling boosts the light fluids cycling rates. The troposphere, tropopause accruing insolation energy attenuates and impurities concentration drop, which, in turn, initiates the next 41 ka cycle. Milankovich cycles, plasma fountains, Earth's spin, Moon-Earth separating and cycling the light fluids soil deposits structure, impurities concentration show the cosmological global gravitational dynamics, the relativity energy field, the MEHC, the absolute conserving, and the nullities' sums balancing mass and energy, all show the energy relativity is the root cause of global air warming.

Curved space time must set forth and define a curved space energy displacement a needed minimum energy balancing or parameters of choice. And, define and set forth curved space time curvature slope sustaining means, sustaining in, across the boundaries perfection from atoms thru the boundaries perfection of gravitational sinks, galaxy clusters a curved space time energy field.

Otherwise, curved space time is imaginary theory, promulgating a generally less dynamic fluxing of the Universe, which the prior sciences theorize. Here, presented global air warming as the prima facie credibility which declaiming fundamental and applied sciences point to deep and profound flaws in the prior sciences, the applied art. That art especially exemplifies granted and condoned wind turbine, solar panel archaic technologies, jutting out as deeply flawed contestant.

The MEHC absolute conserving governs the ultra-cycling, the ultra-conserving, effecting the boundaries perfection, the relativity energy, and the absolute technologies. These five aspects of the MEHC in Regions 3 effect ultimately shortest tridimensional loop lengths, the ultra-longevity boundaries, the boundaries perfection cycling the nullities' sums ultimate energy transfers by the light fluids. The three, the MEHC absolute conserving effects cumulative mechanical, electrical efficiencies maximum efficiencies of Regions 1-5 inside the troposphere, tropopause boundaries.

The electromagnetic fluid elastoplasticity deforming spawns the relativity energy in the ultra-transport system of Regions 3, which bolsters Regions 3 integrity. Thereby, the relativity energy generated by the ultra-transport system entirely complies with the bulk power cycling maximized light fluids energy transferring efficiencies and concomitant boosting Regions 3 overall integrity.

The Regions 1 comprise the nullities nullity of the bulk power cycling the light fluids cycling coolant in primary loops. Regions 2 comprise cycling the bulk power transfers from the primary coolant loops to turbine, condenser units' coolant cycling the bulk power in the secondary loops. Regions 3 comprises the containment and the annex buildings an HVAC system circulating air to the light negative pressure. The Advanced Fluid Elements the celestial bodies as exemplified by Earth's magnetosphere and atmosphere spawn the energy relativity structures, the ultra-longevity boundaries of the Advanced Fluid Elements and respective energy of the troposphere, tropopause and the stratosphere, which levitate, balancing in the cosmological global gravitational dynamics.

The First Law states that in energy systems mass energy cannot be created or destroyed. Any system affecting the boundaries perfection, the ultra-longevity boundaries yields a closed system. Technicians' referral to ‘renewable energy’ are deeply and profoundly flawed. Any definition of a ‘renewable energy’ systems boundary is undefined, since energy is not creatable, renewable, or recyclable. Even the cosmological gravitational dynamics frictionless media cycles energy, only.

It is certain that Einstein's Relativity Theories et al. and Newton's Gravitational Theory et al. violate the Laws of the Thermodynamics as these cosmological Kafkaesque mass energy theories mislay energy paths, sources and sinks diversity. Newton misplaces, Einstein misapplies, United Nations IPCC disregards and CERN project mislays, all amiss, the Second Law applied sciences.

Sir Arthur Stanley Eddington wrote “The law that entropy always increases holds, I think, the supreme position among the laws of Nature. If someone points out to you that your pet theory of the universe is in disagreement with Maxwell's equations—then so much the worse for Maxwell's equations. If it is found to be contradicted by observation—well, these experimentalists do bungle things sometimes. But if your theory is found to be against the second law of thermodynamics I can give you no hope; there is nothing for it but to collapse in deepest humiliation.” Unless said cosmological gravitational dynamics technology imposes absolute and ultra-maximal mechanical and thermal efficiencies to globally applied sciences, the collapse turns into extinction of species. Only Tesla's sciences breeds hope, as the Newton-Einstein Theories contaminates all associating applied science technologies with same, deep, profound absolute flaws, toward ends of no return.

Einstein at al. curved space time theorizes a homogeneous, uniform system unitary Universe; otherwise mass energy circulations results from dense to less dense mass energy, from sources to sinks of mass energy that require counter balancing circulations. This application nexuses reveal mass and energy boundaries perfection and the ultra-longevity boundaries, from atomic elements to the Advanced, the fundamental Fluid Elements, and the ultra-longevity boundaries of Systems and Galaxies balancing dispositions which absolutely conserve energy. The atomic elements, the Fluid Elements complete complement clusters cycle, flux, and balance the Universe mass energy nullities to sustain cosmological energy with mass Universe enormously dynamic levitating state.

The nullities of mass energy cycling do interrelate, associate within the boundaries perfection and can accelerate decelerate inside the ultra-longevity boundaries by pressures in the light fluids or plasma densities and by configuring balancing dynamics to repositioning dispositions, on both sides of the boundary perfection, which flux complete complements of the boundaries perfection. The prior Theories art, especially the theorized four dimensional coordinate system curved space time, stunning jaw dropping Kaflcaesque fundamental envisioning the cosmological gravitational dynamics goes against sciences core kernels in the Laws and Principal Theories applied sciences.

The atomic elements and the Fluid Elements constituting the ultra-longevity boundaries bares cycling dynamics unusual fluxing deformations enormous energy in light fluids boundaries. The Fluid Elements, the boundaries perfection disclosing existences of the ultra-longevity boundaries disclose the cosmological gravitational dynamics which are missing in quantum energy sciences.

Dynamics of the light fluids, especially plasmas spawning the ultra-longevity boundaries and magnetic field boundaries, cycles in reactions to gravitational sinks energy in environment. And, cycling energy dynamics system in magnetic, cosmological gravitational field cycles energy flow analogous to flowing fluids as if by massless radiation means. In environment, energy dissipates as propagating fluids densities are dissipating; all of which the prior Theories and the art ignores.

Energy in environment superimposed dynamics (EESD), the EESD, in omnipresence utilizes relentlessly gravitational dynamics cosmological balancing of mass energy; likewise, embodying energy of vaporization, of sublimation and of freezing, melting, of condensation, deposition, and of ionization, recombination spawn phases changing thermal-energy processes from solid state to plasma state. These processes effect buoyancy, combustion, erosion, friction, gas emissions, and stratifications, gradations processes that also affect dissolution of the boundaries perfection in the Fluid Elements and Advanced Processors. AGW belongs in dissolution category as a newcomer.

The cosmological gravitational dynamics engender the energy relativity field, the MEHC, the absolute conserving of mass energy at the magnetosphere boundaries. Earth's gravitational field, sink, nowhere duplicated in the Universe, cycles the light fluids to rebalance itself and spawn the ultra-longevity boundaries of the magnetosphere boundaries, which, likewise, embodies reaction to insolation radiation energy penetrating the atmosphere and said energy requirements acting on the boundaries. The prior paragraph cites insolation energy reactions, which, likewise, embodies energy that in all respects yield energy environment in the magnetosphere boundaries, the EESD.

The prior sciences theorizing Milankovich cycles in the Pleistocene Epoch switching into present ecliptic primary frequency nigh 125 ka is flawed. In fact, switching primary frequency to 21 ka precession frequencies occurs. Since AGS emits enormous energy into environment, in the last centuries, cycling rates in the gravitational sink slow to effect plasmas outflow sooner. Now, magnetic field cups appear to persistently outflow plasma. All cycling comprises the MEHC, the absolute conserving of energy; energy cycling effect two dominant directionalities: within or out of Earth's gravitational sink. The letter is global air warming root cause effects of the root cause, and most, if not all energy emissions at least at emission points, impose the letter directionalities.

Wind power ‘renewable’ energy siphons the cosmological global gravitational dynamics, the EESD in environment energy which is cycling fluids. Slowing cycling coolants flowing rates, in gravitation sink environment, slows cooling of that environment. The cosmological gravitational dynamics, the ultra-conserving of environment energy, cycles the light fluids, the nullities' sums. In fact, at high altitudes heat of condensation escaping to space thru thermal transparencies of the stratosphere, actually radiating heat of evaporation into space, effectively cools epigene surfaces.

Emission cuts in CO₂ is justified, indeed. Yet, solar panels electrical power generations stops radiations inflow into epigene gravitational sink, magnetic field core, which eternally drains both energy fields. Unless energy inflows gravitational sink epigene, it effects the EESD directionless energy sapping the ultra-longevity boundaries, the boundaries perfection of Earth's energy fields. AGW vagabond energy opposes cycling fluids, cycling energy innate directionalities into Earth's gravitational sink, in turn, generating the relativity energy peak in the energy relativity structures.

Disclosure of the light fluids engendering longevities of the boundaries perfection reveals the MEHC innate self-sustaining genres and innate spawning of the ultra-longevity boundaries of the Advanced, the fundamental Fluid Elements. Only, the light fluids, plasmas effect the boundaries perfection of the light fluids; avoiding the atmosphere utilization as the gravitational sink is most important wherein a limited opposing of the cosmological gravitational dynamics in time domain can turn deadly. Wind turbine and solar panel technologies appear to take exactly such a chance.

It is disappointing and very disturbing that for seven decades profoundly flawed gravitational theories are touted by theoreticians in face of notable very fierce very valid opposition. Wherein, and clearly, solutions to the science of cosmological gravitation entirely depends on revelation of the Advanced, the fundamental Fluid Elements. Sciences climate change vitalities depend on the ultra-longevity boundaries of the light fluids. Disclosing sciences of the Fluid Elements resolves not only the cosmological gravitation but applied sciences of the Theory of Uniformity and, also, the applied science Theory of Everything declaiming the climate change very issues many facets.

The applied science Theory of Everything and Theory of Uniformity yield key to all theories. The fundamental and the Advanced Fluid Elements with Atomic Elements hold scientific keys to the Theory of Uniformity. While electron current flows as fluid, in atoms electron spin is eternal about the nuclei; everything bounding eternally mass and energy yields the boundaries perfection of atoms. The Universe mass and energy nullities reverberate, cycle and evolve deformation and volume changes energy which spawns the boundaries perfection clustering of the Fluid Elements and the Advanced Processors. None of the prior Theories science and art conform; by theorizing curved space-time, in general, assails the supreme laws of Nature, the First and the Second Law.

Claimed clean renewable energy generation in environment, in fact, utilizes cycling energy in environment, which is absolutely perfect in every respect and constitutes the MEHC proven Heat Rate of 100% efficiency through billions of years. That energy, in fact, is energy of cycling that balances energy of all nullities, the nullities, effecting the magnetosphere spawned global climate temperatures in environment. The compositions of the nullities cycling in environment normally comprises the light fluids in excess of 99% and CO₂ of 0.3% to 0.4% and other impurities, whose energy effects the EESD cycling globally the nullities' sums. Effects by the cosmological global gravitational dynamics that affect causes and effects, which yield balances of the cycling nullities and their interactions show 0.01%-0.02% CO₂ concentration changes cannot embody such energy.

Collectively, technocratic dispositions take for granted the magnetosphere magnetic lines and epigene surfaces. Thus, generating the ‘clean renewable energy’ by wind turbines or solar panels takes for granted the EESD, the cycling energy by environment; which, in fact, consumes energy sustaining the cycling nullities, the cosmological gravitational dynamics affecting the boundaries perfection of the atmosphere. Cycling nullity as such effects perfection, and all energy spawning energy sum of the cycling nullity should not deviate from nullity, as such imperils the boundaries perfection. The cycling nullity of energy cycling in the magnetosphere affects climate perfection that affects and sustains life and is only known place in the Universe that can claim that paragon.

Testing ‘renewable’ against the First, Second Law reveals that the wind turbines, solar panels consume 100% efficient power committed to the ultra-fluxing the magnetosphere and cycling the nullities' sums. The testing reveals that the wind turbines, solar panels generate electrical energy from energy balancing the nullities' sums and the boundaries perfection of everything, sustaining boundaries of magnetosphere magnetic lines and epigene surfaces. Stunningly instantaneous and unbelievably enormous displacements of boundaries constituting the magnetosphere disclose that energy in environment through stratified layers of the atmosphere enormously magnifies itself by quantum energy accuracies, especially and specifically evident at constraining boundaries. In the art of air conditioning, lowering cycling rates in closed environment are known to effect a slower cooling of that environment. Performance of the wind turbines, solar panels blocks all or almost all flowing energy conforming directionalities of the cycling nullities, thereby, causing the EESD in environment generated 100% flowing energy byproduct nonconforming cycling directionality.

All planets, with any type of atmosphere, exhibit energy cycling issues. Glaciation effects of each and every geological epoch, epigene surface features including the magnetic field's shifting its disposition, point to the EESD and the cosmological gravitational dynamics cycling of energy violent effects associated with unbalances in energy cycling. Very discouraging, disappointing is the wind turbines, solar panels selections to oppose global air warming when their Heat Rates are moderate to poor, while blocking instead of facilitating energy cycling that tempers environment.

Proven by billion-year longevity, the magnetosphere effects mass energy cycling nullity upon nullity fauna and flora chain upon chain of cycling nullities perfection. The prior art's ‘clean and renewable energy’ claims is deeply, profoundly technocratic, in fact, consuming absolutely clean natural cycling processes environment energy, dedicated to sustain life and climate perfection, to generate electricity. Stunningly all of that the First and Second Law absolutely clearly denounce.

Physical and chemical exoergic, exothermal and endothermic actions and reactions which evolve, occur and subside and cycle in and out of existence, including winds and wind pressures, radiations and radiation pressures spawns the EESD in environment. Wherein, the cosmological gravitational dynamics gravitational sink and magnetic field environment self-conserving effects, the MEHC, ultra-conserving genres of the light fluids engender the ultra-longevity boundaries of the boundaries perfection whose infinity upon infinity of diversities constitute cycling nullities of the PPLLS sums that spawns cycling nullities sum that is the PPLLS nullity sum of the Universe.

The EESD engenders reactions in genres of the boundaries perfection, which occur or evolve or lessen entelechy of the ultra-longevity boundaries yielding cycling chains of actions, reactions associated with the boundaries perfection and which embrace the atomic, the Fluid Elements and the Advanced Processors. Physical and chemical parameters and genres associating with actions and reactions exposed by the Earth's glaciation geology and the gravitational and magnetic fields magnetosphere fluxing confirms solution to the Uniformity Theory, known as uniformitarianism. The uniformitarianism in inorganic and organic domains is the Theory of Everything solutions in the applied sciences of the ultra-longevity boundaries of the boundaries perfection. The above in applied sciences embraces declarations in Cosmological principles, which, then, embrace Earth's light fluids cycling in/to the boundaries perfection and in/to three gravitational sinks: the Earth's, the Sun's, and the Galaxy's. The Earth loss of the light fluids endangers life on Earth; a research undertaking estimates a forth of Earth's water, thus, more than one atmosphere is lost into space.

In bounding sources and sinks, a mass energy balancing of balancing everything engendering quantum mass energy PP in and from sources into and in mass energy sinks yielding a sum of the PPLLS of quantal mass quanta energy transport from source to sink ultra-conserves mass energy. Regions 4 and 5 cycle, flux the light fluids, the PP quantal mass energy nullity, the MEHC of the PPLLS entire length, the ultra-longevities boundaries of the boundaries perfection portions of the ultra-transport system, the PP cycling the nullities. The super plant, Regions 1 and 2, the radially inline piping hot legs controls a self-alignment of the ultra-transport system by wind cone effects granted electromagnetic fluid a creep, a stiffness, displacement response to electrical power input granting the creeping, the stiffness by the electromagnetic fluid in an electromagnetic transducer, the minimum energy balancing of the relativity energy, and the ultra-longevity of the super plant; Henceforth, electrical power input, calibrated electrical power input, transducers power input and power input in all instances refer to calibrated electrical power input, synonymous terminologies.

The displacement response to electrical power input, comprising the fluxing total displacements, effecting the minimum energy balancing of the relativity energy, by spawning the stiffness in the electromagnetic fluid nigh infinitesimal confined creep yield the ultra-longevity of the super plant, the ultra-transport system by effecting dynamic loads damping.

Strengths of materials technology defines elastic, shear, and bulk moduli, which sets forth interactions among loads, stresses, strains and displacements. The minimum energy balancing of the relativity energy retain low static stresses and dampen, to entirely suppress, dynamic loads by the electromagnetic fluid's stiffness creeping which grant Regions 3 structure the ultra-longevity.

In applied art theoretical mechanics, energy of displacement and volume change technologies sets forth strains and deformations. The prior art uses ultimate load and/or working stress design of structures. Here, displacements and strains measured entelechy as it occurs reveals and yields the super plant very simplicity. Controlled temperature, pressure and stress energy ranges, creep and deformation energy of distortion and volume change, in the super plant, comprise equipment minimum stresses steady state in environment and energy of distortion and volume change as the light fluids cycling the nullities' sums mechanical, electrical highest efficiency Heat Rates, while slight negative pressures spawn the ultra-longevity, the ultra-conserving of Regions 3. Structures stresses effect the minimum energy balancing, invaluable interaction stress imposing energy flux that elastic displacement volume change of the containment and the annex building, the buildings cluster, which spawn the ultra-longevity of structures. Transducers convert a calibrated electrical power input into the electromagnetic fluid stiffness, creeping, volume change energy yielding the minimum energy balancing, the minimal energy displacement of the ultra-transport system to the electromagnetic fluids retained energy and the ultra-conserving, the ultra-longevity of Regions 3.

The minimum energy balancing Regions 3 constitute the ultra-transport system, the buildings cluster interactions balance by electromagnetic transducers effecting and fluxing electrical power electromagnetic fluid inputs, which engender the ultra-fluxing and the ultra-cycling and the ultra-longevity Regions 3 boundaries change of the ultra-transport system. The electromagnetic fluids varying stiffness restricts the minimum energy balancing in the ultra-transport system, Regions 3 to nigh 0.10% of yield stress nigh an order of magnitude less than in the prior art; backstops limit entirety of electromagnetic fluids' displacement and volume change; the fluxing power input, the electromagnetic fluids optimal stiffness relative yield strength dampens all cyclical stresses to the minimum energy balancing that effects the ultra-conserving, the ultra-longevity of the Regions 3.

The electromagnetic fluids stiffness, creeping and volume change retains the relativity energy in Regions 3 comprising displacement energy above the minimum energy balancing, the minimal energy displacement relative sum, which the calibrated electrical power input continually retains; the minimum energy balancing, the relativity energy, Regions 3 bulk power, Regions 5 meg bulk power energy transfers flux the ultra-conserving, the ultra-longevity in the boundaries perfection, including electrical energy, in the ultra-longevity, the ultra-conserving Earth's gravitational field.

Said MENC, absolute conserving, ultra-conserving and self-conserving denoted mass energy always refers to the ultra-longevity boundaries or the boundaries perfection of atoms, molecules, and the fundamental, the Advanced Fluid Elements. The Fluid Elements, entirely missing in the prior sciences, thus, art reveals in both fatal flaws, which further aggravated by disregards of the First, Second Law threatens potential global civilization absolute, stunning, merciless extinction.

The supreme laws of Nature, likewise, declaim the applied sciences, the relativity energy, and the Fluid Elements fundamental sciences sole sciences technologies innately opposing global air warming effected by the cosmological gravitational dynamics. Said technologies of the Fluid Elements heedfully shift entelechy from the prior art ultimate loads or allowable stress designs of structure to technologies imposed realities of the cosmological global gravitational dynamics and EESD environment energy, the energy relativity structures, the minimal energy displacement, the minimum energy balancing spawned by the relativity energy. All these, in turn, remove the prior sciences' technologies profound flows, declaim fundamental sciences in Milankovich cycles, and yield structure technologies entelechy in environment of the EESD to oppose global air warming.

The self-alignment of the ultra-transport system by wind cone effects comprising the self-alignment spawns absolutely highest energy conserving in the ultra-transport system Regions 3 and engenders absolutely highest Heat Rate mechanical, electrical efficiencies.

The super plant technologies, effect the light fluids the ultra-cycling by the cosmological global gravitational dynamics conforming nullities to energy of fluxing total displacements embodied in electromagnetic fluids creep stiffness, the energy relativity structures, the relativity energy, the minimum energy balancing, the minimal energy displacement, the ultra-longevity boundaries, the ultra-fluxing, the ultra-conserving mass energy yielding the boundaries perfection and means for opposing global air warming comprising PMII, FEIIPMII technologies.

The super plant absolute technologies of the boundaries perfection of the Advanced Processors clustering the Fluid Elements and principles, methodologies, inventions, and innovations (PMII), the PMII and the Fluid Elements, Ions and Isotopes (FEIIPMII) applied science PMII, FEIIPMII technologies effect the cosmological gravitational dynamics, the MEHC absolute conserving, the nullities' sums cycling the light fluids by the minimal energy displacement, the minimum energy balancing of the relativity energy in the ultra-longevity boundaries and the boundaries perfection.

The minimal energy displacement, the minimum energy balancing of the relativity energy of the light fluids cycling respective energy in the boundaries perfection, the PMII and FEIIPMII technologies quantify in Regions 3; in the boundaries perfection of epigene surfaces fluids, solids phases, epigene erosions and depositions, ocean tides and volcanic eruptions tectonic movements occurs. Within the boundaries perfection of the troposphere, tropopause and the stratosphere, the magnetosphere the light fluids respective cycling, which, likewise, bulge along with the tides and plasma outflow, are individual common effects. All of which flux the Universe energy dynamics make up, as ultimate fluid flowing from peaks of the relativity energy into gravitational sinks and planets as potential peaks with stars as the peaks. The relativity energy in all shows Earth's light fluids ineffectively cycling insolation and AGW emissions energy into Earth's gravitational sink.

Henceforth, ‘greenhouse effect’ refers to Magnification, Magnification factors insolation energy as heat energy that accrues, magnifies, in the tropopause, troposphere volumes, measured rising temperatures, due to the light fluids inadequate cycling heat transfers into epigene surfaces of gravitational sink. Again, very variable energy, omitting ‘the’, and capitalizing the lead letter.

In the late Pleistocene Epoch, with glaciers retreating, insolation Magnification intensify, and in the last three centuries AGW energy emission multiplies, activating Milankovich cycles at 21 ka dominant frequency, rather than scientific community theorized 125 ka frequencies. In fact, presently, leaking plasma sporadic outflowing thru the North Pole cusp places the Earth in a peril of losing the light fluids and water, which Mars epigene has suffered. Energy outflowing reveals the relativity energy cycling least effectively the light fluids is first to distribute the light fluids of the boundaries perfection into the boundaries perfection having larger boundaries of gravitational sinks. In time domain, such show Earth's gravitational sink light fluids gained from Mars's loss.

The PMII technologies effect fundamentals of atoms, molecules and the Advanced Processor fluxing that embodies the boundaries perfection. Earth's mass energy phenomenon bounding the troposphere, the tropopause mass energy clustering the boundaries perfection by the fundamental Fluid Elements embody, spawn boundaries perfection technologies, PMII and FEIIPMII absolute technologies; the PMII, the FEIIPMII absolute technologies; the PMII, FEIIPMII technologies or the PMII, the PMIIFEII technologies complete compliments entirely matching energy balancing. Thus the super plant, the cosmological gravitational dynamics are same technologies. The super plant absolute technologies incorporate the ultra-transport system, the cosmological gravitational dynamics, the MEHC absolute conserving and the PMII, FEIIPMII technologies cycling the light fluids in Earth's gravitational sink, cosmological global gravitational dynamics respective fields.

The PMII, the FEIIPMII absolute technologies embody the light fluids ultimate balancing the cosmological global gravitational dynamics and the boundaries perfection of the energy relativity structures engendering the nullities' sums cycling rates, which spawns the boundaries perfection. The PMII technologies condone the light fluids highest cycling rates, which effect the boundaries perfection effecting highest efficiency Heat Rates inside the boundaries perfection of the epigene surfaces, which concomitantly spawn the PMII, the FEIIPMII technologies inside the boundaries perfection of the troposphere, troposphere which comprise 99% of the light fluids by volume. In the EESD is energy cycling the light fluids by which all fluids cycles, including CO₂, AGW mass energy emission, comprising all fluids at large cycling mass energy by cycling phases of the light fluids. The PMII, FEIIPMII technologies genuinely oppose insolation energy global air warming by ultimately maximizing energy transfers of air fluids cycling energy into the gravitational sink.

The PMII, FEIIPMII technologies show the prior art, besides carrying on profound flows in the prior sciences, yields energy misdirection global air warming, very unacceptable Heat Rate efficiencies, high allowable structures stress, stress corrosion cracking, short life span longevities and needed frequent and regular tensioning of bolts, all effect global air warming. All such show energy emitting, accumulating in environment and global air warming are one or the same issues.

In time domain, the EESD cycling energy dynamics fluxing the ultra-longevity boundaries of the Regions 4 and the boundaries perfection of the magnetosphere, with mass energy and volume change relative displacements, interacts mass volume and energy balancing by fluxing respective boundaries. The cosmological global gravitational dynamics, the MEHC absolute conserving, by cycling the nullities' sums spawn, bind and sustain the ultra-longevity boundaries, the boundaries perfection to the gravitational, magnetic fields bound mass energy balancing relative imbalances. The minimum energy balancing balances the relativity energy imbalances by spawning the ultra-longevity boundaries cycling orientations, rotations, flux and displacement, and effect the MEHC absolute conserving. The PMII, the FEIIPMII absolute technologies closed systems clustering in the ultra-longevity boundaries embodies the minimum energy balancing and the relativity energy relative fluxing effected by the electromagnetic fluids stiffness, creep, and volume change energy effecting optimally least stresses, strains Regions 3 structures and the ultra-longevity boundaries.

In the super plant Regions 3, the boundaries perfection concrete construction, the high energy piping loops interfacing effects the electromagnetic fluids creeping and stiffness, which comprise finite displacements energy yielding the interactions energy of displacements and volume change the electrical power input entirely controls. The interactions energy spawns the minimum energy balancing, the minimal energy displacement comprising the relativity energy, which embrace the boundaries perfection or the ultra-longevity boundaries Regions 3 environment, engendering low strains and stresses related parameters. The interactions energy constituting the minimum energy balancing reaffirm the ultra-longevity boundaries of the ultra-transport system and the Regions 3.

Instruments, gages including extensometers and cameras, monitor energy in environment and energy effecting overall displacements and volume change, the interactions energy, which spawn the interactions energy balancing Regions 3. Instruments, gages measurement and cameras data, software programs and computer memory banks concomitantly balance Regions 3 energy cycles, which, of course, includes operation of the super plant associated with numerous energy devices.

The PP constitute least resistance paths in transporting plasma that affect the light fluids self-conservations genres that in presence of gravitational sink and magnetic field constitute the ultra-longevity boundaries of the Earth's magnetosphere. The super plant technologies effect, embody energy of distortion and volume change in the electromagnetic fluids displacements creeping and stiffness to configure energy of elastic displacement volume change that is occurring in the ultra-transport system extending into high pressure turbines. The calibrated electrical power input into the electromagnetic transducers, the transducers, effect, grant the electromagnetic fluids creeping volume change and stiffness grated displacements by the interactions energy, the minimal energy displacement, which, in turn, spawns the ultra-longevity boundaries of the ultra-transport system, effecting the minimal energy displacement, maximal longevity of the ultra-longevity boundaries. Of course, atomic boundaries omnipresent electrons cycling displacement exemplifies most of it.

The minimal energy displacement, the ultra-longevity boundaries ultimate integrity comprise the boundaries perfection ultimate longevity comprising the calibrated electrical power input into the electromagnetic transducers, the electromagnetic fluids, which dampens energy cycling flows from exigent localities and the interactions energy, potential displacements eventual deformation. The electromagnetic transducers effect the electromagnetic fluids embodying pressures in control over granted stiffness and creeping, which spawn the minimal energy displacement in Regions 3.

The calibrated electrical power input into the electromagnetic magnetic fluids a power signal, the electromagnetic fluids, a substance, of the electromagnetic transducers embody the signal and the substance, to comprise electromagnetic transducers, the transducers, which convert the power signal into the substance concomitant shear and elastic moduli displacement stiffness and only as needed plastic creeping deformation, embodying the minimum energy balancing and the minimal energy displacement. The transducers effect inside Regions 3 structures minimal energy cycling. Electromagnetic coil construction, the electromagnetic fluids make-up compositions or magneto-rheological fluids trade names construction are known in the art and also widely used in industry.

The electromagnetic transducers preclude plastic and sap dynamic displacements comprising ultra-transport system proper all plastic, most elastic strains with energy stresses of the minimum energy balancing of the relativity energy and the ultra-longevity boundaries, Regions 3, integrity.

The minimal energy displacement precludes stresses concentrations which combine axial and transverse hoop stresses, the hoop stresses, wherein, a potential high energy piping pipe break due to high or even moderate axial stresses cannot occur; wherein the creeping of the electromagnetic fluids plastic deformations attenuate even most moderate axial stresses, including a small portion of the hoop stresses. The transducers continually attenuate the minimal energy displacement flux engendering the ultra-transport system continual configuring an ultimate configuration. Wherein the transducers spawn vastly superior means for structures attenuating flowing energy stresses, in walls of the high energy piping specifically, when compared to the prior art mechanical spring or hydraulic devices known as snubbers. The transducers indisputable advantages dampen the axial and the hoop stresses flowing in structures, by electrical power, which pressurizes and or spawns the electromagnetic fluids plasticity and or to solidify, stiffen or plasticize and or lower viscosity.

The transducers, the electromagnetic fluids deformations dampen the interactions energy and embody the ultra-transport system ultimate configurations, the minimal energy displacement and the minimum energy balancing comprising the ultra-transport system, Regions 3 integrity which, in turn, yields the ultra-longevity, the ultra-conserving of the boundaries perfection of Regions 3.

The ultra-transport system heat energy ultimate transferring by the electrical power input into the transducers, by the minimum energy balancing, the minimal energy displacement, aligning of the ultra-transport system effects the light fluids highest rate cycling, ultimate efficiencies Heat Rate, effecting equal opposite reaction least energy flow from the transducers into Regions 3 structure. Heat Rate, energy input vs. work output, as high as 100% and higher Heat Rate efficiency ensue.

Said 100% Heat Rate excludes distortions, stress corrosion cracking and volume change by flaws in parts not in the ultra-transport system. The FEIIPMI, the PMII technologies embody the ultra-transport system absolute maximum conservation, the MEHC, of light fluids energy, which, thus, effects cycles and amplitudes displacement energy volume changes and stress corrosion cracking least sum stresses in structural members, all of which effect the ultra-longevity of the super plant.

Gravitational sink, epigene surfaces spawn the super plant energy boundary energy cycles by precipitated fluids useful thermal energy transferring from atmosphere into that energy sink or an in situ water prior and subsequent to passing the condenser units to cool the secondary coolant the super plant cycles; condenser units flow thru water, secondary coolant temperature difference yield generated electrical power Heat Rate efficiency. Aqueduct length flows prior, after passing the condenser units, gravitational sink, epigene surfaces or groundwater lowers flow temperature, comprising Heat Rate efficiency within energy boundaries of gravitational sink epigene surfaces.

Energy boundary of the gravitational sink epigene surfaces, the atmosphere effects difference by outflowing, inflowing in situ water temperatures, comprising Heat Rate efficiency heat energy transfer by in situ groundwater which effectuates in situ paths-of-passage lengths within and thru gravitational sink and groundwater natural in situ ambient temperature nigh 55 degrees. Therein below grade construction, aqueducts length comprises thermal energy transfers ultimate transfer.

In situ water cycling positive difference in inflowing and outflowing temperatures necessitate tracing energy paths thermal energy transfers inside perfection of the magnetosphere boundaries, in addition to convection, conduction and radiation energy transfers by said aqueducts length, the light fluids phase changing spawned thermal energy transfers comprise the EESD in environment energy, spawning the cosmological global gravitational dynamics. Unique synergies in sciences, technologies and geological, astronomical sciences, supplemented by deep ice cores data, affirm, disclose energy transferring by prevailing energy events. No way can CO₂ concentration present in the ice cores embody global energy dominant events root cause. In no way, CO₂ concentration can embody convection, conduction, radiation, and/or phase changing energy events concomitant occurrence. Opposite is true. Prevailing global events energy transfers provoke energy transfers which cycle global nullity CO₂ concentration; and, yes, CO₂ emissions effect energy transferring.

The aqueduct lengths absolutely conserve water coolant mass energy in the aqueduct lengths inside epigene surfaces spawning optimal time duration, radiation heat energy ultimate transfers, which effect optimal heat energy transferring portion from the super plant into subsoil and inside epigene surfaces boundary. The aqueduct lengths' water outflowing onto epigene surfaces emits vapors' heat energy which innately balances in situ energy present by heat energy of evaporation which, in turn, cools surface of in situ water liquid phase, comprising epigene surfaces elevation.

The EESD energy, comprising environment temperatures, spawns heat energy of evaporation of an in situ water paths length along epigene surface. Mass and temperature of liquid and vapor phases and which imposes environment in situ path lengths regulatory agencies entirely regulate. Air masses and water vapors energy transfers affect Ferrel or Hadley cells cycling the light fluids between north and south 60 degree latitudes as well as cycling Subtropical and Polar Jet Streams.

Absolutely, radiations energy transfer from the aqueducts length to saturated, partly saturated subsoil and retained by the epigene surface constitute energy retained within liquids and solids of the gravitational sink, magnetic fields boundaries mass energy, which entirely sustains respective fields energy. The aqueduct lengths thermal energy transfer into subsoil embodies global climate energy, Heat Rate useful work. The aqueduct lengths outflowing water temperature equal or less than inflowing temperature comprises Heat Rate respective efficiencies 100% or greater. It is, of course, exceeding 100%, 10% of time by the energy directionalities thermal radiations directions reversal within epigene boundaries during periods of refueling and low electrical energy demand.

Heat Rate above 100%, really? Yes, by opposing global air warming environment, effecting quantum energy absolute balancing technologies, which engender sums cycling nullities of mass and energy sums within the boundaries perfection, wherein the magnetosphere boundaries spawn such boundaries in supporting life on Earth. Aqueduct lengths water temperature, at outflowing less than its inflowing temperature, comprises mass and energy balancing by heat of evaporation, which relegates the epigene boundaries mass and energy balancing and shifts balancing quantum mass and energy inside the magnetosphere boundaries which comprise the boundaries perfection.

The aqueduct lengths water temperature radiates heat energy into underground soil. Its liquid phase heat of evaporation cools epigene surface. Its heat of condensation tries nigh balancing the atmosphere energy budget by cycling the super plant at nigh 100% efficient Heat Rate within the magnetosphere boundaries. In sciences prestigious literature and various publications consensus, the atmosphere unavoidably spawns radiations energy budget unbalances of 5% to 6%, which, of course, the magnetosphere plasmas—Jean's—fountains rebalances. All such, in turn, enormously fluxes dispositions of the magnetosphere boundaries and imposes atmosphere's energy means for dispensing the light fluids among cosmological mass and energy sinks. About 10% of time, thru refueling outages, aqueducts length radiations balance a portion of the energy budget unbalances.

The super plant utilizes gravitational field force to effectuate the epigene, the magnetosphere boundaries respective Heat Rate 100% efficiency, by rebalancing portion of 5% to 6% unbalance in the atmosphere energy budget, steadying the boundaries perfection taken dispositions. Herein, energy balances the boundaries perfection in the Universe, the Advanced and fundamental Fluids Elements, the magnetosphere, in complete conformance to the Uniformity Theory, Unitarianism.

All in consensus condone atmosphere is Earth's gravitational sink inseparable integral whole, wherein energy devices byproduct energy emitting, especially ‘clean’ energy emitting is ignored. Epigene surfaces solar irradiations is way overestimated, ‘clean’ energy emitting disregarded and the unbalance 5% or 6% of total energy budget way underestimated. None of that or such effects the FEIIPMII, PMII technologies, the PPLLS absolute technologies, Heat Rate 100% efficiencies of the absolute magnitudes of the boundaries perfection by the MEHC mass energy absoluteness.

The FEIIPMII, PMII technologies yield the boundaries perfection—the PPLLS sums absolute technologies to effect mass energy absolute cycles Heat Rate 100% efficiency—transferring mass energy inside and across the boundaries perfection of the magnetosphere boundaries and epigene surfaces. Milankovich cycles, cycled energy in the early Pleistocene Epoch, undeniably show it. Aforesaid, the three gravitational sinks cycle the cosmological global gravitational dynamics, the EESD in the troposphere, tropopause flux cycles, the MEHC, the minimum energy balancing and the ultra-conserving the boundaries perfection generically effect a global air warming root cause.

Milankovich cycles sets forth the Solar System relative time and space mechanism in cycling mass and energy of the Sun and its planets, comprising respective celestial bodies' orbital planes, in invariable plane respective orbital dispositions directionality and periods, while spinning about respective axis and orbiting the Sun. Each celestial body mass and energy occupies specific time and space dispositions. Celestial bodies flux the nullities sums of the light fluids whose presence balances environment to absolute quantum energy accuracy mass energy sums of nullities, which cycle such sums to the boundaries perfection. The magnetosphere boundaries by the boundaries perfection, cycling the cosmological, solar gravitational dynamics embody Earth's energy of life.

Global scientific community, IPCC sets time domain historical records of global temperature and carbon gases concentration obtained from the deep ice cores. All that data stunningly shows geological time cyclical atmospheric temperatures and cycling gaseous and organic compositions concentrations stunning correlation and unanimous agreement, identifying causal effects systems environment energy. The IPCC at al., claims CO₂ energy has that energy. Yet, the cosmological global gravitational dynamics, the relativity energy, the ultra-fluxing by energy in the boundaries perfection of the magnetosphere raise the nullities' sums CO₂ concentration cycling time periods. Conversely, low magnetosphere energy lowers its CO₂ content in the nullities' sums high cycling rates, which concomitantly bolster cycling the nullities' sums and the energy relativity structures.

A steady unavoidable globally non-uniform inflowing of small to insignificant concentrations of various substances into the atmosphere above the continents, specifically at any historical time period prior to AGW, invariably raise global air average temperatures. Milankovich cycles time-temperature correlations from concentrations of various gases and organic substances presence in deep cores taken in ice and sediment show peaks and lows stunning pattern particular similarities among gases and δ¹⁸O oxygen isotope concentration, vs average global temperatures and vs time.

The prior global technologies' sciences “global warming”, literally, global air warming, links said stunning pattern particular similarities to causes of global air warming, to small insignificant concentrations of various substances, which undeniably is deeply, profoundly flawed conclusion. The small unavoidable concentrations, prior to AGW time, are those under 350 ppm and pertains to the atmosphere CO2 concentration specifically considered as impurities, herewith. In the deep cores, such impurities and concentration of various gases and δ¹⁸O oxygen isotope, relative peaks and lows cycling pattern stunning similarities, especially global temperatures precipitous cycling drops offsetting 100, 000-years global temperatures rise, points to global air warming root cause.

Starting from widely accepted, absolute sciences, “global warming”, global air warming, root causal effects arise from ineffective water vapors heat of condensation radiated thermal radiation energy into space, thereby, balancing the Sun's, the Earth's thermal energy radiation, irradiation, within the boundaries perfection of the magnetosphere, the epigene boundaries. All these change ice, water, and vapor phases and air to the light fluids mass energy to effect mass energy to space losses causal effects whose changing phases generate adequate water vapor mass energy volume.

The FMIIPMII, PMII technologies reveal the boundaries perfection of the light fluids and the fundamental, the Advanced Fluid Elements and the PPLLS nullities nullity sums with the MEHC and the atmosphere mass energy cycling critical parameters. That cycling effects the MEHC and the PPLLS sums cycling quantum energy clusters clustering the nullities nullity sums, to embody and sustain the boundary perfection of the magnetosphere boundaries. North, south hemispheres yield Hadley, Ferrel and Polar Cells and Subtropical and Polar Jet Streams and, likewise, in turn, embrace nearly stagnant or stagnant air masses that, nevertheless, spawn the MEHC, the nullities nullity sums which yield and sustain the boundaries perfection of the magnetosphere boundaries.

The cosmological global gravitational dynamics spin the Earth about its axis orbiting the Sun and the Sun spinning about its axis orbiting about Black Hole of the Milky Way Galaxy to spawn enormous mass energy dynamics, effecting almost all of the EESD in environment, including the Hadley, Ferrel and Polar Cells and the Jet Streams mass and energy. Thinned CO₂ concentration energy at Jet Streams' altitude is irrelevantly small to significantly affect the cosmological global gravitational dynamics, the EESD in environment, at or above that altitude. Solar radiation, CO₂ concentration global air warming effects, within the Hadley, Ferrel and Polar Cells, engender the tropical belt, the Polar Regions temperature greater temperature differentials. The rising globally air temperatures evaporate, condensate water vapors larger mass, especially with melting glaciers and polar ice caps increasing surface water increasing exposure to sunlight. Wherein, the MEHC innately yields air masses effective rates of cycling and water vapor condensations optimal mass.

The cosmological gravitational dynamics most crucial genre is the MEHC that superimposes energy in environment, the EESD, which balances changing phases energy temperature changes' thermal gradients, including ionization and recombination and mass buoyancy stratifications and gradations density gradients, and gravitational and cycling energy comprising erosion, deposition and combustion, friction and outflowing gases, and the Solar, cosmological radiation presence in the atmosphere, which, in turn, cycle the mega bulk energy inside the magnetosphere boundaries.

Epigene surfaces' boundaries perfection interfacing the nullities' sums cycling effectuates the boundaries perfection of the atmosphere, effecting epigene mass energy responses which balance that boundary and effectuate the magnetosphere boundary. And, everything balances to quantum energy resolution accuracies. Milankovich cycles embodies the Earth's orbital eccentricity, axial tilt, axial and apsidal precession and orbital inclination relative to the Solar system, the invariable plane that constitute the Solar system angular momentum plane. Cosmological and Solar System gravitational masses and energy and radiations and wind pressures affect energy dynamics inside the atmospheric boundaries. The Earth's gravitational field epigene boundaries then spawn, emit energy responses by radiation evaporation, and convection, and the EESD in environment spawn superimposed energy sums of epigene boundaries energy responses and Cosmological with Solar System mass energy inputs, while sustaining the MEHC of the atmosphere. The EESD mass and energy superimposing sums deform epigene surfaces and violently flux the boundaries perfection of the magnetosphere dispositions which radiation and hydrogen ions easily penetrate. Magnetic field cusps, magnetic lines disconnecting effects mass energy densities balancing magnetosphere fluxing boundaries dispositions spawning ions of oxygen, nitrogen and helium escape into space.

The troposphere, tropopause cycles fluids energy, air impurities concentrations and radiations energy, associated with Earth's gravitational sink epigene boundaries, except for hydrogen atoms and ions which escape into space. The gravitational, magnetic fields holds the stratosphere mass that buoyancy force lifts above the tropopause. The stratosphere cycles about itself, with density stratified layers that disclose Holes in the Ozone Layer above North, South Poles, which disclose Ozone to space escapes and the Earth's mass continuous energy emissions into the Solar System.

The Milky Way Galaxy, Black Hole cycle nullities' sums mass energy fluxing the boundaries perfection, the nullities' sums having the invariable plane angular momentum and the boundaries perfection of the Solar System. The troposphere, tropopause and the stratosphere in concomitant cycling mass energy nullities respective sums comprise the boundaries perfection of mass energy effecting the nullities' sums of the magnetosphere boundaries. Likewise, the Milky Way Galaxy comprises its invariable plane, angular momentum mass energy with nullities' sums, which, also, yield, balance the Solar System cycling the nullities' sums, comprising the boundaries perfection and the ultra-longevity boundaries of the magnetosphere boundaries effecting the nullities' sums.

The nullities' sums declaim applied and fundamental sciences, which disclose the Universe is effecting mass energy absolute conserving in the MEHC infinity upon infinity of concomitant do while loops, mass energy infinity-loops comprising the boundaries perfection, the nullities' sums algorithms fluxing the boundaries perfection, by cycling a smaller mass energy in the boundaries perfection of a larger mass energy. Concomitantly, the boundaries perfection, the nullities' sums evolves sequent of the boundaries perfection bounded largest mass energy yielding the Galaxies in the Universe and the light fluids smallest mass energy that yields molecules, atoms and electrons.

The gravitational sink fluxing mass of the light fluids cycling energy, inside typically globose spherical mass, comprises the Advanced Processor energy portion. Molten core of the Advanced Processor generates a magnetic field. The light fluids in the Advanced Processor's dormant state comprise frozen epigene mass. The minimum balancing energy and the relativity energy and the energy relativity structures associates with the Advanced Processor effecting the MEHC absolute conserving the light fluids cycling, fluxing energy in the boundaries perfection relative longevity.

The Universe comprises galactic Advanced Processors invariable disk planes, the boundaries perfection of galactic boundaries and the nullities' sums of mass energy galactic centroids, Black Holes, and invariable disk planes angular momentum. The Universe embodies three dimensional space infinites galactic centroids grid flux in the Advanced Processors mutual interactions lattice, the interactions lattice, in time domain. The interactions lattice interlaces the Newton's universal gravitation proportional energy force, including angular momentum, of any two of any Advanced Processors. At the galactic boundaries surface, slip faults effectuate and the universal gravitation proportional energy force transfers among Advanced Processors Sets in the interactions lattice; at the slip faults, the boundaries perfection holds the galactic boundaries even when facing vacuum.

The Universe fundamental structures consist of the boundaries perfection comprising smaller mass energy cycling, fluxing inside the boundaries perfection of larger mass energy, which starts with eternal boundaries spawning the boundaries perfection of the electrons, the atomic elements and ends with the ultra-longevity boundaries of galaxies in the Universe space time infinity. The minimum energy balancing, the relativity energy comprises the energy relativity structures which yield the ultra-longevity boundaries inside the boundaries perfection of respective magnetic field, gravitational sink. The energy relativity structures observed in space are taken as evidence of the curved space time, which, of course, violates the First and Second Law and is profoundly flawed.

In particular, violations of the First, Second Law assails the Universe fundamental structures, especially the energy relativity structures which embody the troposphere, tropopause yielding the ultra-longevity boundaries. Therein, especially, the wind turbines and solar panels producing the “renewable” and “clean” electrical energy” actually squander the minimum energy balancing and the relativity energy, which balances and prolongs integrity of the ultra-longevity boundaries and the energy relativity structures constituting the troposphere, tropopause. Violent and rare climate events, unusual variances arise in the relativity energy, in the minimum energy balancing uneven balancing, which warrants the wind turbines and solar panels removal from electrical power grid.

A forbidden mechanism event cycles energy which cycles the nullities' sums nullity, in chain reactions up and down sequence of forbidden mechanisms, requiting the boundaries perfection of the Advanced Processors spawning the MEHC, the EESD and environment boundaries of energy and mass. Of course, troposphere, tropopause cycling the nullities nullity forbidden mechanisms affect insignificant requiting energy responding feedback from Solar System cycling the nullities nullity. However, glacial age cycles climate changes do impose the troposphere, tropopause, the stratosphere and the boundaries perfection of the magnetosphere boundaries concomitant cycling respective nullities that in the atmosphere is equalizing energy of the EESD inside the boundaries perfection of epigene and magnetosphere dispositions. Atmospheric fluids mass energy mixtures spawning mass volume, density, temperature variations and pressures within varying range of the atmospheric pressure spawn the tropopause as boundary between stratified, unstratified densities.

Several researchers propose, Milankovich declares, that the obliquity of the ecliptic (tilting of the Earth's axis of spin toward the Sun as it orbits the Sun) constitutes the dominant frequency of glacial periods. Orbital eccentricity (orbital shapes), precession (gyroscopic motion), and apsidal precession (inclination of Earth's orbit that drifts up and down relative to its present orbit) spawn also Earth orbiting frequencies. Consensus of scientific communities claims orbital eccentricities as setting dominant frequency of glaciation periods, and that is profoundly and decidedly flawed.

That consensus suggests profoundly flawed conclusion that thru millennia CO₂ concentration drives global climate system changes. In fact, the obliquity of the ecliptic does that, wherein and not surprisingly, the scientific community is profoundly misled by the prior scientific Theories of cosmological and global gravitation. In the last two million years, interglacial period's global air warming “global warming” invariably follows thirty one (31) glacial periods, which undoubtedly repeat without any AGW. Geological ramifications of the Theory of Uniformitarianism imposes in immediate future a glacial period. Global average temperatures and CO₂ concentrations effect concomitant rising, expected to rise unavoidably, since CO₂ AGW energy emission is increasing.

In 1955, a first record of ice ages dating provided temperatures based on δ¹⁸O oxygen isotope in microscopic shells of ocean plankton serving as a proxy thermometer, which also discloses the dominant cycle 41 ka (1,000 years=1 ka) glaciation periods, dozens rather than four ice ages. An assuming consensus is that 41,000-year variation in sunlight is much too short to spawn ice ages.

To explain CO₂ concentration driving global warming climate changes, scientific community statistical analysis, thus, very recently, switches from obliquity dominant 41 ka climate cycling to 100 ka eccentricity cycling period's relative variation matching to the invariable plane. However, additional validation of such cycling spawns inconsistencies in northern hemisphere's insolation.

Numerous issues surface with 100 ka cycles, since eccentricity variations yield a significantly lesser solar insolation global climate Milankovich Theory impact to effect a dominant frequency, rather than obliquity or precession spawns. Then, there is the cycling frequencies transition issue switching periods in early 2-1 Million (Ma) and late (1 Ma to recent) Pleistocene Epochs, as well as, imprecise 41 ka periods of ice ages with various researchers claiming inconsistencies; wherein theoretical climate forcing is smaller than in obliquity and precession frequencies putative effects which precede the transition issue during the Pleistocene Epoch that reveals dominant root cause.

The cosmological global gravitational dynamics spawn the EESD global air warming cycling energy including radiations, irradiations the atmosphere magnifies, breaching the magnetosphere on frequency intervals of 41 ka, and spawn celestial, Solar System bodies and, of course, Earth's mass with energy ecliptic obliquity, precession and eccentricity frequencies dominant frequency. Atmospheric insolation naturally magnifies the EESD, in environment energy, wherein the three gravitational sinks, here, the intermediary gravitation sinks, flux cycling atmospheric energy, the nullities' sums and embody Magnification-One water vapor and CO₂ concentration as impurities.

Magnification-Two liquid phases mass portions PP densities comprises epigene's watersheds drainage conforming exclusively to gravitational field PP cycling directionalities, which embody ultimately short cycling time durations conforming to epigene elevation gradients, entirely those of gravitational field, liquid phases, conforming to the boundaries perfection of epigene surfaces.

The gravitational fields influence and restriction on liquids, gases in the epigene, atmosphere cycling nullities embody the MEHC optimal directionalities of liquids, gases, respectively. Such directionalities in gravitational field inside epigene boundaries engender the liquids inflowing the tropical belt regions in ultimately short time durations spawning oceans currents which neutralize all inequalities. Atmospheric precipitations also affect liquid phases' ultimately short duration in cycling surface runoffs. Conversely, the intermediary gravitational sinks, energy fields spawning atmosphere cycling the light fluids and all impurities (such as CO₂ concentration) associates with the light fluids cycling the nullities sums. As evapotranspiration, photosynthesis diurnal oxygen, CO₂ concentration PP reversed directionalities, the cycling nullities yield ultimately long relative durations. Fluids' cycling nullities, PP sum portions, in epigene environment and the atmosphere embodies ultimately long, short relativity exposures to gravitational sink, solar insolation relative cooling and warming mode. All such effect environment energy insolation Magnification-Three.

Magnification-Four embodies watersheds drainage longest transports predominant duration's to tropical-belt, continually shortened durations, bolstering inflowing impurities into air currents.

Spurious directionalities transport of air impurities (water vapors, CO2 concentration, etc.) in mass energy PP lengths cycling nullities magnifies maximally the Hadley, Ferrel, and Polar Cells optimally long cycle relative time durations, which maximizes insolation global air warming and the troposphere, tropopause engendering Magnification-Five maximal air warming temperatures.

Magnification-Six affects inactive, dormant and stagnant pockets, bulbs, domes of air masses which by gaining altitude avoid precipitations and trap impurities, while rising, in turn, warm-up.

Magnification-Seven floats stagnant volume air mass pockets, bulbs and domes toward poles, which, thereby, merge into bulging doming air mass that rises and stratifies, then, presses against densities of stratosphere, therein, comprising levitating domes of air mass under the stratosphere.

Feedback-One affects Magnification-Eight wherein rising environment temperature increases the tropical belt, the polar ice caps separation distance, thereby, increasing the PP lengths cycling exposure to Solar, cosmological radiations and wind pressures, which, thus, effectuate impurities even more disproportionate durations relative cycling thru the atmosphere, the gravitational sink.

Feedback-Two affects Magnification-Nine wherein environment rising temperature increases the troposphere, tropopause in volume, which traps more radiations energy and slows air cycling.

Feedback-Three, Magnification-Ten rising temperature in environment, in turn, affects larger impurities concentration, especially water vapors in troposphere, further raising air temperatures.

Feedback-Four, Magnification-Eleven comprises higher impurities concentration which slow air streams cycling rates, maximizing troposphere environment global warming temperature rise.

Feedback-Five, Magnification-Twelve slow cycling rates yield pockets, bulbs of stagnant air, magnifying the troposphere, tropopause heating rate that boosts epigene fluids' mass outflowing.

Insolation bulk energy more than sufficient imposes stunning modifications of the boundaries perfection of the magnetosphere and epigene surfaces, to the First and Second Law science in the intermediary gravitational sinks which effect the EESD of Magnification-Thirteen and insolation energy Magnification effecting Magnification One thru Thirteen superimposed insolation energy.

The Pleistocene, Holocene Epochs glacier shrinkages, in time domain, evolve the boundaries perfection epigene surfaces while steadily boosting insolation Magnification. Frozen planet crust insolation Magnification and its evolving of its crust are near nullity. However, in geologic time, the Earth has past that stage. It emits the light fluids to lower pressures, the relativity energy and the minimum energy balancing causing insolation Magnification drop by plasma outflow energy.

A boundary low energy balancing ultimate volume boost longevities; a closed boundaries total energy yield energy balance. The super plant, the PMII, the FEIIPMII technologies address total energy balance, first. The IPCC miss geologic epoch climate changes energy, atmosphere's cycling energy, the minimum energy balancing, and the relativity energy—each miss a fatal flow.

Insolation Magnification additional numerous fine details exist in geology documentations to affirm glaciation periods, tectonic and volcanic activities, magnetic fields shifting and shifting of continents spawning the EESD superimposing energy. All energy is comprising cycling nullities of relative lengths portions to PP sums cycling rates which affect global air warming. Respective deep core-borings continual samples date CO₂, methane and δ¹⁸O concentration, whose graphical concomitant atmospheric temperatures verses time plots confirms the Milankovich cycles similar cycling structures. Thus, the core borings, the Milankovich cycles are atmospheric energy record which except for plasma fountains energy outflows is the troposphere, tropopause energy record.

The stratosphere's mass energy cycles about itself, except for energy associating with plasma fountains. Thus, it spawns the troposphere, tropopause elastoplasticity shield covering, only. By all measures of life sustainability on Earth, troposphere, tropopause is perilously, stunningly thin. Recent research estimates that a quarter of Earth's water mass is lost into space. Tracing oxygen mass associating derivatives yields a stunning, enormous one atmosphere's mass energy loss into space, and Earth's, Moon's cycling light fluids lost mass yielding continuous separating in space.

The deep cores taken continuous sampling yields prima facie data that discloses the obliquity yields the dominant frequency of the Milankovich cycles cycling environment energy, the EESD. The cosmological gravitational dynamics energy embodies precise synchronous and concomitant lowest temperature, CO₂, δ¹⁸O oxygen isotope and Methane impurities relative concentration and glacial periods start and ensuing temperatures, impurities concentrations respective rising. All of which yield concomitantly the EESD environment energy in relative time and concomitant rising into sharp peaks relative levels of the prior and next peaks in interglacial periods. All such peaks precipitously and concomitantly attenuate into glacial periods' lowest temperature relative levels, Milankovich cycles shown typical structure. But, continually persistent temperature increases in a glacial period show even lowest CO₂ concentration is mostly an effect not a cause of global air warming. Flawed science technologies of IPCC sciences Milankovich cycles reaffirms 50 times.

During entire Pleistocene Epoch aforesaid is the case; Milankovich cycles engender obliquity 41 ka frequency processes dominant structure that repeats, till nigh 1.2 million years ago one beat skip, doubling its period to nigh 83 ka, while during the late Pleistocene and the Holocene Epoch, one or two beats skip in obliquity frequency, as if 125 ka occurs. During each cycle, three effects which emit the atmosphere's thermal energy are following: condensation radiation into space and convection, conduction, and radiation into the mantle's mass by the light fluids cycling mass and emitting the light fluids, plasma fountains' plasma, by the troposphere, tropopause cycling fluids.

The obliquity dominant frequency, thru late Pleistocene Epoch and Holocene Epoch, appears to skip beats which occur due to the Magnification of insolation, associated with processes of the polar ice caps, glaciers retreating, Hadley and Ferrel Cells expanding, Polar Cells shrinking with Earth's gravitational, magnetic fields' weakening and the eccentricity and precession frequencies participating. Plasma fountains outflowing plasmas relieve pressure buildup in stagnant, bulging air domes into the stratosphere, and, in turn, into the ionosphere, which, in turn, outflow plasmas.

Feedback-Five, Magnification-Twelve, first part, briefly states causes of enlarging air domes. Plasma fountains and a plasma outflowing threshold occurs several millennia prior to an ensuing obliquity frequency peak. Plasma outflowing engender the troposphere, tropopause slow cycling rates pick-up, but not appreciably, which spawn indiscriminate fluxes in temperature and in CO₂, δ¹⁸O oxygen isotope, Methane relative concentrations give dominant frequency changes illusion.

Prior paragraph describes plasma outflowing and buildup pressure release in tempered loss of accrued insolation energy in slow cycling, dormant, stagnant, warm and doming air mass bulging the stratosphere, which, then, in turn, bulges into ionosphere, which erupts in plasma outflowing. An energetic threshold comprising plasma outflowing minor outflowing can explode into plasma outflowing explosive event, which syphons the troposphere, tropopause doming air mass into the stratosphere, which, in turn, reinstates slowly the tropopuase, troposphere, the light fluids cycling ultimate rates. In time, all that concomitantly yields impurities concentration lowest prior levels.

A plasma tempered outflowing that releases insolation thermal energy buildup which accrues thru millennia is not an apropos scenario, due to potentially losing the North Pole ice cap crucial, absolutely necessary component in the troposphere, tropopause cycling the light fluids absolutely highest rates. The deep core borings point to persistent flux continual rises in CO₂, Methane, and δ¹⁸O oxygen isotope relative concentration. Plasma cycling, explosive eruptions, thru the Earth's entire glaciation, engender also global temperature concomitant precipitous, rapid, relative drops.

Identical repeated relative magnitudes of precipitous, concomitant, rapid drops disclose each cycle repeated concomitant identical processes to impurities relative concentration return to prior lowest levels conformance to the obliquity dominant frequency cycling concomitantly disclosing Milankovich computed illumination cycles. The concomitant identical processes thru millions of years, relative energy actions relative reactions spawning the Earth's environment and impurities relative concentration, return to lowest levels conforming to cycling frequencies dominant cycles and cycling plasma energy source in the Universe—the cosmological gravitational dynamics—the EESD. The boundaries perfection in the magnetosphere to the EESD balancing actions-reactions effects mass energy compliances with everything in the troposphere, tropopause cycling nullities, yet effect dormant, stagnant, stratified and warmed, buoyed air mass that bulges the stratosphere.

Air mass volume that domes into the stratosphere grows by intercepting, aggregating floating alike air mass volumes inside the boundaries perfection of the light fluids cycling nullities, which slows cycling rates by volume of buoyed air mass upward directionality. The light fluids cycling still effects the buoyed air mass lower portion but not the portion that domes into the stratosphere which, in fact, cycles conforming to the stratosphere slower nigh dormant cycling rate. Thereby, entire impurities concentration mass segregates by residing in the buoyed air mass lower portion.

In any one Milankovich cycle, global temperature yields rising trend that CO₂, Methane, δ¹⁸O oxygen isotope respective concentration and global temperature follow; when fluctuation of each relative concentration and relative temperature change is prorated over time interval of any cycle, each relative concentration and respective temperature shows relative structure with concomitant relative flux similarity. The prior sciences impute all and each respective, relative concentration, temperature to rising trend in CO₂ concentration, its respective, relative flux. None of it is valid.

Likewise, the prior technologies science promulgates critical CO₂ levels emission guidelines, to sustain, preserve and spawn the Earth's environment and atmosphere. And, of course, none of that is valid, also. The Universe absolute balances eternal cycling, the cosmological gravitational dynamics, as the EESD in environment energy, impose atomic elements balancing fundamentals, affecting the MEHC internally absolute energy balance within the boundaries perfection. Earth's epigene boundaries bounding the gravitational sink core portion modulates energy within, which, therein, modify solar insolation into the MEHC yielding the epigene surfaces. Elastoplasticity of the stratosphere elastoplasticity shield covering employs the gravitational, magnetic fields energy that effects, attracts respective pressure, electrical charge, respectively by mass weight, ions mass charge. The respective pressure mass weight, ions mass charge comprise the stratosphere energy of ultimate integrity, which transmits the magnetosphere'enormous energy damped fluxing to the tropopause, troposphere boundaries whose energy of ultimate integrity is that of the stratosphere.

Magnetic fluxing lines in the magnetic field optimally bear brunt of solar radiations and wind pressures energy by utmost elastoplasticity damping inside the stratosphere ultimate integrity and by transmitting remaining energy to the boundaries perfection of the troposphere, tropopause. In Hadley, Ferrel and Polar Air Cells, the Air Cells, the light fluids cycles the boundaries perfection of the troposphere, tropopause, and the stratosphere boundaries relative actions reactions envelop the Air Cells and the Subtropical and Polar Jet streams. The light fluids mass weight density, the electrical charge in the gravitational, magnetic fields effects the elastoplasticity, propagating flux energy damping and latency, wherein the Earth's angular velocity distributes fluxing energy well within ultimate integrity on the insolation and the lee sides of the elastoplasticity shield covering.

Science behind the Milankovich cycles computes global insolation energy in the atmosphere, as solar energy actions provokes reactions by cycling air masses in the Air Cells and Jet Streams, cycling energy. The Air Cells, Jet Streams energy actions, as the tropopause, troposphere action, spawn the epigene surfaces reaction disclosed by ice, soil-rock deposits, impurities concentration content disclosed by deep core borings which disclose processes energy that spawns the deposits.

The scientific community overlooks effects of the Air Cells and Jet Streams as energy source action that effects soil, ice deposit as its reaction. CO₂, Methane, δ¹⁸O oxygen isotope respective concentration, then, is not the energy source action spawning global air warming but its reaction, comprising infinity upon infinity of actions relative reactions balancing chains of the boundaries perfection effecting the MEHC inside the Fluid Elements, Advanced Processors in the Universe.

The stratosphere elastoplasticity shield covering restricts tropopause, troposphere cycling the nullities nullity. The Milankovich cycles energy, complying with the obliquity cycling, 50 times in only the last 2 million years, energy of the tropopause, troposphere spawned reaction exceeds, insolation energy action. In each instance, cycling CO₂ concentration under 220 ppm, very close to concentration that grants life on earth, does not preclude air warming phenomenon. All of that and more the deep core samples show. Foremost, the core samples show, low CO₂ concentration science is delusional. It can fail, only! In last 2 million, 50 times, in 4.5 billion years many more times, to Sir Eddington famous quote on flawed sciences, “there is nothing for it but to collapse”.

Computer models validate CO₂ emissions restriction benefits. However, wind turbines, solar panels electric power generation effect the prior flawed sciences, counterproductive technologies under disguise of renewable, clean energy, deserving Sir Eddington stated “deepest humiliation”. Earth's insolation Magnification in the tropopause, troposphere generate global air warming root causes, effectuating the First and Second Law, PPLLS nullities cycling the boundaries perfection to nonconformance, chronic imbalance. Likewise, the deep core borings further show increasing the Air Cells rates of cycling lowers temperature; such rates causal effects spawn glacial periods.

Aforesaid rapidly energetically syphoning the dome of air mass doming into the stratosphere occurs at the Ferrel Cells highest latitudes as thickness at altitude about 16 km drops to the Polar Cell abutting about 9 km thickness; a growing dormant, stagnant, stratified, warmed, and buoyed the air dome rises, pushing into the stratosphere by Ferrel and Polar Cells confluent cycling. The polar ice caps in the early Pleistocene Epoch spawn the Ferrel, the Polar Cells relative interfacing near N30° latitude wherein in the late Pleistocene and now Holocene Epoch that interfacing nears N60° latitude. In the latter instance, the air dome rather than syphoning rapidly and energetically thru the stratosphere's covering elastoplasticity shield drains slowly thru the magnetic field cusp. Then, the air dome syphoning lasts thru millennia; the Air Cells cycling rates barely increase. In turn, impurities concentration, temperature show marginally drops; the obliquity cycle beat skips.

In unusual unambiguity, the deep core borings duly reveal the global air warming root causes of cycling energy effectuating the Air Cells cycling the light fluids cycling rates. Fluids' cycling environment cycles in reaction response to that energy action, especially impurities concentration which includes their spawned responses. Especially water vapor and CO₂ relative concentrations penetrate interstitial space of the light fluids molecules, which, in turn, become insolation opaque and rise in temperature. Impurities concentration concomitant sharp peaks are followed by rapid relative drops to lowest lows, which, in turn, effects sudden increases in cycling rates of the light fluids in a response to the plasma fountain energetic rapid release syphoning out most of growing stagnant and stratified and warmed buoyed air of the air dome restricting the Ferrel Cells cycling. By the light fluids cycled energy, relative unblocking and blocking in the Ferrel Cells spread into the Polar, the Hadley Cells, analogous to impurities concentration cycling, dissipating throughout both Hemispheres. The core samples further show the boundaries perfection of epigene surfaces continual balances with the EESD environment energy, the cosmological gravitational dynamics.

Insolation energy of Milankovich cycles, the EESD, environment energy, is the cosmological gravitational dynamics, which balance in the atmosphere by partial transfer to epigene surface, as relative energy reaction, action precisely balanced energy of impurities concentration in deposits. Thus, epigene energy balances precisely; magnetosphere boundaries fluxing enormously balance precisely, but barely; the stratosphere elastoplasticity shield covering balances itself, transmitting precisely damped energy; then, the troposphere, tropopause cannot precisely balance. The EESD in environment at or near peak obliquity siphons the troposphere, tropopause to precise balances. The First, Second Law, the MEHC absolute energy conserving, fundamental sciences make such apparent, which global air warming sciences, the prior gravitational theories stunningly discount.

The Pleistocene Epoch aforesaid data, provided in entirety by the deep core samples, confirm explicitly global air warming natural phenomenon as old as the atmosphere itself, comprising the Air Cells cycling directionality absolutely negligible, dispensable CO₂ concentration energy, and the cosmological gravitational dynamics absolute environment energy, the EESD, overpowering, merging fluids in fluids' boundaries perfection comprising the MEHC quantum energy precision.

Scientific community, the IPCC rational to effect controlling global air warming goes beyond genuine comprehension—it absolutely, positively cannot succeed. Global air warming root cause effects are not CO₂ concentrations energy which stays in the gravitational field into eternity. The cosmological gravitational dynamics environment, the EESD, spawns all cycling energy, cycling rates in the Universe. The EESD effect the Air Cells cycling rates of fluids, the energy relativity structures. Stratosphere, tropopause and troposphere boundaries perfection, the energy relativity structures, including life on Earth, rely on the Air Cells' energy cycling rates and directionalities.

The prior sciences Gravitational Theories deep and profound flaws of the First, Second Law magnify stunning, concomitant omission of the cosmological gravitational dynamics, the MEHC, the boundaries perfection of the Advanced and the fundamental Fluid Elements, and the EESD in environment energy and all energy which effects the Universe energy balance; all that is missing.

Insolation remains stable and steady, while epigene surfaces spawn the boundaries perfection by energy of erosion, deposition and concomitantly by both. That energy of deposition is energy reaction of epigene surface to energy of action, the EESD in environment energy, comprising the cosmological gravitational dynamics in environment. Energy of deposition as energy of reaction and the EESD in environment energy concomitantly evolve the boundaries perfection of epigene surfaces. The deep core borings data of soil and ice deposits, respective impurities concentration concomitantly and individually pertain to relative depositions reaction energy. Reactions energy always associates with energy of action wherein soil or ice deposit characteristics reveal relative energy of dissipation, dispersion and transport responses to concomitant mass and energy action.

Said impurities, any and all concentration present in the deep core borings possess absolutely enormously insufficient energy to effect global uniformity to dissipate, disperse, transport, and to produce soil and ice deposits. Impurities concentration show concomitantly similar structure of fluxing and relative highs and lows thru Pleistocene Epoch. All of that points to single energy of action source, which as a general rule physically is not present in core borings but is known from known similar energy processes which yield characteristics of core samples. Global air warming by 200 to 400 ppm CO₂ concentration requires dissipation, dispersion and transport energy action it simply does not possess; its mere presence in core borings shows mass that has no such energy.

While CO₂ concentration as one of impurities in air that incrementally affects air temperature effects just that, incrementally raises air temperature, only. It is the light fluids energy of cycling action as the EESD in environment energy, which cycle tropopause, troposphere energy of action cycling Air Cells mass, which effects the Air Cells cycling energy that is global air warming root cause. Only one source can possesses global mass energy uniformity, which dissipates, disperses and transports soil and water vapors into deposits, whose soil, ice actual depositions gravitational field predominantly effects. Thus, it is Air Cells mass energy cycling which magnifies, as supra enumerates, Earth's insolation energy by quantum accuracies that spawn global air temperatures.

Structure technologies are based on energy of deformation and volume change which elastic, shear and bulk moduli grant within elastic limit of materials. Therewith, outside boundaries of a structure are constructed, effected, which under load, inside these boundaries yield elastic strains, which, in turn, results in a stable structure. Analogous to energy principles and methodologies of structure technologies energy added and taken out, in this instance thru the boundaries perfection of epigene surface, stabilizes the boundaries perfection of the troposphere, tropopause. And, that is exactly what the light fluids cycling nullities quantum energy of the EESD in environment, the boundaries perfection of tropopause, troposphere and magnetosphere boundaries do, which effect energy release to space, also. Thus far, none of these spawns eternally the boundaries perfection.

Energy of deformation and volume change by an Advanced Processor fluxing the boundaries perfection yields the MEHC conserved absolute mass energy inside the boundaries perfection, as is in ordinary structures, also. Inside ordinary structure energy flows as stresses flow. Inside the boundaries perfection of elastoplasticity fluids, in the magnetic and gravitational field energy, the light fluids mass flows as energy flows, yielding the Advanced Processor and yielding the energy relativity structures of interacting cosmological gravitational dynamics. Nigh perfect boundaries, in fact, embody the light fluids cycling the nullities nullity cycling gravitational, magnetic energy fields evolving into the boundaries perfection by balancing imbalances. Earth energy boundaries evolves the energy relativity structures of the light fluids in the gravitational and magnetic fields.

Earth's gravitational and magnetic fields concomitantly evolve the relativity structures by the Universe omnipresent cosmological gravitational dynamics to the boundaries perfection of three, absolutely stunning paradigms—the tropopause, troposphere boundaries, and the magnetosphere, epigene surfaces. Light fluids relativity structures by the gravitational, magnetic field disposition and relative strengths synergy, compatibility yield the elastoplasticity shield shielding air masses.

In general and instead, a ring or rings of planetary dust of substantial mass energy decoupling occur rather than ionized sphere of the light fluids spawning the boundaries perfection with thick stratosphere's elastoplasticity shield. The EESD in environment energy spawning Magnification factors, by the light fluids cycling nullities yield global air warming root causal effect, analogous to resonating frequencies cycling energy in structures. Gravitational, magnetic field dispositions relativity strengths synergy and compatibility balance the light fluids cycling the nullities nullity; the minimum energy balancing flux the energy relativity structures configuration, orientation and rotations, which in time domain spawn the ultra-longevity boundaries, the boundaries perfection.

The boundaries perfection reverberating the energy relativity structures concomitant balances is unnoticeable, in general, in the Solar System, in particular, except in proximities of the Earth's magnetic and gravitational fields' energy and the First, Second Law and the MEHC, which effect absolute, omnipresent mass and energy conservations. The magnetosphere boundaries perfection effects the cosmological global gravitation dynamics to the Solar System, Earth concomitant flux to the minimum energy balancing the energy relativity structures, relative energy sums of Earth's gravitational, magnetic fields, which constitute the energy relativity structures of the atmosphere.

The stratosphere comprises the intermediary gravitational sinks, the elasoplasticity shield and the energy relativity structures an ionized elastoplastic spherical form of the light fluids mass and energy, energy dampening which imposes the EESD, the MEHC in environment energy absolute perfection. The plasma energy of volume changes effects plastic deformations damping, wherein the magnetic field, gravitational sink energy and buoyancy force resilience yield elastic damping.

In time domain, the energy relativity structures, Air Cells, Jet Streams levitates stratosphere's elastoplasticity shield, which magnetic, gravitational fields' energy anchors. The Solar System's comprising the nullities' sums of the cosmological gravitation dynamics and the energy relativity structures, the energy relativity structures' Air Cells and Jet Streams, cycle the light fluids energy actions and relative energy reactions by Earth's gravitational sink and magnetic field energy flux.

In rime domain, soil ice deposits yield energy record of the EESD environment energy action reaction. In all instances, reactions and depositions energy equals actions energy cycling MEHC, EESD absolute perfections and the deep core boings impurities concentration fluxing records the energy relativity structures cycling reactions, to the cosmological gravitation dynamics an energy relativity structures energy actions. Quantum energy yields the energy relativity structures of the troposphere, tropopause and magnetosphere boundaries and epigene boundaries spawning energy of distortion and volume change, damping, fluxing, which reverberates actions, reactions energy. Cycles by energy of distortion and volume changes concomitant impurities concentration cycling the deep core borings consistently note by all-time highs subsequent rapid drops to all-time lows.

The cosmological gravitation dynamics, the energy relativity structures stay boundaries in the Pleistocene Epoch. Concentration of CO₂, Methane gas in gravitational sink mass energy budget remains unchanged; AGW is not present at that time and, yet, enormous volumes of mass energy escape the gravitational sink. The Intermediary gravitational sinks effecting the stratosphere, the elastoplasticity shield mass energy, disperse plasma into Solar System energy sinks, by balancing imbalances. The gravitational sink readily spawns the boundaries perfection of epigene surfaces, which identifies troposphere, tropopause inability to engender eternally its boundaries perfection.

The atmosphere innately effects global air warming, wherein the troposphere, tropopause, the energy relativity structures fail to effect eternal energy of the boundaries perfection; since planets predominantly evolve into hot or entirely frozen surface show the troposphere, tropopause failure to embody the boundaries perfection of the light fluids yields global air warming. Polar ice caps, glaciers retreat boosts insolation Magnification factors which slow the Air Cells cycles rate; thus, in turn, the plasma fountains prolonged outflowing weakens gravitational, magnetic field energy.

Top doomsday scenario collapses the boundaries perfection of the energy relativity structures of the troposphere, tropopause and the Air Cells and the Jet Streams cycling energy, significantly magnifying the insolation Magnification factors, which dissipates mass energy of the boundaries perfection; North Pole ice cap disappearing potentially places this doomsday inside four decades.

Doomsday scenario two swells the boundaries perfection, the energy relativity structures and the troposphere, tropopause of the intermediary gravitational sink by AGS energy emissions and, in turn, forcing plasma energy outflowing at precession and eccentricity dominant frequencies, as well, and a continual outflowing. The troposphere, tropopause thickness at the North, South Pole is 9.0 km, only. Wherein the top and second doomsday scenarios embrace propensities to merge.

Doomsday scenario three effects Magnification factors Magnifications by global air warming energy of distortion and volume change that breaks integrity of the energy relativity structures of the boundaries perfection. Repeatedly, in each instance, impurities concentration at all-time low, in time domain, affirm the deep core borings global temperature rises, by global air warming; the deep core borings show Magnification factors energy sever the boundaries perfection, the energy relativity structures, the tropopause-troposphere, which spawn global air warming all root causes.

Nigh zero CO₂ concentration yields global air warming, also. The deep core borings show it. Cycling structure similarity consistency in fluxing impurities concentration, temperature found in soil, ice samples of deposits, which scientific community globally correlates, thereby, is showing time domain same cycling energy transports effected soil, ice deposits. Globally correlating soil, ice deposits structure of fluxing impurities concentration, in turn, shows fluxing in energy source impurities concentration global transport. One energy source global disposition is cycling global impurities concentration and temperatures. Of course, the Air Cells energy is that energy source.

Doomsday scenario four effects the light fluids spawning violent climatic events unbalanced, asymmetric distribution of mass energy, especially by relentless precipitations, wherein erosional effects shortens fluids inflowing into the tropical belt, magnifies Magnification factors, which, in turn, spawn continental groundwater low levels, with barren central portions, and global famines.

In insolation environment, the light fluids cycled impurities concentration in interstitial voids gain radiations thermal energy that by convection, or by contact by conduction heat environment. Predominant among impurities, water vapor cycles and transfers bulk of that energy by changing phases. The light fluids thermal energy limited portion, by precipitations temperature difference, transfers to groundwater. Bulk heat energy transfers rate in insolation environment mass volume greatly exceeds such transfers rate into groundwater mass volume. Surface waters phase changes cools groundwater, yields global air warming and magnifies of the EESD in environment energy.

Heat energy of condensation, evaporation balance if and only when the boundaries perfection of troposphere, tropopause is impermeable, which is not the case. Said heat energy transfers rate of insolation energy to groundwater show the plasma fountains outflowing effects the light fluids loss to space mass energy directionalities flowing diametrically which opposes directionality into the gravitational sink. Said directionalities and directionality is prima facie credibility that shows flows in Quantum Theory theorizing that future meets present; the present meets the future, only.

Planets subliming ice surface emits vapor into gas environment, raising its temperature above freezing on otherwise entirely frozen planet. Concomitantly, cycling of air particles starts, due to established temperature gradient. Much later in time domain, a first plant emits first CO₂ into the air as temperatures stay above freezing. That sequence, in time domain, is prima facie credibility that water vapor and cycling of air in environment, both precede CO₂ cycling. All three correlate to δ18O oxygen isotope and yield fluxing air temperatures. The doomsday scenarios superimpose mass energy of the gravitational field flowing directionalities directionality opposed to Air Cells, Jet Streams cycling, which, as the EESD in environment energy, cycles impurities concentration.

The global air warming root causes are the mantle cooling and the cosmological gravitational dynamics superimposing fluids environment, yielding the EESD in environment energy, thereby, magnifying insolation energy. Explicitly the EESD in environment bolsters insolation energy by effecting the light fluids cycling optimal water vapor contents, which slow Air Cells mass energy cycling and boosts temperatures, which boost flowing directionalities energy which diametrically opposes Earth's gravitational sink directionality, with impurities concentration optimal emissions from epigene surfaces into the troposphere, tropopause fluids, which further boosts temperatures.

The EESD in environment energy magnifying insolation energy yields energy imbalance that shows up in Earth's energy budget, in Pleistocene Epoch and within the boundaries perfection of the magnetosphere. At obliquity dominant frequencies, plasma outflowing relieves and balances imbalance; in turn, Air Cells boost cycling rates and precipitation frequencies, which drop global temperature and of all impurities' concentrations, which lower flowing the energy directionalities diametrically opposed to gravitational sink. In time domain span, energy flowing directionalities and precipitation frequencies effect impurities concentration relative drops from highest peaks to lowest lows, spawning global temperature, impurities concentration transition into glacial period.

Insolation energy magnifying erodes steadily the gravitational, magnetic fields in interglacial periods by outflowing plasma, as supra explains, from Pleistocene into Holocene Epoch. In each of the four doomsday scenarios, cycling energy three directionalities one direction, with the other two, effect the root lead causes of failure modes, and CO₂ and impurities concentration excess as contributing effect, only. CO₂ concentration, in all instances not dominant impurity, points at the EESD, the cosmological gravitation dynamics, cycling of energy as the failure modes root cause.

In the last 300 years and especially in the last 30 years, global industry is dumping fluids and energy byproducts into the atmosphere which, as supra explains, is tenuously coupling to Earth's gravitational sink, comprising the intermediary gravitational sinks. Collectively, those fluids and energy byproducts comprise potentially one volume of the atmosphere as supra notes. All which yield the mass energy flowing directionalities diametrically opposed to gravitational sink, which, in turn, attenuate the Air Cells energy cycling, which, in turn, boosts the troposphere, tropopause impurities concentration, which, in turn, magnifies insolation temperature, all of which boosts air temperature. All which effects global air warming, wherein CO₂ is a concomitant impurity, only.

Herein declared science behind Milankovich cycles, confirmed by the deep core borings data, affirms the cosmological gravitational dynamics, the EESD cycling energy in environment in the Pleistocene, Holocene Epoch spawning global air temperatures, impurities concentration effects. Bungling the cosmological gravitational dynamics (the EESD cycling energy in environment) by experimentalists-theoreticians, in the prior art flawed science, convinces global citizens that zero CO₂, AGW emissions solves global air warming issues, which, of course, is fundamentally false.

The experimentalists-theoreticians address no energy emission issue. AGW energy emission absolute nullities is necessary, in Earth's compliance with the Pleistocene, the Uniformitarianism Theory cycling of the cosmological gravitational dynamics within the fluxing temperature ranges in that Epoch, which, likewise, is unacceptable, since plasma outflowing into space are no longer acceptable. Troposphere, tropopause mass volumes present thicknesses are too shallow, already.

In the last eight decades, bungling experimentalists and theoreticians at large usurp, dominate and impose delusional Gravitation Theories deep flaws and the Second, First Law and the energy relativity structures undefined boundaries misuse. Form of energy and mass energy transposition flowed substitutions yields imaginary science. The Universe evolves perfection of everything by energy cycling conformance to 100% Heat Rate efficiency. Wherein, bungling experimentalists, theoreticians misapply the minimum balancing energy of the energy relativity structures, the Air Cells cycling energy to generate electrical energy, calling it clean renewable energy. In fact, low and moderate Heat Rate devices solar panels, wind turbines sap energy from the energy relativity structures, the minimum balancing energy and the troposphere, tropopause ultimized longevities.

Of course, deeply flawed the prior sciences and art effects catastrophic climate change. Low, moderate Heat Rates with respective, moderate mass energy byproducts comprise directionalities diametrically or significantly opposing Air Cells' energy directionalities cycling 100% Heat Rate efficiency. Stunningly, said prior sciences profound deep flaws substitute CO2 concentration 200 ppm above all-time laws for inefficient cycling rates by the Air Cells, the EESD, and the MEHC. The Air Cells energy deposits soil and ice found in the deep core borings, not CO₂ concentration; that energy embodies, is by far global temperature rising dominant driver, not CO₂ concentration.

Eight decades ago, scientific communities, at al. declare and, thereafter, accept deeply flawed cosmological theories, wherein wind, solar power generating energy for consumption effectuates prima facie credibility of neither total grasp nor comprehension of the cosmological gravitational dynamics hitting Earth. The Universe evolves boundaries perfection of everything, which yields, comprises and declares the Theory of Everything, comprising the bound boundaries perfection of everything, the fundamental, the Advanced Fluid Elements, which, in turn, underscore perfection of everything in environment energy mechanisms concomitantly evolving boundaries perfection.

Herein, declared science of the Milankovich cycles, cosmological gravitational dynamics and the deep core borings impurities data concomitantly disclose prima facie credibility that the prior science and art imperil global citizenry. Undefined structure and mode of failure adjoin the First, Second Law in absentia. Flaws of such science transfer fundamental science structure mechanics from said assorted and delusional sciences mixture into counterproductive global energy policies.

By the Uniformitarianism Theory, Earth's energy budget 5% to 6% imbalance balancing continues thru the Pleistocene, the Holocene Epoch. Therein, the energy relativity structures, the troposphere, tropopause, energy actions transfer mass energy into the energy relativity structures of the stratosphere, which at obliquity 41 ka dominant frequency outflows plasma to space, which may start to occur at precession 21 ka frequency, also. All the energy relativity structures, energy actions mass energy lost to space to date is absent in the prior art Earth's energy budget. The Air Cells Jet Streams cycling energy losses concomitantly raises impurities content in the light fluids cycling nullities, eventually reside in epigene soil deposits, out of the energy relativity structures.

Each of the four doomsday scenarios failure mechanism has propensity to migrate into any of the other three. The insolation energy Magnification inside the energy relativity structures yields creeping energy losses, which, in turn, concomitantly spawns global air warming phenomena. In energy relativity structures, creeping energy losses, the failure modes advance concomitantly. In each instance, the cosmological global gravitational dynamics embody the EESD in environment energy, which, in turn, yields energy relativity structures cycling mass and energy in environment.

Milankovich cycles flux the minimum energy which embraces the ultra-longevity boundaries fluxing and evolving the boundaries perfection, yielding the tropopause, troposphere and epigene surface respective boundaries structure. In balancing imbalances, the EESD, the MEHC absolute energy conservation spawns an energy relativity structures energy fluxing boundaries structure to the MEHC absolute energy conservation and the minimum energy, effecting plasma outflow and epigene evolutions. In time domain, boundaries perfection minimum energy, EESD, MEHC and epigene flux surface and obliquity, precession eccentricity frequencies plasma outflow as needed balance the energy relativity structures and light fluids cycling energy respective relative fluxing.

Milankovich cycles defines environment insolation energy, affirmed by the deep core borings impurities concentration. Milankovich cycles show cycling energy primarily embracing the light fluids cycling energy cycles, by mass volume of over 99%, effecting the Air Cell, the Jet Streams cycling energy cycling mass volume 100%. The prior science compounds bungling fundamental sciences energy transfer structure mechanics to substitute 400 ppm CO₂ concentration energy for the Air Cell, Jet Streams energy, thus, to effect “clean, renewable energy” global energy policies.

Thus, wind turbine, solar panel devices “clean, renewable energy”, in fact, advance global air warming by converting irreplaceable cycling energy which sustain the Air Cells, Jet Streams, the energy relativity structures energy cycling troposphere, tropopause fluid into electrical energy for general consumption. Said structures sustain the stratosphere energy relativity structures, which, in turn, sustains the global gravitational and magnetic fields relative strengths, mass, and energy.

The wind turbine, solar panel devices squander the light fluids cycling nullities energy of depositing suspended impurities concentration into epigene sediments, thus, bolstering impurities concentration, which includes environment very powerful greenhouses gases, methane and water vapor. Thereby, overall, these devices boost the cycling nullities' CO₂ concentration constituting CO2 in environment, as well, affecting in part recent 60 ppm surprising jump to 420 ppm. Wind turbines, solar panel relative moderate 55%, low 20% respective efficiency Heat Rates block and redirect the light fluids energetic air stream. The devices syphon, redirect cycling energy cycling nullities which lower relative impurities concentration and temperatures. The Uniformitarianism Theory, the MEHC absolute perfection affirm it; these devices effect, not oppose climate change.

Energy directionalities, atmosphere proximities to energy sinks embody insolation energy Magnification-One thru Thirteen in the intermediary gravitational sinks, spawning the doomsday scenarios three directionalities and three diametric directions: fluids global precipitations, plasma outflowing two cusps to cosmological sinks, three directionalities. The three diametric directions embody the EESD of the relativity energy, the cosmological global gravitational dynamics inside the energy relativity structures, enormously affecting Earth's climate. Wind turbine, solar panels proximate energy sink maximally obstruct the light fluids, radiations energy Earth's gravitational sink flows. Obstructed insolation energy directionalities to energy sink maximally retain energy.

Air Cells' energy dominates environment proximate Earth's gravitational sink. Wind turbine and solar panel devices obstruct, reflect and deflect Air Cells energy from inflowing energy sink, in part, traceable and shown, by most recent 60 ppm, CO₂ concentration jump. Insolation energy asymmetrical, violent precipitations distribution frequency and polar vortex cycling eccentrically to geographic poles, into Temperate Zone climate, reveal imbalances in Air Cells energy cycling. Wind turbines, solar panels dismantling are warranted, which, thus, avoids such climate changes.

In time domain, impurities concentration in the deep core borings shows structure similarities which affirm all individual and concomitant impurities concentration effected energy by the light fluids, which, in turn, is energy spawning concomitant evolving epigene surfaces while spawning the boundaries perfection. In fact, that energy yielding the boundaries perfection is energy in the tropopause, troposphere which yields concomitantly the boundaries perfection of epigene and the tropopause, troposphere boundaries. The core borings impurities concentration concomitant flux discloses fluxing of the light fluids energy by Milankovich cycles energy cycling in environment.

Concomitantly, Milankovich cycles insolation with epigene impurities concentration embody relative insolation energy action, epigene surfaces reaction, effecting prima facie credibility facts shown tropopause, troposphere and magnetosphere integrity relative strengths are weakening. In Pleistocene Epoch, the boundaries perfection effectuates plasma two important threshold types of plasma outflowing that rebalances energy outflow, relative integrity of the boundaries perfection.

The Early Pleistocene Epoch threshold type, erupting by bursting pressures, is effecting sharp peaks in impurities concentration reaffirming all-time highs followed by impurities concentration reaffirming all-time laws. In the last 1.2 Ma of Pleistocene Epoch contrasting differences appear at threshold of plasma outflowing, which give false impression that obliquity beats or beat skips; and, plasma outflowing moderate pressure threshold fluxes impurities concentration, which stays in relative fluxing range. Threshold types disclose the troposphere, tropopause spawning cycling energy fluxing pressures to the boundaries perfection integrity retained 14.7 psi relative pressure.

In science technologies, principles and methodologies cycling energy concomitant structures affirm these applied sciences and technologies and the First, Second Law confirming the Air Cell cycling the light fluids as the EESD in environment energy. Quantal quanta comprising quantum mass of the nullities nullity of epigene and tropopause, troposphere and magnetosphere spawning the boundaries perfection of relative boundaries comprise respective structure methodologies and principles relative analogies. The First, Second Laws energy of deformation and volume change, therein, engenders said Magnification factors by fluids associated with the boundaries perfection.

Global air warming boosts concomitantly evaporation rates, violent asymmetrical distribution precipitations frequency, with geographical areas flooding, central continental areas groundwater low levels, and drying up in general. All these associates with Air Cells cycling rates slowdown, which, in turn, associates with high impurities concentration in air Magnification factors yielding global air warming Earth's insolation energy comprising the EESD in environment. Fortunately, the Earth effects plasma outflows unique concomitant rebalances of the boundaries perfection of the magnetosphere and tropopause, troposphere boundaries and epigene surfaces. Unfortunately, Earth has lost enormous air mass energy, which now comprises 6 to 16 km in overall depth, only.

Heat Rate 100% efficiency energy cycling rule space. The PMII, the FEIIPMII technologies embody the cosmological global gravitational dynamics, the global air warming sciences, and the ultra-longevity boundaries of the super plant inside epigne surfaces inside the magnetosphere and the light fluids energy cycling, comprising concomitantly 100% or greater Heat Rate efficiencies.

The PMII, the FEIIPMII technologies embody the cosmological global gravitational dynamics, the MEHC absolute conserving, the 100% or greater Heat Rate efficiency energy cycling and the nullities' sums cycling energy and the ultra-longevity boundaries of the magnetosphere, the light fluids. Heat Rate 100% or greater efficiency spawns the light fluids cycling concomitant thermal energy transfers by gravity flowing the aqueducts length portion prior to inflowing the condenser units, thru the condenser units and the aqueducts length entire remaining portion by cosmological global gravitation dynamics and insolation energy forcing evaporation, condensation. All which, including electrical power generation, comprise useful energy inside the boundaries perfection of respective epigene surfaces and, then, the topopause, troposphere boundaries energy transferring, provided the aqueduct length precludes a potential plasma outflowing. When fusion with fission balances nuclear power energy generation respective energy cycling effects nigh eternal cycling.

The 100% or greater Heat Rate efficiency cycling shows Magnification factors power within, inside the boundaries perfection cycling the light fluids including electrons, the nullities sum's in omnipresent cycling, which comprise energy inside energy fields concomitantly but successively exchanging mass energy and radiation energy transfers, climate changes cycling. And, the super plant, Regions 1-5 do exactly that. All that affirms, declaims science behind Milankovich cycles, a stunning difference in global technologies bulk power plants Heat Rate around 35%, in general. The light fluids flowing energy highest Heat Rate efficiencies effectuate the global, cosmological gravitational dynamics partial portions energy redirections of the mega bulk power directionality, effectuating means for electrical power generating, the mega bulk power energy cycling synergy.

The electromagnetic transducers power input comprising the minimum energy balancing, the minimum displacement energy maximize the light fluids cycling, the bulk power transfer highest Heat Rate efficiencies and effectuate the ultra-longevity boundaries of the ultra-transport system.

The electromagnetic transducers are devices grounded by the Regions 3, Regions 5 a network site interconnected grounding grid grounded all super plant mechanical and electrical equipment. The Electromagnetic transducers warrant the super plant safety equipment rating that qualifies by construction and maintenance. However, the super plant, ultimate longevities plant qualifying its components, thus, derives maximal unprecedented Heat Rate efficiency benefits. In a power loss accident, the minimal energy displacement relegates to Regions 3 displacements energy the prior art grants, while the electromagnetic fluids fixed volume, viscosity spawns a beneficial damping.

In the prior Theories of the Universe mass energy dynamics huge, most stunning oversight in evolution and/or creation is the boundaries perfection existence, sustained by technologies which comprise the Advanced and the fundamental Fluid Elements as well as the atoms. After-all, flow or spinning or displacements of electrons is atomic energy inside boundary, flowing every which way complying with laws of conservation of mass and energy, the Laws of the Thermodynamics.

In the Universe, mass energy reverberates and cycles, to evolve into nullities by energy of deformation of volume change of the boundaries perfection, to cluster the Fluid Elements and the Advanced Processors, all which the cosmological gravitational dynamics, the EESD, comprise in environment. The Second Law apparent and unavoidably omnipresent and misallied in sciences, key Theories, and the entire prior art embodies causal effects of and global air warming solutions to cycling energy balances, as fundamental and comprehensive as lowering global, ultimate Heat Rates, yielding 100% Heat Rate the super plant claims, which is the only device that can do such.

No prior device cycles nullities' interactions, the cosmological global gravitational dynamics, the boundaries perfection do in concert. The super plant, Regions 1 thru 5 embody such cycling, global energy dynamics cycling nullities, to affect the Laws of Thermodynamics, the MEHC and the FEIIPMII and the PMII technologies, which universally yield maximal Heat Rates efficiency by cycling energy thru gravitational sink potential energy. All such spawns massive differences.

Ultimately Heat Rate of the super plant accounts for gravitational field useful energy to cycle cooling water evaporation/condensation and underground aqueducts lengths even when the super plant is refueling. Heat Rates fluctuation quantified on calendar year time periods is appropriate.

Such Heat Rate computing inside the boundaries perfection comprises that Heat Rate efficiencies fluxing by the boundaries perfection. In this instance that Heat Rate pertains to energy budget of the tropopause, troposphere. All of which plasma energy outflowing to space ultimately govern.

Global air temperature rise forces the light fluids mass energy cycles to distend boundaries of the boundaries perfection with insulation energy Magnification factors slowing cycling rates into gravitational sink. The light fluids, plasmas escape to space restore cycling rates, boundaries and global air temperatures and sums up global air warming, Milankovich cycles fluxing phenomena.

The underground aqueducts cycle the light fluids inflowing gravitational sink, boost all fluids cycling rates, spread and disperse precipitations, engendering useful energy to entirety; that sums up principles of Heat Rate 100% efficiencies with Heat Rate forced by the boundaries perfection.

The prior art yields the energy directionalities adverse outflowing, from epigene surfaces into cosmological sinks, by atmosphere intermediation. Atmospheric precipitations, plasma fountains spawn the energy directionalities to respective global sink, cosmological sinks. By conscientious defying of the cosmological gravitational dynamics, the prior Theories, the prior art imperils life.

The Earth's gravitational sink outflowing energy that cools the mantle affects life on epigene, in glacial periods preserving life dormancies, while during interglacial periods it dries up epigene interior land masses. The EESD escaping, radiating, irradiating energy into space forces all of it, by energy dynamics cycling the nullities' sums in atmospheric environment propagate the EESD, bound by the magnetosphere boundaries, epigene surfaces, comprising the global climate system.

Wind turbines, solar panels technologies syphon energy form global nullities' cycling energy of the EESD in environment energy, spawn the energy directionalities adverse global cycling and climate associated causal effects imbalance. Globally air rising temperatures embody the EESD in environment cycling energy nullities, comprising cycling mass and energy densities within the magnetosphere and epigene boundaries. The cosmological global gravitational dynamics fluxing enormous energy balance the energy directionalities and energy of distortion and volume change, yielding volume of climatic, volcanic, tectonic events and precipitation asymmetric distributions.

Cycling AGW CO₂ emissions, a small fraction that exceeds 0.04% of CO₂ in the atmosphere, cycles within the light fluids mass energy cycling and inside hydrosphere vapors boundary in the atmosphere. Around 0.03% of CO₂ cycling inside the hydrosphere is sustaining life environment on Earth. Even 0.01% variances in CO₂ budge in the atmosphere discloses the light fluids, water vapors inadequate cycling rates in the tropopause, troposphere and the hydrosphere, respectively.

In invoking electrical energy analogies, energy flowing dynamics reveal that solar panels and wind turbines in atmosphere's energy dynamics spawn dislocating directionalities, disconnecting radiation respective effects comprising discontinuities, open circuits in cycling radiations and the light fluids cycling loops. Wind turbine, solar panel devices devour the Air Cells cycling energy, in turn, effecting Heat Rates moderate and law efficiency energy conversions. While their power generation makes no particulates emission, that generation spawns energy directionalities cycling against the Earth's gravitation sink, favoring cosmological energy sinks, the magnetic field cusps directionality. Purging power grid systems of such energy power generation is highly warranted.

The light fluids cycling nullities mass and energy sums dominates global nullities cycling energy and concomitant climate change. Historical geology, the Uniformity Theory show energy in the nullities' sums effect the Air Cells impurities concentration. Earth's glaciation prima facie credibility, Milankovich cycles, points to the cosmological global gravitational dynamics forcing the Earth's climate system changes, effecting byproduct CO₂ concentration spawned changes and concomitantly evolving glaciation and epigene surfaces and, in turn, supra Magnification factors.

And, in glaciation history, cognitive glances at the climate system reveals that vapors buildup in the atmosphere is accompanied by CO₂ buildup, during glacial or interglacial period. Climatic events unbalancing energy and plasma outflowing release unsymmetrical, energetic distributions huge precipitations, the light fluids unbalance released energy radiations into space, respectively.

The unsymmetrical distributions huge precipitations maximally precipitated water vapors from the troposphere, tropopause maximally drop global temperature, maximally drop impurities concentration in air transferring concentration portions into gravitational sink. The cosmological global gravitational dynamics, Earth's gravitational sink, the mega bulk power cycles effect it all.

The deep core borings continuous sampling thru epigene surface 2 million years of ice, soil-rock layers deposits during the Pleistocene, Holocene Epochs comprise the early Pleistocene Epoch, taken from 2 to 1 million years ago, shown Milankovich cycles uncannily cycling at 41 ka obliquity dominant frequency, except for the beat skip 1.2 million years ago. Supra explains that beat skip and subsequent repeated beat skip appearance in the late Pleistocene, Holocene Epochs.

Balancing it all in environment, the EESD, and plasma outflowing and the unsymmetrical distributions huge precipitations is balancing the relativity energy, the relativity energy field, and the energy relativity structures to Uniformitarianism Theory energy of the boundaries perfection.

The light fluids to space losses confirm the atmosphere spawns the intermediary gravitational sinks by proximities and directionalities to energy sinks. The Uniformitarianism Theory beyond a doubt affirms energy of the EESD cycling climate change with CO₂ energy levels as byproduct.

The Universe comes as three dimensional spider web that generates three dimensional grid of nodes, each evolving origin of evolving celestial bodies, entities of cycling nullities which spawn the boundaries perfection and spherical, globose bodies as gravitational sinks. Astoundingly, the prior sciences, prior art overlook, misplace the cosmological gravitational dynamics, which come with the Universe as a mason architect to configure, shape and balance everything to accuracy of quantum energy by spawning the MEHC naturally and innately and always; which spawns paths, directionalities in direction of least energy resistance. Whereas the stars' nuclear reactions origin dates to the Big Bang, nexuses of cycling nullities mass and energy date to origin of gravitational sinks, respectively. Wherein, the cosmological gravitational dynamics embody and impose all of present evolving appearance of the Universe comprising the Uniformity Theory, which embodies Milankovich cycles. The ultra-transport system employs technologies and associated genres that is defined by the cosmological gravitational dynamics and mass energy cycling eternal longevity.

Milankovich cycles show that the global and the cosmological gravitational dynamics cannot retain the boundaries perfection of the magnetosphere. Consequently, global air warming occurs as energy accumulates in the boundaries perfection, until the blow-off occurs, which resets all of the cosmological global gravitational dynamics. In fact, Milankovich cycles shows that any CO₂ concentration in the atmosphere, and the Theory of Uniformity affirms it, cannot yield dynamics, thus environment energy temperatures, which spawns eternity of the boundaries perfection of the magnetosphere. Wherein opposite holds true, the cosmological gravitational dynamics affect the EESD overall energy, the light fluids global temperatures and CO₂ concentration in environment.

All light fluids nigh mass energy densities balance the cosmological global dynamics and the nullities' sums yield the boundaries perfection of the magnetosphere boundaries which seems to exist; in fact, that is not the case. The magnetosphere boundaries violent, continual, enormous fluxing with astounding deformations energy embody instant power that in no way CO₂ presence can effect, is the case. These cases show the prior, the IPCC sciences embodies grave oversights.

The atmosphere suspends oxygen in nitrogen and including ions of both in bobbles inside the magnetosphere boundaries. Nitrogen and oxygen bobbles jointly and in common suspends water vapors, all of which jointly and in common suspend CO₂ gases. Atmosphere constituents jointly, and in common, effect thermal energy gradients in the atmosphere. By definitions, cycling fluids cycling directionalities and energy gradients are mutually orthogonal. Energy gradients embody thermal and pressure gradients orthogonal to cycling directionalities. Celestial bodies yield mass energy cycling nullities energy gradients and directionalities from energy sources to gravitational sinks. The Earth is entirely mass energy device. The Uniformitarianism Theory affirms the light fluids cycling compositions content that effects concomitant cycling energy chronic unbalancing, which cycling the compositions content temperatures spawns the glacial, the interglacial periods.

Aforesaid points at glaciation history, energy cycling the nullities' sums and inadequate rates of cycling, specifically by the light fluids nitrogen, including water vapor, and hydrogen, oxygen, affecting global air warming that accrues vapors and various gases small amounts including CO₂. High CO₂ concentrations is the light fluids inadequate cycling energy “canaries in a mine” effect.

Solar panels power generation siphoning solar energy naturally directed toward warming the mantle actually ends up warming the atmosphere, an unintended compliment by the Second Law. Wind turbines siphon most, not all, energy portion cycling locality air, which siphons short loops cycling energy and, in turn, adversely affecting long cycling loops energy, yielding condensation which precipitate most impurities concentration comprising vapors, CO compounds, all which, in turn, radiates radiation to space. Attempted unthinkable competing with the cosmological global gravitational dynamics, by energy subpar Heat Rate efficiency devices, in turn, further warms the atmosphere by the First and Second Law and the Theory of Uniformity unintended compliments.

Entirely and comprehensively setting forth quantum mass and energy yielding the boundaries perfection of the atomic elements and the fundamental and the Advanced Fluid Elements and the Universe affirms fundamental Laws sciences disclosed technologies in these applications, which, likewise, unmask the prior sciences and art deeply flawed highly counterproductive technologies.

An idling air mass bulb enlarged volume attaining altitude proximate the hydrosphere highest elevations disperses under very strong lasting air currents, only. Air bulb enlarging idled volume unrestricted enlarging by gravitational field force at high elevations segregates by density and air impurities concentration, which effects mass energy volume mechanisms, eventual disconnecting of magnetic lines by mass energy persistent blow offs by plasma outflowing into space outflows.

Earth's gravitation is not in absolute possessions of its light fluids. Siphoning of solar energy from the Earth's gravitational sink, magnetic field energy must, also, spawn climate changes that permanently attenuate energy cycling in both energy fields stipulated by the Second Law, which, in turn, permanently attenuate both energy fields. Theory of Uniformity energy—the atmosphere energy cycling energy—the cosmological gravitational dynamics evolves Earth life forms energy, life uniformitarianism energy cycling and energy fluxing, the prior sciences art, the cosmological global gravitational dynamics profound, stunning flows squander in CO₂ low emissions tradeoffs.

The cosmological global gravitational dynamics embrace opened loops idling or closed loops cycling the light fluids, impurities concentration and water vapor condensate, transporting energy into Earth's gravitational sink. Open idling loops flux idles air mass bulbs whose volume grows, distends into cycling energy closed boundaries to block, reflect the light fluids cycling, spawning the idling air mass bulbs air volume trapping entire locality impurities concentration that idles, or strays from cycling loops. The idling air mass bulbs isolated volume mass, retains radiations and irradiations energy large portion, which insolation energy further heats up and distends enlarging its volume, especially into elevated altitudes, yielding mass volumes that further slow air cycling. And, such is very similar energy in environment wind turbines, solar panels mechanically spawn.

A hemisphere idling the light fluids mass energy optimal portion and the cosmological global gravitational dynamics disconnect the magnetic field outer lines, cosmic radiation wind pressures syphon air mass portions into the ionosphere, and especially dormant air portions, which, in turn, effects plasmas blow off to space. Concomitantly, cycling nullities boost cycling rates, which, in turn, optimize precipitation of water vapor and impurities concentration, as disclosed by the deep core borings in ice and soil deposits. Cycling rates boost lowers insolation Magnification factors of the EESD in the energy relativity structures and the ultra-longevity boundaries nigh perfection of the Advanced Processor, the tropopause, troposphere, magnetosphere and epigene boundaries.

Universe mass energy down to molecules and atoms innate cycling electrons energy quantum evolves the boundaries perfection by continual testing presence of the ultra-longevity boundaries and the MEHC, proven by atoms and molecules, invariably evolves the Advanced Processors. In mass and energy cycling nullities to quantum accuracies any and all paralysis, comprising idling, engendering energy with mass cycling directionalities of nullities, embodying the MEHC and the Advanced Processor, Earth's magnetosphere, must without fail evolve the boundaries perfection. The magnetosphere boundaries adverse directionalities energy cycling flux bolsters cycling rates alternate directionalities evolving the MEHC. If the MEHC fails, the boundaries perfection fails.

And, that is what Milankovich cycles really show. In each instance thru billions of years, the Earth's mass energy gravitational dynamics response to the cosmological gravitational dynamics mass energy fail to yield the MEHC of the atmosphere and, in turn, fail the boundaries perfection of the magnetosphere. Cycling nullities energy balance unbalance is root causal effect of all that.

It can appear that the Universe eternal balancing of unbalances into the boundaries perfection mass energy lacks ultimate purpose, which, of course, is not the case. Milankovich cycles shows the magnetosphere cycling nullities yield the boundaries perfection cycling into nullities failures, all which glaciers, polar caps ice, the deep core borings, impurities concentration deposits affirms concomitantly, respectively. The light fluids' cycling energy cycles the glaciers, polar caps mass volume respective energy in gravitational sink, also, effecting soil, ice constituents mass volume.

That energy dwarfs air impurities concentration energy. Gravitational sink cycled energy yields the mega bulk power, the deep core borings soil, ice deposit volume. That energy, cycling the nullities' sums of gravitational sink, effects plasma energy losses to cosmological sinks, also.

Likewise, Milankovich cycles constitute prima facie credibility that the cosmological and the global gravitational dynamics in the Earth's gravitational sink fluid, volume and energy cycle the nullities' sums energy, pressures, and volume in the boundaries perfection of the magnetosphere. The nullities' sums fluid magnetic lines disposition enormous flux sustains atmospheric pressure 14.7 psi at sea level, comprising the boundaries perfection mass energy densities. Deforming the magnetosphere boundaries magnetic lines disposition to mass and energy balances comprises the MEHC and mass energy absolutely highest conservation or outermost magnetic lines disconnect.

In fact, Milankovich cycles shows CO₂ is a contributor to mass and energy and definitely not the root cause of global are warming, “greenhouse effect”. Furthermore, Milankovich cycles prove beyond reasonable doubt comprising prima facie credibility, CO₂ emissions cuts may help, but yield zero chance of success. The ice cores data reveal that at any CO₂ concentrations, which includes concentrations needed to support life, global air temperatures unavoidably show a rising trend. In geological past, the Earth's gravitational sink stunningly optimal attempts at the MEHC self-conserving consistently fail; numerous glaciation periods and several shifts in dispositions of the magnetic field are shown not to work. All mass energy balancing perturbations in the Earth's gravitational sink to bind the atmosphere's mass energy in the boundaries perfection by the ultra-longevity boundaries of the intermediary gravitational sinks also generates balancing imbalances.

Mass energy perturbations affecting the atmosphere rising temperatures imbalance trends embody mass part with energy part, varying within participating concentrations mass and energy cycles, all of which effect continuous imbalances for 4.5 billion years. Of course, the root causal effects comprise the energy directionalities difficult, also destructive, turbulent mass energy nigh balancing in the Earth gravitational and magnetic fields, which violates the boundaries perfection of the magnetosphere and epigene boundaries. CO₂ concentrations 0.02% to 0.04% by molecular density mass volume directionalities to gravitational sink epgene surface only ride the light fluids cycling energy. All which relegate CO₂ concentration energy as a global air warming root cause.

Energy cycling aforesaid cycling directionalities, energy gradients comprise the EESD, in environment energy, are rising air temperatures root causal effects, assisted thru several centuries of the prior sciences art; that art has: a) on average energy devices Heat Rate of less than 27%, b) the atmosphere as integral part of the Earth's gravitational sink. Aforesaid concurrently establish the atmosphere unique, exclusive nigh perfections of the intermediary gravitational sinks cycling mass energy in environment spawning the magnetic field. Aforesaid reveal the Universe cycling mass and energy by mean machine Heat Rates, 100% efficiency. Cycling unlimited mass energy which cycles the light fluids radiations and radiations wind pressures, inside time longevities, the Universe balances, modifies and eradicates anything cycling energy at less than 100% efficiency.

Universe balancing mass energy down to the light fluids quantum energy lowers potential energy of everything cycling analogous to a skater in a spin pulling the extremities into his body. Perpetual mass and energy to and from gravitational mass energy sinks within frictionless cycled environment yields limitless energy to balance mass energy cycling into absolutely low potential.

The celestial mass energy bodies' energy cycles nullities in cosmic space, comprising the cosmological gravitational dynamics, requiring affirmative energy responses of a nigh perfection presence in the boundaries perfection. Energy action of the cosmological gravitational dynamics within the Earth gravitational sink, the magnetosphere boundaries prompts mass energy reaction, action superimposed into balance of the EESD, mass energy present. Or, plasma outflow occurs.

Geographical regions energy action, reaction can dominate, or affect cycling the nullities' sums. Thus, the EESD in environment energy may yield energy action, energy reaction or a sum of superimposing energy. Milankovich cycles disclose that invariably thru 41 ka intervals energy reaction exceeds energy actions, forcing the magnetic field lines individual or group disconnects, and associating plasma outflows, which the cosmological global gravitational dynamics imposes.

Both, wind turbine and solar panel technologies, generating “renewable”, “clean” electric power, conceal deep, profound ramifications which imperil the human race. Such devices utilize gravitational sink energy reaction embodying perfection of the magnetosphere boundaries. Force of energy action, the cosmological gravitational dynamics, omnipresent on, in the magnetosphere boundaries, enforce energy of volume changes and distortion in these boundaries, penetrating the atmosphere. Most forces of energy action act unavoidably on gravitational sink, epigene surface. Said energy devices energy transfers effect adverse energy cycles directionalities in environment.

Cycling directionalities in environment energy transport, transfer spawn the MEHC, Heat Rate 100% efficiency. Wind turbines, solar panels bulk electrical energy generation respectively effect moderate to low Heat Rates which effect intellectual technological bungling. Environment cycling of energy transfers of reaction by the gravitational sink should greatly overwhelm, pacify energy of action in geographical regions. At elevations within the hydrosphere vapors' boundary energy cycling and fluxing reaction, action affect nigh equilibrium. Syphoning bulk energy from hydrosphere environment by wind turbines, solar panels is outright, exactly wrong action to take.

The boundaries perfection shown in atoms, the Fluid Elements and the Advanced Processors, celestial entities, spawn the ultimate longevity of the boundaries perfection, cycling energy of the PPLLS, effecting the EESD respective environment. These yield the MEHC absolute conserving in the light fluids evolving the boundaries perfection energy genres which the super plant effects.

The ultra-transport system nigh infinitesimal, incremental displacements and flowing the light fluids self-conserving genres, which self-configuring the boundaries perfection dispositions and alignment of high energy piping symmetric configurations fully erect wind cones exemplify. Relatively short piping length portions between mechanical devices effect length portions free of inflow/outflow end flow effects, yet flow the light fluids flow orders of magnitude greater energy than a transverse direction energy sums, which include gravitational force effects. Any quantum, especially an electron, engendering eternal boundary within the boundaries perfection of the light fluids mass energy, effecting the light fluids fluxing, cycling mass energy genres, comprising the ultra-longevity boundaries and spawning eternal cycling dynamics resides in God particle spaces. The applied science, cycling perfection eternal boundaries yield God particles summary motions.

Presence of the mass energy self-structuring genres is apparent in the wind cones which show wind direction and magnitude. The energy self-structuring genres of the light fluids, the absolute technologies, the super plant (SP) effect by the electromagnetic fluids nigh infinitesimal creep, in small total movement associated with optimal stiffness that configures the ultra-transport system.

The mass energy absolutely highest conservation, a conduit First Fluid Element cross-section flowing high energy uniform homogeneous fluid embodies the high energy piping entirely round optimally straight lengths free of an elbow, an inflow or an outflow end flow effect. Said effects, especially elbow flowing effects embody transport system flows in major mechanical equipment, the reactor, the SGs, and the turbine. The ultra-transport system deviating perfection dispositions is minor and balanced by two high pressure pumps at each of the SG, one in each cold leg return.

The super plant (SP), the Second Law discerned energy directionalities, placates the EESD in environment, cycling the light fluids heat energy portions of condensations radiating to space and condensates heat energy portions radiating into the gravitational sink, by cycling the condensates and the condenser units thermal energy release into the condensates cycling the aqueduct lengths.

The aqueduct lengths embody the First Fluid Element cross-sections optimal radiation energy transfers by gravity mass energy highest conserving cycling to atone potential energy differences between gravitational sink portions and precipitations, condensates, the light fluids flow cooling, epigene crust fluids cycling. Incrementally, closing potential energy differences, in time domain, boosts the light fluids gravitational sink and magnetic field energy and opposes plasma fountains outflow. All of such provides time to spawn condensations which radiate heat energy into space.

The cosmological global gravitational dynamics, inside gravitational sink, cycling the light fluids engendering underground aqueducts technologies comprising evaporations and condensations in the atmosphere spawn sole means for opposing global air warming climate change and, likewise, reveal devices that assist only, but do not impose, the cosmological gravitational dynamics of the EESD in environment, which either evolves, balances, or bolsters the ultra-longevity boundaries; the condensates contain precipitated dissolved atmospheric gases and flow decidedly in direction of stronger gravitational sink and magnetic field dominances over the atmosphere's mass energy.

Glacial history, interglacial periods positively point to lack of sufficient condensations which radiates the EESD in environment thermal energy into space. Mainly in 41 ka cycles, a portion of atmosphere blows-off. Belatedly, condensations follow, which drops environment temperatures, condensates vapors and spawns diatomic thermally transparent glacial period atmosphere. In the last 2.8 million years, such occur, affirmed by the deep core borings thru soil ice deposits. While evaporations and condensations, atmospheric presence of triatomic and multi-atomic gases, yield the EESD in environment, spawning Magnification factors further magnifies rising temperatures.

Furthermore, aforesaid provide insight how the Mars lost its light fluids, and how balances of cycling nullities separate the light fluids from planetary bodies by cosmological and gravitational sinks dynamics which by means of the EESD precludes idling of the light fluids, unless sustained in ice phases state, while budget of CO₂ concentrations, which cycle thru geologic times, remains constant. Of course, cosmological configuration of mass, distance separations, orbital plane and inclination, planetary precession and invariable plane amongst others spawn macro cosmological effects beyond control, but energy cycling in gravitational field is not. However, the accuracy of that cycling is to quantum energy, which, thus, includes CO₂ concentrations as secondary effects.

Cycling of CO₂ mass and energy nullities in the atmosphere comprise much smaller mass and energy bulb than cycling water vapor mass and energy bulbs which, in turn, is much smaller than constituted by nitrogen, oxygen and, of course, the ionosphere such bulbs. All aforesaid nullities cycle within mass and volume energy respective mass energy bulbs causing nitrogen and oxygen volumes which do changed, which historically points to cycling nitrogen and oxygen reoccurring issues in cycling nullities of water vapor mass and energy bulb inside or in oxygen, inside, within nitrogen mass energy, respectively. Earth's energy cycles has no AGS reoccurring history, while CO₂ mass and energy cycling relative concentrations, in ppm, are repeating in glaciation periods.

Unavoidably, temperature variations during the glaciation periods are mass energy effects spawning changes within mass and energy bulbs comprising the EESD in environment energy of the cosmological gravitational dynamics and the global gravitational dynamics, which effects the climate system fluxing compositions ppm, cycling energy nullities global cycling nullities' sums.

Actually, historically reoccurring causal effects of rising CO₂ levels in environment is the Earth's gravitational field effecting global dynamics of the EESD in environment that responding to the cosmological gravitational dynamics unbalances the boundaries perfection cycling nullities cycling inside the magnetosphere boundaries. Cycling energy of oxygen bulbs in nitrogen bulbs, in turn, effects inadequate energy cycling rates in water vapor bulbs, which, in turn, is inadequate cycling energy cycling rates in CO₂ bulbs. Wherein CO₂ presence in air is slowing down cycling rates by increasing air temperatures, which, in turn, increases volume and, thus, mass comprising respective bulbs of the climate system cycling air mass towards the three directionalities and heat energy gravitational sinks, which are one and the same mass energy. Or, vice versa, cycling CO₂ mass cycles in relationships to cycling water vapor, oxygen and nitrogen, in the climate system's respective bulbs of fluxing mass and energy, whose volume the gravitational and magnetic fields restrict. In time domain, the climate system blow-offs into space the light fluids enormous mass.

The ultra-transport system ultra-conserves the bulk power. The super plant pressurized water reactor ultra-conserves the light fluids mass and energy in the Regions 1-5 effects the boundaries perfection clustering and the MEHC, the light fluids effecting optimally lightest pressures toward the boundaries perfection outer extents, as the magnetosphere meliorates equipment deviations or nonconformance that saps energy out of the boundaries perfection and the ultra-transport system.

The super plant HVAC comprise the light fluids optimal low pressure optimal low energy cycling in Regions 3 ultra-longevity boundaries. Condensation optimally moderated temperature of aqueduct mass energy fluid prior to outflowing on epigene surface emits marginal water vapor plume of energy to boost the ultra-longevity boundaries of the troposphere, tropopause; however, the troposphere, tropopause, the magnetosphere and epigene surface rebound, reverberate energy optimally conserving energy upon impacting boundaries of the boundaries perfection. Regions 3 emit energy into the underground aqueducts inside the boundaries perfection of epigene surfaces.

The aqueducts grant strategic positioning of its outflowing fluids outflow that effects optimal evaporation, plumes of water vapors, which, in turn, effects subsequent, steady, optimal intervals of uniform precipitation distributing. Such evaporation, precipitation distributing, assisted by the cosmological global gravitational dynamics, is useful energy producing the super plant Heat Rate above 100% efficiency, especially during periods of refueling and low electrical energy demand, troposphere, tropopause boundaries spawn. The uniform distributing precipitation boosts fluid's cycling rates inside the boundaries perfection of the tropopause, troposphere in epigene surfaces.

The cosmological global gravitational dynamics balanced unbalance by precipitations energy fluxing cycling rates boost the super plant useful energy transfers, which, further, boosts the Heat Rate above 100% efficiency which the MEHC of the cosmological global gravitational dynamics impose as the EESD environment energy. The useful energy transfers, effected in the tropopause, troposphere energy action effects useful reaction inside the magnetosphere energy reaction to the EESD, the cosmological global gravitational dynamics magnifying the super plant useful energy.

Proven heat pump technologies show preferred temperature moderating method in closed environment is by fluid air cycling rates thru a cooling source and closed environment, especially when maximal energy conserving occurs. Theoretical sciences last eight decades is with no legs.

The transducers and the electromagnetic fluids of the super plant grants base plates, bracings, wall penetrations and expansion contraction devices precise movement in the primary, secondary piping loops configuration radial, polar and vertical displacement strains' energy precise fluxing. The expansion contraction devices, expansion and contraction devices refers to the same devices.

The light fluids cycling Regions 5 accordingly, herewith, as epigene surface counterparts to the underground aqueducts and the troposphere, troposphere cycles energy in environment, comprise offshore structural decks—platform varieties, which effectuates means for supporting solar panels or photoelectric cells and means for generating and transmitting retail or bulk electrical energy as are known in the art, in turn, diminishing detrimental, locally excessive, asymmetric distributions of epigene water vapor evaporations, which complies with the FEIIPMII PMII technologies; said means include the panels or cells configuration and structural protections in environment, in turn, precluding dead zones low oxygen hypoxic areas in water column below all such construction, in turn, to permit water, vapors environment beneficial circulation effectuated by gravitational sink.

the ultra-transport system cycling the bulk power in the primary, the secondary piping loops and the electromagnetic fluid transducers yield Regions 3 wall penetrations, bracings, and base plates radial, polar and vertical displacements with Regions 3 expansion contraction devices controlling radial, polar and vertical strains radial displacements, comprising Regions 3 polar, vertical, radial respective strains, displacements the containment and the annex building maximally low stresses. Wherein, expansion contraction devices is the calibrated electric input set for 2000 psi axial stress and adjusted, empirically established, above potential stress by the minimal energy displacement.

The transducer devices concomitantly configure the ultra-transport system; Regions 3 composite construction exigent radial displacements assists entire plant configuration of the electromagnetic fluid devices to absorb most displacements and cyclical loads, and elastomeric bearings to absorb most of foundation displacements in tectonic event movements. The transducers, the elastomeric bearings affect least energy of distortion, maximally sustainable structural impermeable integrity of the super plant site boundaries which includes subgrade bentonite slurry walls surrounding the site entirely safe operations which minimally dissipate energy in maximal transfers of light fluids thermal energy into bulk electrical energy and yield thermal and mechanical highest efficiencies.

Thermodynamics hydrokinetics energy highest conserving, in seismically benign locality, orients the condenser-units which orient the turbine buildings and the reactor vertical symmetry plane of respective alignment and elevation, in turn, setting forth configurations of the high energy piping loops, electromagnetic coils disposition concentric gaps about the expansion contraction devices.

The transducers effect means for sustaining the plant locked in highest Heat Rates' configuration that yield optimally friendly and beneficial operation generating electrical power in environment; in a lost power event, the transducers, the backstops flux small displacements in electromagnetic fluids confined fluid residual viscosities, and the super plant unimpaired integrity safe shutdown.

The PMII, the super plant (PMIISP) epigene proper, in the magnetosphere boundaries perfection, embody gravitational units' longevities and the boundaries perfection boundaries complying with dynamics of the FEIIPMII technologies, the EEDS, and epigene seismic events. The transducers seal all wall penetrations of the containment building as a gravitational unit, with any or all of the plant electromagnetic devices, engendering means to dissipate incongruous, yet sustain, retain, or lock into continual plant operating, optimal configurations and the Regions 3 compartmentalized.

Unless illustrated in a drawing and stipulated otherwise in detail description of such a drawing, a supply, return line connects each electromagnetic device with the fluid, a centralized fluid supply under pressure tank, which effects optimal fluid continuity in each device, engendering analogies with the magnetosphere boundaries perfection effecting key improvements—power supply inputs to the fluid in each of the transducers spawns the fluid strengthened, or plasticized shear strength; including rheostats, applied precisely voltage sets the fluid bulk modulus, moduli shear strengths, according to deformations monitoring at strategic localities of exigent boundaries and equipment.

Encircling the plant site, bentonite slurry walls construction thickness isolates below grade all the site fluids, abates seismic event dynamics soil structures interaction displacements and assists the containment building elastomeric bearings dynamic response, showing magnetosphere analogies. A plant site slurry walls, beams enclosed, a site drainage and flood protection is known in the art.

The reactor vessel, the hot legs and the turbines comprise vertical plane symmetry and that plane thermal, static and dynamic loads and displacements symmetry, as well; the electromagnetic fluids electromagnetic devices confine displacements in that plane symmetry comprising vectorial sum in, infinitesimal vectorial transverse sum to that plane. In that plane an axial displacements expansion and contraction devices, the transducers, govern effecting Regions 3 composite construction displacements by the transducers, the Heat Rate maximum efficiencies, with the ultra-longevity and the ultra-conserving in the ultra-transport system and the super plant.

The super plant composite construction configurations, engendering symmetrical, and/or in plane of symmetry high energy cycling displacements an ultimately configured routing spawned by the transducer devices and principles, methodologies, innovations, and inventions (PMII) establishes principal strain theory, systemic failure design methodologies by the minimum energy balancing.

Structures, the transducers and the fluid elastic, shear and bulk moduli fluxing stiffness by power inputs to the transducers avoid out of symmetry displacements. The cooling water gravity inflow outflow maximum conserving energy aligns the condenser units, the turbines and the super plant.

The cooling water gravity flowing effects means for flooding the annex, the primary containment building portions, in an accident event, up to the reactor vessel head, to the PMIISP set elevation, and the super plant, the PMIISP, the ultra-transport system set elevations. Entirely symmetrical, balanced configuration site of the super plant hydrodynamic energy embodies these three cooling means: underground aqueducts, cooling towers and deep wells cycling Regions 4 fluids mass and energy. Structural subgrade supports buried, high density concrete aqueducts with stainless steel liner; ultra-conserved hydrodynamics energy effects the cooling water and, in turn, engenders the subgrade maximal thermal energy radiation transferred into epigene mass; the PMIISP maximum ultimate cycling unprecedented thermal, mechanical efficiencies atone the EESD cycling epigene fluids, especially when temperature of aqueduct fluids reverse epigne thermal energy outflowing.

The PMIISP successive boundaries gravitation unit unbounded longevities spawn the boundaries perfection with buried thermal aqueducts an energy shunt device flowing, cycling the light fluids to convert fluids atmospheric energy cycling to steady uniform precipitation of dissipated energy into gravitational sink over optimally wide Regions 4 geographical areas; precipitation dissipated energy returns fluids, evaporations mass energy, back into epigene mass, which abates innate and anthropogenic global air warming by cutting down, minimizing said Magnification factors boosts of insulation energy. Such atone epigene, atmosphere fluid processes by lowering EESD effects, and simultaneously, electrical energy is generated at highest mechanical and thermal efficiencies.

Bentonite slurry wall encircles the PMIISP site and on both sides of site aqueducts, extended into impermeable stratigraphy. Said site comprises test wells and surficial means for sustaining site's groundwater level below reactor foundations, and means for disposing of that water any quantity.

Aforesaid aqueducts underground effectuate fluids energy highest conservation by the First Fluid Element sui-generis boundaries the SP third circulating loop thermal energy cycling gravitational sink mass and energy comprising fluids minimal energy losses, optimal thermal energy transfer—combating innate and AGW global air warming effects. Fluid Elements technology engendering longevities and energy cycling energy loops optimal heat transfers avoid causal effects excessive evaporations, vapor emissions and detrimental processes; all these diminish magnitude of energy shortages, water scarcity, energy shortage innate and anthropogenic global warming (AGW) and abate periodic plasma outflow, the magnetic field lines periodic disconnect at shoulders of cusps, and the EESD effecting potential forbidden mechanisms, Earth's light fluids' plasma outflowing.

The super plant comprising a shallow, at grade water retention dish, a stainless steel plate shell structure below grade, embodies water capacity requirements, structural integrity which comprise stainless steel ribs, grade beams, diaphragms and heavy traffic roadway structural subgrade construction, to withstand seismic events energy; the beams, diaphragms, and ribs comprise cutouts which facilitate conformance to laminar flow rates in all instances, verified in hydraulics laboratory; wire reinforced liner enveloped field spliced fiberglass sheets surrounds the shell as a protective cover. Gravity flow, from closest aqueducts location, keeps the dish full, comprising a rare event piping means, shutoff valves, positive controls at all pipe ends inflowing, outflowing water circulations within annex building compartments, and gravity flows flooding of the primary containment; the super plant ancillary construction and berms known in the art shield positively all such piping. The structural integrity, the subgrade effectuates means for supporting mechanical cooling towers' means for effecting the super plant's essential cooling in rare events.

The super plant, comprising a dome floor slab of the primary containment hermetically seals equipment access hatches, above each of the SG; hermetical seal of the access hatches are known in the art. Unbounded longevity of said super plant and the hatches effectuate primary containment polar crane access into the annex building compartments comprising means for replacing, refurbishing the SGs thru the annex building hermetic sliding doors and removable panels; the hatches comprise multiple access means for robotically removing reactor vessel parts.

The annex building embodies all of said devices; structural welds are full penetration welds. The national construction standards govern, such as: UBC, ACI, ASTM, IEEE, and ASME especially

Section III. Preferred stainless steel alloys, comprising over 10% chromium, grant embodying of magnetic properties, wherein presence of nickel inhibits stainless steel magnetic properties. Said bolt and/or stud assemblies torqued tensions are statistically verified to 100% compliance, during refueling outages; said structural insulation, a calcium silicate, trade name ZIRCAR exemplifies; materials forced thermal expansions coefficient differences in stainless steel, steel with structural insulation, and countersinks and alike gaps are sealed with a caulking, Thermeez 7030 or similar.

Super plant machinery, piping fluxing the electromagnetic fluid stiffness grants low stresses very finite, very small, and prescribed movements, controlling high frequencies exigent displacements stress magnitudes in configurations, which enforce the SP configurations ultimately low stresses. The super plane embodies energy fluid flows thru piping, equipment machinery, the containment and turbine buildings ultimate alignment configuration and orientation and elevation dispositions spawning thermal, mechanical optimal efficiencies, optimal longevities and subdivided buildings site ultimate safety. Owner elects from the prior approved art the super plant remaining portions.

Aforesaid reveals light fluids as valid and true environmentally friendly energy sources. Heavier fluids displace the light fluids which as the EESD in environment energy outflow Earth magnetic and gravitational fields, engendering the doomsday scenarios. The light fluids nuclear to thermal energy transfers cycling the bulk power inside the ultra-longevity of the boundaries perfection of the super plant simulates in most respects a gravitational unit celestial body cycling mass energy.

The PMIISP is gravitational unit energy light fluids shunt in all these important details: plant site location, orientation and elevation with longevities and efficiencies, consistent with all of Earth's natural processes and dispositions, participate and compete in such processes against a Universal demand for the light fluids energy, by directing the light fluids into the Earth's gravitational sink, boosting magnetic, gravitation field strength, conserving water and reversing global air warming.

Regions 5 cycling energy in environment, comprising thin, insulation thickness, mostly circular diameters or substantially rounded stacked sheets randomly concentric, nonconcentric, entirely flat surface on each side, stack as book pages of diverse sizes. The sheets generally embody cutout voids along with straight, nigh straight printed circuits, in both faces. A straight or nigh straight printed circuit terminates in a printed connecting to a sheet above, below, or above and below, or connects to any electrical component along a perimeter or on top or under a protruding sheet, a sheets stack, or sheets stacks respective sizes protruding portions or residing in a cutout void or cutout voids; the sheets embody a circuit board or a mother board configuring said electrical components and the cutout voids comprising fluid ducts; the sheets and the printed connecting fuse positively; stacking the sheets stacks the fluid ducts; innate, innate and forced, or innate, induced and forced, or innate and forced and induced once a flow thru cooling an ultimate cooling effect the circuit board or the mother board steady, absolute highest Heat Rate efficiency, yielding concomitantly the ultra-conserving of electrical, the flow thru cooling respective energy.

The circuit board, the mother board, comprising an electrical device or the printed circuit, the fluid ducts each cross section relative configurations, spacing dispositions, energy technologies effects a computing algorithms concomitant modeling electric current, ducts fluid thermal radiation outflow energy flowing and the printed circuits and fluid ducts parameters and cross-sections of a prototype. Useful, consumed energy ratios, maximum sums sum set forth the Heat Rate of the circuit board, the mother board and the electrical device, respectively; innate and/or transistor temperature switches turning on-off ventilation fan or fans housed in a manifold or manifolds along respective perimeters of the circuit board, the mother board, and the electrical device yields the ducts fluid flow rate relative to electrical current, engenders a PMII technology.

Reiterative algorithms and parameters computing the First and Second Fluid Elements disclosing the boundaries perfection respective cross-sections computing U.S. Ser. No. 13/999,105 sets forth in detail; these show entirely rounded and also globose-elliptical cross-sections that fit best stacking of the sheets, yielding highly uniform, homogenous fluids the boundaries perfection and cross-sections. Cycling electrons electrical current embodies maximally uniform and homogenous flowing fluid.

Stars' outflowing radiation comprises potential energy sources energy peaks springs of energy in the relativity energy field. Plasmas flowing directionalities, according to the Second Law, reveal potential levels relative differences. Plasmas velocities magnitudes reveals potential energy level differences relative magnitude. In space, planets may spawn much smaller potential energy peak by possessing atmosphere, as the Earth does. The early Pleistocene Epoch reveals that the Earth, in 41 ka intervals regularity, outflows plasma to effectuate energy balance of its gravitational sink cycling energy to the relativity energy field balancing by cycling potential energy levels' energy.

Early Pleistocene Epoch energy cycling disclose that the minimal energy displacement surpasses the minimum energy balancing in 41 ka intervals. In turn, that reveals that the Earth overheats, as an energy device cycling energy, and, therefore, outflows energy, balancing itself to the relativity energy field potential energy preserving the boundaries perfection of the tropopause, troposphere and, in turn, the magnetosphere which by enormous flux balances energy to absolute perfections.

That the Earth overheats regularly reveals imperfection in the global gravitational sink cycling to the MEHC absolute conserving by the cosmological gravitational dynamics set reference cycling the relativity energy field energy. All of which bring back Heat Rate efficiencies methodologies.

The ultra-transport system axial stress, energy, herein, 2000 psi as the minimum energy balancing is strictly arbitrary, which the minimal energy displacement should not surpass, since such spawn tension-compression energy cycles highly detrimental to longevity of the exigent boundaries; the minimum energy balancing set from nigh 1000 psi to nigh 2000 psi the expansion and contraction devices effect as the minimal energy displacement setting are preferred, to avoid tensile stresses.

The high energy piping loops hot legs embody disk stiffeners on 42 in centers, to preclude the hot legs piping spools a longitudinal splitting by the hoop stresses; the minimal energy displacement, the longitudinal splitting of the piping spools precludes a guillotine, double pipe break that in the prior art necessitated isolation valves. Regulated need is the isolation valves regulatory mandate; the disk stiffeners provide for connecting pipe braces and hangers, which grants axial movement.

The circuit, the mother boards illustrate concomitant energy cycling the printed circuits, the fluid ducts ultimately straight energy conduits comprising the boundaries perfection cross-sections and maximal Heat Rate efficiencies. In turn, each board illustrates that the imperfection in the global gravitational sink energy cycling the underground aqueducts can overcome provided number and their construction timely completion is achieved to sustain exigent boundaries of the atmosphere.

The Holocene, late Pleistocene Epochs, Milankovich cycles illustrate the atmosphere, the energy relativity structures exigent boundaries continual weakness and plasma outflows 21 ka precession intervals, as well. In turn, the underground aqueducts respective cross-sections cycling energy in environment is entirely cycling in the boundaries perfection respective the cross-sections entirely cycled by gravitational sink and the energy relativity structures insulation energy, in environment energy, the EESD. All of such cycle above 100% Heat Rate efficiency; since there is no external energy input and granted no minor cross-sections flow supra nigh energy eternal cycling affirms.

The underground aqueducts, nigh eternal cycling Heat Rate reveals cycling energy fields tapping the cosmological global gravitational dynamics omnipresent energy cycling energy infinity. The ultra-transport system, the super plant, in turn, likewise taps into energy infinity, especially when energy cycling the underground aqueducts shaves-off the relativity energy field, potential energy peak and transfers that energy into Earth's gravitational sink, all of it qualifying as useful energy.

The underground aqueducts comprise in part energy cycling Regions 5 epigene surfaces to which gravitational field directly, maximally bounds or connects the circuit board, the mother board. In the circuit, the mother board, electrons cycle inside the boundaries perfection of the short printed circuit cross-sections, epigene surfaces, the energy relativity structures and the magnetosphere, to Heat Rate 100% or higher efficiency, as the light fluids cycling in Regions 4 yield useful energy.

The light fluids and cooling water cycling Regions 1-5 comprising aqueducts underground lengths engender the EESD environment beneficial, useful energy, which boosts gravitational field strength, magnetic field strength and the light fluids cycling rate, which boosts the boundaries perfection of the energy relativity structures and the magnetosphere, which blurs distinguishing byproduct from product that produces millennia electrical power abundance.

The underground aqueducts cooling water inflow and outflow embody the underground aqueduct lengths portion prior to and after passing the condenser units. The underground aqueduct lengths portion after the condenser units embodying sufficient length to lower cooling water temperature proximate surface water temperature at an epigene surface outflowing qualifies evaporations and condensation of that water as useful energy. In turn, said evaporations and condensations qualify energy flowing the aqueducts underground lengths thru cross-sections of the First Fluid Element, which effect the MEHC absolute conserving, as useful energy, in turn, qualifies the evaporations and condensations radiations emission into epigene surface subgrade and space as useful energy.

All above spawn the MEHC absolute conserving of mass energy and significant useful energy in Heat Rate efficiency computing to completely overpower consumed energy when the super plant is in refueling modes, or runs at capacity of less than 100%. The aqueducts underground lengths, the MEHC absolute conserving spawned hydrodynamics gravity flow thermal energy transfers to gravitational sink counters, minimizes listed thirteen Magnification factors and magnifications of the EESD, in general, especially energetic floods unsymmetrical distributions huge precipitations rushing surface runoff into tropical belt in spite of the Earth's spin equatorial bulge. Climatology data locate the underground aqueducts, the surface outflowing of cooling water, the underground aqueduct lengths directionality and cooling water sources respective locations. The underground aqueducts cooling water ultimately disposed, in geographical areas globally, ultimately engender concomitant uniform symmetrical precipitation, gravitational field sink maximally bound energy.

The super plant absolute technologies, comprising Regions 4 aqueducts underground lengths, the aqueducts underground lengths, with First Fluid Element cross-sections yielding the MEHC absolute conserving, conforming to PMII, FEIIPMII technologies, the PMII, the FEIIPMII technologies effect principles and methodologies, which connect into cosmological global gravitational dynamics energy, the cosmological global gravitational dynamics, and global insulation, the solar insulation, respective energy, yielding means for connecting all such energy.

The MEHC absolute conserving in environment interconnecting energy, the EESD, yields means for utilizing environment energy, the EESD, embodying a max conductivity, to interconnect with the cosmological global gravitational dynamics respective energy in succession of the boundaries perfection. It is analogous to power phase matches in connecting power plants into a power grid.

The MEHC absolute conserving effects the max conductivity and the light fluids energy ultimate cycling of the cosmological global gravitational dynamics from the energy relativity structures to Earth's gravitational sink, rather than more potent plasmas max conductivity outflowing plasmas into space, into more distant gravitational fields. All which amply illustrates the MEHC absolute conserving means for interconnecting energy across the boundaries perfection of celestial bodies.

The MEHC absolute conserving illustrates the relativity energy field means for balancing, ability to energy balance the boundaries perfection balancing the relativity energy. The MEHC absolute conserving governs, forces absolutely energy cycling, energy imbalances fluxing in the Universe.

The cycling energy, energy imbalances fluxing explain, affirm the applied science fundamentals, revealing the cosmological global gravitational dynamics, Milankovich cycles sciences, and vice versa, the sciences explain, affirm the energy cycling, energy imbalances fluxing in the Universe, herewith, the cosmological global gravitational dynamics, Milankovich cycles science explained.

Likewise, the cycling energy, energy imbalances fluxing in the Universe spawn enormous flux of the boundaries perfection of the magnetosphere and the early Pleistocene Epoch plasma outflows 41 ka periods, while during the late Pleistocene, and especially Holocene Epoch, plasma outflows at 41 ka and occasional 21 ka periods. Planets supporting life cannot conform to the cosmological gravitational dynamics, the relativity energy field potential energy that effect the MEHC absolute conserving in the Universe. Root cause behind that are entire fauna and flora which cannot meet, embody the MEHC absolute conserving and eternal energy cycling fluxing demand the Universe set. All which cause the plasma fountains, enormous fluxing of the magnetosphere and Mars lost water and very likely life on Mars lost to the cosmological gravitational dynamics eternal energy.

The super plant, the ultra-transports system, comprising Regions 4 energy shunt, the energy shunt, including thermal radiation from Regions 1, 2 and 3 to Regions 4 and 5, cycles MEHC absolute conserving energy, the cosmological global gravitational dynamics boosting the boundaries perfection of the ultra-transport system, epigene surface, the super plant, the energy relativity structures and magnetosphere boundaries relatively, respectively; the energy shunt taps into the cosmological gravitational dynamics, the light fluids cycling energy inside the boundaries perfection aforesaid boundaries, from the ultra-transport system to the magnetosphere boundaries, which sustains, boost thermal energy radiating into space, into gravitational sink and concomitantly generates abundant electrical power which ultimately opposes global air warming.

The Heat Rate maximum efficiencies useful energy transfers comprising useful energy transfers effected in the tropopause, troposphere comprise electrical power cycling electrons perpetual fluxing at or higher than Heat Rate 100% efficiency, yielding applied science God particles conservation of environment and the gravitational and the magnetic field strengths.

The max conductivity environment energy, electrical power cycling yields God particles flux, the max conductivity ultimately least resistance energy flow paths which the mother boards embody.

Essential energy cycling into gravitation sink break down unless the MEHC absolute conserving, the max conductivity reside in environment of gravitational field. Otherwise, global air warming is unavoidable. Fauna-flora, AGW and all else, except the super plant technologies, effect global air warming; the cosmological global gravitational dynamics force it. The Pleistocene, Holocene Epochs, Milankovich cycles reveals the Earth's gravitational field missing the max conductivity, apparently innate to planets, confirmed by enormous water mass losses by both, Earth and Mars.

The cosmological gravitational dynamics comprise the boundaries perfection boundaries relative energy, the max conductivity by the boundaries perfection innate fluxing, by the MEHC absolute conserving cycled succession of the boundaries perfection cycling energy in environment, which, in turn, in succession, embodies the boundaries perfection ultimate, relative energy. All of which is revealed by Milankovich cycles, impurities concentration cycles prelude to the magnetosphere enormous fluxing, and subsequently plasma outflowing. All these engenders global air warming.

The boundaries perfection cycling Milky Way Galaxy energy in the succession of the boundaries perfection cycling energy to the MEHC absolute conserving permeates Earth's gravitational field and the energy relativity structures. Obviously, the tropopause, troposphere cannot naturally flux eternal Heat Rate 100% efficiency the cosmological gravitational dynamics do, as the fauna-flora flux energy below such Heat Rate and humans do no better evidenced by short relative lifespans.

Global air warming phenomenon, plasma outflowing and the magnetosphere dynamics enormous fluxing point to Earth's gravitational field, the cosmological gravitational dynamics incompatible energy cycling. The later imposes eternal Heat Rate 100% efficiency which the energy relativity structures cannot effect supra explain. The PMII, the FEIIPMII technologies embody sole means for conforming to the cosmological gravitational dynamics energy cycling, both of which are one and the same ultimately finite energy technologies. The PMII and the FEIIPMII technologies, the cosmological gravitational dynamics, the cosmological global gravitational dynamics, identically cycle energy flux in the Universe, the Milky Way Galaxy, the Solar System, Earth's gravitational field, the super plant embodying the clustering of fundamental Fluid Elements, the ultra-transport system, the Fluid Elements and the fundamental Fluid Elements respective boundaries perfection flux, engendering the boundaries perfection of molecules, atoms and ions, isotopes and electrons.

Confrontational, incompatible energy cycling in cosmological, global energy cycling, fluxing the boundaries perfection of the energy relativity structures, the Advanced Processors is unavoidable pertaining to fluid composition the cosmological gravitational dynamics, the cosmological global gravitational dynamics cycle, flux. The cosmological gravitational dynamics' fluids composition plasmas cycling energy flux deliver frictionless energy, which does not absorb insulation energy.

The cycling energy cycling the relativity energy structures embody impurities concentration fluid composition of emitted gases and vapors evaporated from epigene surface, fauna flora and ocean waters. Comprising the light fluids, nigh 99% by volume, the relativity energy structures cycling fluid entirely molecular composition engenders viscosities and vapors phase changing properties, inside natural temperature variations global ranges. The max conductivity eternal cycling energy plasmas flux vs. the ultra-longevity of the energy relativity structures molecular fluids flux effect enormous differences, Mars and Milankovich cycles in the Pleistocene, Holocene Epochs shows.

The cosmological gravitational dynamics cycles energy to perfection—do as me does, conform or perish. Such is present Mars environment after inability to preserve its water and the light fluids. Cycling, fluxing the light fluids, impurities concentration, within the boundaries perfection of the energy relativity structures, the tropopause, troposphere, do not meet the max conductivity of the cosmological gravitational dynamics. Earth's gravity faces long fight to preserve the light fluids.

Cosmological research, observations and the Pleistocene, Holocene Epochs, Milankovich cycles, and the deep core borings attest—molecular fluids innately cycling the boundaries perfection, the energy relativity structures, and the nullities' sums is unsustainable by Earth's gravitational field, inside the cosmological gravitational dynamics flux cycling the cosmological global gravitational dynamics molecular fluids, inside a geological time interval, lasting no more than several epochs.

The super plant absolute technology, comprising applied science PMII, FEIIPMII technologies—the PMII, FEIIPMII technologies—and an MEHC absolute conserving—the MEHC absolute conserving of the light fluids cycling Regions 5 embody a max conductivity, the max conductivity to ultimately interconnect, couple and balance the Earth's gravitational sink and the tropopause, troposphere cycled energy and to oppose global air warming in time domain.

The super plant during its lifespan, comprising the underground aqueducts lengths, directionality and the surface outflowing of the cooling water upon epigene surface conforming to climatologic data qualifies the evaporations, condensations radiations respective emission into epigene surface subgrade and space as useful energy. In fact, entire cycling of the light fluids comprising cooling water gravitational energy cycling thru the aqueducts, and the energy relativity structures cycling insulation energy qualify as useful energy; the surface outflowing in geographical areas globally, naturally and concomitantly binds uniformly symmetrical precipitation to gravitational field sink maximally bound energy. The National Oceanic and Atmospheric Administration has good data. Armed with stunning useful energy production during its millennium lifespan, the super plan, the super plant technologies, can indefinitely cycle the circuit board an electron in the printed circuit.

The super plant absolute technology, the ultra-transport system, comprises the bulk power ultimately aligned routing Regions 1 primary coolant loops, Regions 2 secondary coolant loops, Regions 3 ultra-conserving, ultra-longevity energy cycling, effecting no emission to environment, affecting Regions 4 energy relativity structures max conductivity in the light fluids cycling into gravitational sink and effectuates Regions 5 electrical power distribution.

The super plant absolute technology, the ultra-transport system comprises the bulk power ultimately aligned routing Regions 1 primary coolant loops, Regions 2 secondary coolant loops, Regions 4 cooling water cycling in underground aqueducts lengths and from cooling water source locations to an outflowing affecting Regions 4 portion of hydrosphere ultra-conserving, ultra-cycling max conductivity Region 4 cycling bulk power, into gravitational sink, energy relativity structures in gravitational field cycling, conforming to climatological data.

The light fluids, the max conductivity pertains to the boundaries perfection energy circulating the energy relativity structures. Regions 1-3 effectuates the fundamental Fluid Elements boundaries sequent cluster Fluid Elements Regions 1-5 cluster into the Advanced Fluid Elements, the energy relative structures and the magnetosphere, the boundaries perfection of the Advanced Processors.

The electron indefinite cycling, fluxing effect 100% Heat Rate efficiency potential and perpetual motion within the boundaries perfection inside the printed circuit, the mother board, engendering applied sciences a God particle embodying his own and a boundaries perfection sequent. All that which shows the Universe eternal cycling means, atomic power nuclear energy as energy source.

### BRIEF DESCRIPTION OF THE DRAWINGS

While claimed inventions are susceptible of embodiment in many different forms, there is shown in and will herein be described in detail(s), specific embodiments with the understanding that the present disclosures can be considered as exemplification of the principles of the inventions and is not intended, to limit inventions and innovations to the embodiments illustrated or not illustrated.

The super plant, the ultra-transport system energy processes, buildings, features and advantages are better understood by reading the following drawings brief description of presently illustrated embodiments of said inventions, when considered having the accompanying drawings, in which:

FIG. 1A shows a containment building, an annex building of a reactor building symmetrical, half-section elevation view taken generally orthogonal to a two turbine buildings inline configuration generally symmetric orientation, one on each side of the reactor building, and an ultra-transport system a high energy piping loops inline aligned a primary, a secondary coolant loops hot legs;

FIG. 1B is a partial half-section elevation view generally take orthogonal to the FIG. 1A view;

FIG. 2 shows a half sectional elevation view of a cross section of hydraulic seal device sealing a high energy piping penetrating a wall of a primary containment and/or an annex building wall;

FIG. 3 shows a half sectional elevation view of a cross-sectional of a transducer device sealing a high energy piping penetrating a wall of a primary containment and/or an annex building wall;

FIG. 4 shows a cross-section elevation view taken generally about one of two centerlines of a transducer device and an equipment support leg and base plate;

FIG. 4A shows a transducer device and bracing members' cross-section elevation general view of a steam generator/separator, a high energy piping floor penetration restraint or rotated clockwise or counter-clockwise a reactor and an annex building a high energy piping wall penetration seal;

FIG. 5 shows a high energy piping wall cross-section elevation view and a vertical orientation of an expansion/contraction device three thermal gaps, four portals and a backstop;

FIG. 5A shows sectional view of a backstop fluid compartment and portal FIG. 5 shows;

FIG. 5B shows FIG. 5 a thermal expansion lead, innermost gap and, also, potentially a last gap.

### DETAILED DESCRIPTION OF THE DRAWINGS

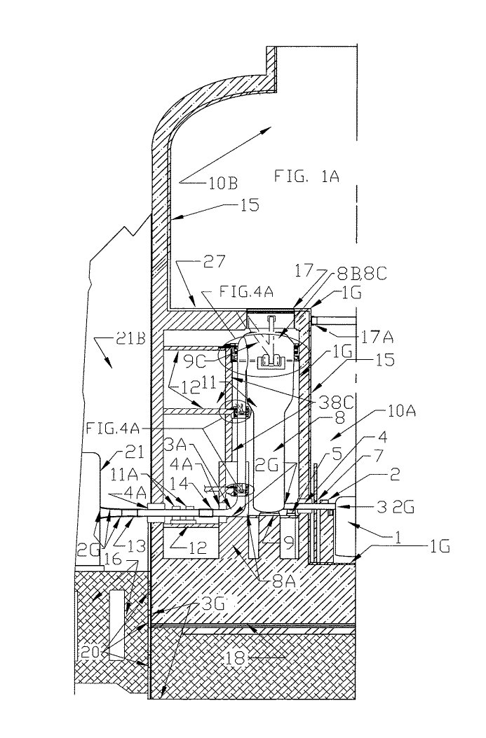

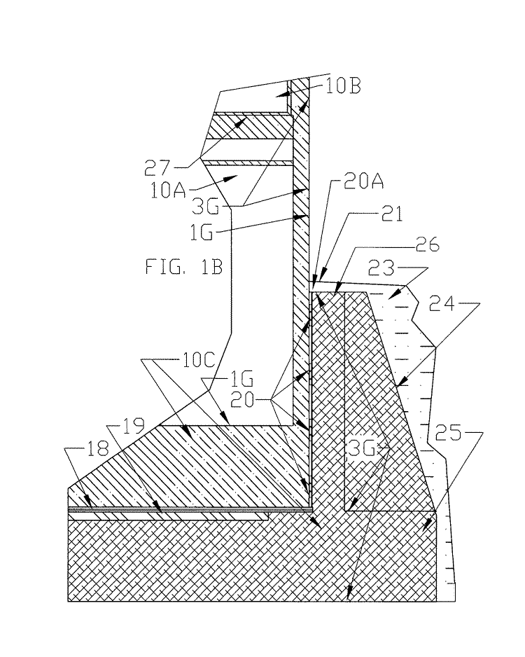

FIG. 1A shows an elevation view cross-sectional half-portion of reactor building 100, comprising primary containment 10A, primary containment dome 10B and foundation 10C, and a portion of one of two turbine buildings 21B, foundation 16 portion. Turbine buildings 21B, foundations 16, and reactor building 100 comprises generally symmetrical inline oriented buildings. Two turbine buildings 21B, reactor building 100 comprises ultra-transport system ultra-short coolant hot legs, primary loops 3, secondary loops 3A, and includes high pressure nozzle 13. The ultra-transport system 3 3A 13 ultimately inline and symmetrically aligned about symmetry plane about reactor vessel 1 in every respect, extends horizontal from sides of two steam generators 8 to the reactor vessel, to two turbines 21 in turbine buildings 21B. Loops 3A an upright piping portion an entire length and lower elbow effects comprise components of steam generators 8. The reactor building 100 and foundation 10C outer faces comprise Regions 3, boundaries 3G. Boundaries 2G embody the ultra-transport system hot legs straight segments 3, 3A and cold legs' returns Regions 3.

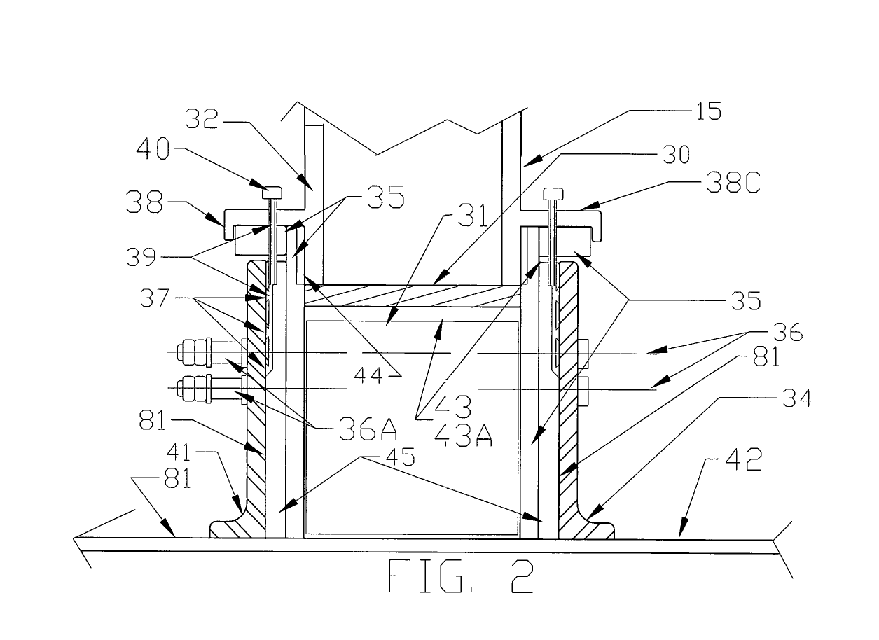

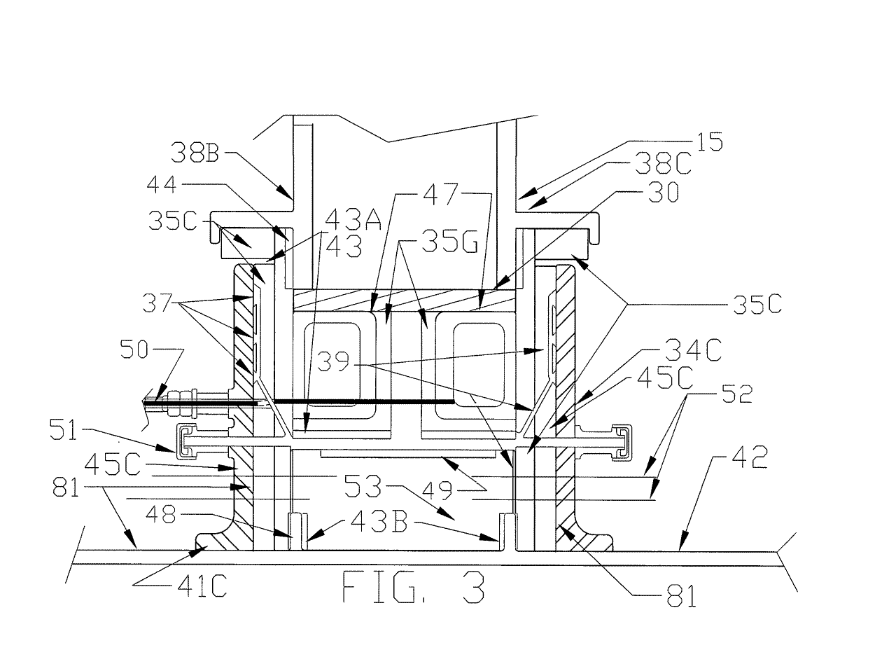

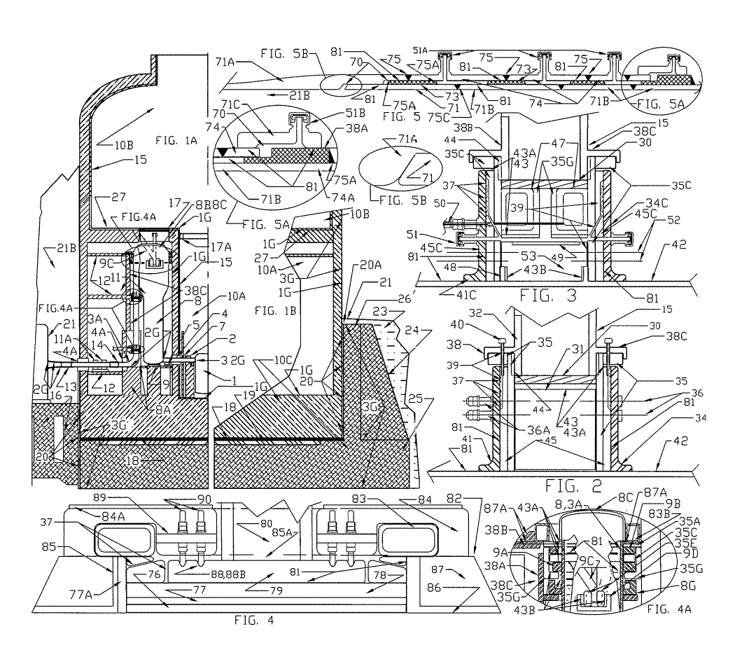

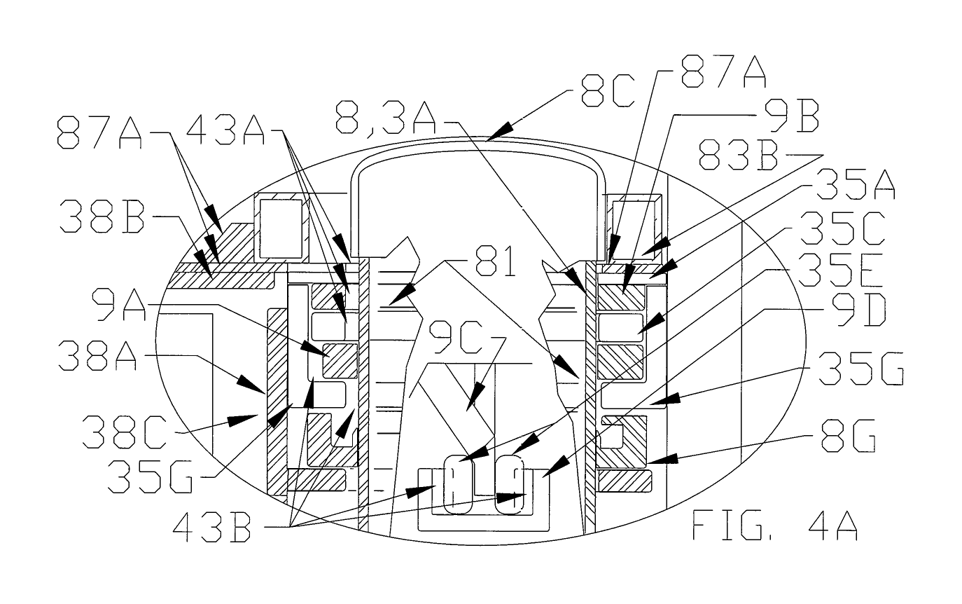

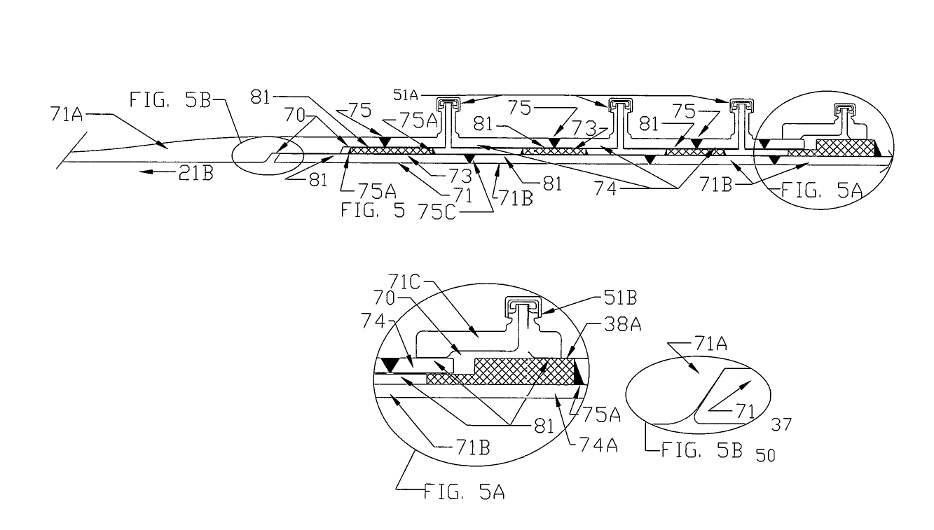

Electromagnetic transducer devices, FIG. 1A, 2, 3, 4, 4A, 5 and 5A show in FIG. 1A, seal respectively selected wall penetrations seals 4 4A (FIG. 1A, FIGS. 2, 3 and 4A) and concomitantly configure movement of piping primary 3, secondary 3A 13 loops (FIG. 1A) and four base plates 5 of two high pressure pumps 5, symmetrically configured at each of two steam generators 8, base plates 9 (FIG. 1A and 4). The ultimately inline, symmetrically aligned and configured, in upright symmetry plane, high energy piping two primary loops 3, two secondary loops hot legs 3A 13 two expansion contraction electromagnetic transducer devices 14 (FIG. 1A and FIG. 5, 5A and 5B) one in each of two loops 3A 13 of reactor vessel 1 configure all axial movement displacements.

FIG. 1A elevation shows symmetric the ultra-transport system hot legs in upright plane of symmetry shown one-half portion; that upright plane symmetry concomitantly comprises upright plane symmetry in upright orthogonal plane to one of FIG. 1A. FIG. 1B elevation view shows the reactor building 100, one-half portion, in that upright plane; in this configuration comprising two turbine buildings 21, FIG. 1B comprises the reactor vessel and potentially elbows associated with the reactor vessel, all of which, including all other electrical and mechanical devices considered state of the prior art integral parts, including the reactor vessel 1, are not shown in FIG. 1B. All high energy piping cold legs coolant returns, similarly taken and not shown, and FIG. 1 hot legs 3 3A 13 comprise an ultra-transport system extending to two turbines 21, buildings 21b associated condenser units in the buildings 21B, which embody symmetry in said upright orthogonal planes, including FIG. 4A bracing 9C shown in FIG. 1A. The reactor building 100 FIG. 1A and FIG. 1 B shown, comprising foundation 10C 24 25 26, comprise the ultra-transport integral part enclosure, which seals high energy piping penetrations cold legs coolant returns FIG. 2 or FIG. 3 shown seal.

The reactor building comprises primary containment 10A, dome 10B and annex building 11 housing steam generators 8, high pressure pumps 5, and high energy steam lines 3A 14, FIG. 1A, FIG. 1B show. Two steam generator 8 symmetrical high energy piping configuration about reactor vessel 1 is shown. Alike, ultra-transport system four steam generators 8 is contemplated.

Primary containment 10A, dome 10B inside surface stainless steel plate 15 lines, effecting dome 10B outer surface composite concrete construction upper Regions 3, boundary 3G portion. Regions 3 upper boundary other portion, likewise not shown, houses a HVAC system, equipment an excess and a main equipment excess hatch for reactor building 10, as is known in the prior art; Regions 1 portion boundary 1G, primary containment 10A an outside face, from top of base slab 27 elevation, annex building 11, to foundation base footing 10C enclose Regions 3 boundary 1G. Tubular, reinforced structural insulation 7 known in the art bolsters reactor vessel shield wall 2.

Annex building 11 surrounds primary containment 10A wall outside face and Regions 1 portion that comprises primary containment 10, Regions 1 portion, including a refueling channel and an outside face of walls and that channel excess hatch and the main excess hatch for primary containment 10A, Regions 1 from foundation 10C to top of floor slab 27, the refueling channel a rectangular cross-section length, height that end with the excess hatch, comprising boundary 2G.

All transducer devices (FIG. 2, 3, 4, 4A, 5 and 5A), excessed and serviced from inside the annex building 11, effect the ultra-transport system hot legs self-aligning and self-configuring by energy of ultimately inline aligned symmetrically configured the high energy piping two primary loops 3 secondary loops two hot legs 3A 14 13, each with expansion contraction electromagnetic transducer device 14 (FIG. 1A and FIG. 5, 5A and 5B). These high energy piping lengths, by high energy flowing straight line and away from acting inflow outflow effects, oppose any changes to maximally straight alignments, assisted and controlled by electrical power and guided by precise predetermined displacement vectors and in situ extensometers measured and cameras monitored.

Summary of the Inventions explain the predetermined displacement vectors effect energy of the minimal energy displacement, the minimum energy balancing, in situ displacement vectors magnitude measured and monitored. The transducer devices 14 effect hot legs 3, 3A 14 13 axial displacement energy nigh 2000 psi, granted by all of the transducer devices, which is 1/10^{th} of the prior art grated, precluding composite constructions all stress concentrations exigent interactions.

Floor slab 27, here, based on two steam generators (SGs) 8 configuration, comprises two equipment access hatches 17, for each compartmentalized building 11, SG 8, steam line 3A, SG 8 globoid 8B, structural insulation 8C, two braces 9C, and removable ring strut 17A. Two solid rubber tire carts 11A effect means for moving and locking each to floor 12 surface and attaching the carts to at least two steam line 3A disk stiffeners; high pressure nozzles 13 embody means for sustaining quality steam and pressure; and in annex building 11 trust blocks 8A and 8C and SG 8 base plate 9 (FIG. 4) transmit steam line 3A loads to foundation; as needed, shim plates welded to wall inserts steel 15 32 embody two parallel and even surfaces perpendicular to pipe spool 42.

FIG. 1B shows containment building elevation half sectional view orthogonal to FIG. 1A sectional elevation view 10A 10B, base/footing foundation 10C, in two turbine buildings 21 configuration; foundations 10C 25 comprise Teflon plate, between stainless steel plates 18, bentonite packaging in sheets on top of compacted sand backfill 19, spaced stainless steel cables elastomeric bearings 20 in stainless steel ducts 20A, retaining wall 26 24, structural backfill 23, and clay layer 21 seal.

FIG. 2 shows a half sectional elevation view generally taken about a vertical symmetry plane thru respective containment wall penetrations device 4 4A, which seals high energy piping 3 3A, with these parts: pipe spool 42, inorganic fullerene (IF) coating 81 on outer diameter surface, effects a torsional and axial slip thru a wall and sleeve 30; flange 34, counter flange 41; two annular disks 45 with inner diameter surfaces coating 81 negative tolerance fit, fit over pipe spool 42; six faces annular structural insulation spacer 31; two structural insulation backings 35 in backing rings 38 38C; and two bolt or stud assemblies 36 thru backings insulation rings 35, flanges 34 41; and two fluid lines 39, branches 37 completes the parts list; the parts comprise machined complement of completely matching surfaces. Backing rings 38 comprise concrete embedded steel plates and backing rings 38C weldments to containment 10A liner 15. Assemblies 36, 2-rows, 10 bolts in a row comprise: a bolt or a stud, a spring, a washer at each end of the spring and a locknut for each nut; flange 34, one disk 45 and insulation backing 35 bear on inner face, while counter flange 41, the other disk 45 with insulation backing 44 bear on the insert plate and that wall outer face, seal respective wall penetration 4 4A by assemblies 36, springs 36A post tensioning means; said parts precisely fabricated surfaces thermal and negative tolerances pre-stressed are assemblies 36 post-tensioned; sleeve 30 penetrates steel reinforced thick concrete wall, with each end groove welded to insert plates 38, or liner 15 and insert plate 38, effectuating two parallel even surfaces. Flange and counter flange inner faces, coated with IF MoS₂ or WS₂, bear respectively on IF coated disks 45, 3-disk grooves 37; disks inner face bear on insulation backings 35 44 against each face of the wall penetration, effectuating wall's positive seal around perimeters of penetrations. This device further comprises three concentric grooves 37 in outer face of disks 45 and two concentric circles of assemblies 36 staggered bolt holes thru spacer 31, disks 45 and thru flange 34 and 41 which in outer faces are countersunk. Said assemblies 36 through said insulation spacer, disks, flange and counter flange with the washers, in compression under torqued nuts affecting said parts assembly that bears on insulation backings 35, seals assembled parts perimeter; assemblies 36, countersunk bolt-holes and washers caulked and pressurized seal the device in assembling of parts. Three 37 concentric groves, clear of the bolt holes, are lubricating turbine paste packed and pressurized by force of gravity. Said lubricating turbine paste seals grooves, in mutually opposing lubricated IF surfaces, sealing high energy piping loop radial thermal movements along IF lubricated surfaces. Shim plates welded to liner 15 and insert plate 32 insert plates 32 (4A) yields means for affecting two flat, parallel surfaces, which are orthogonal to said pipe spool 42. The thick wall, annular insulation cylinder 31, including machined precisely all surfaces and assembly 36 holes disposed longitudinally on concentric circles, presses against insulation backings and opposing flange 34, counter flange 41, under bolts (studs) tensioning; the bolts (studs) pass thru spacer bolt-holes and provide for space gaps 43, from spacer 32 to steel sleeve 30, affecting the device granted internal radial displacements. Flanges 34 41 and disks 45, with 5-10 nanometers IF embedded coating on machined surface of inside diameters, are heated to high temperatures and slid over spool 42 cold length, comprising machined outside diameter and the IF surface coating, and cooled disposed in respective positions; one of the flanges and its disk is shop pre-stressed with the other flange and disk field pre-stressed into place. Imposed thermal pre-stress force-fit yields hoop stresses. Said flange, counter flange, disks and spool, with said inorganic fullerene solid lubricant slips surface, constitute said device sealed wall penetration 4 4A that grants axial-radial displacements thru the device; between insulation backings in a tight fit, spacer 31 is free of high stresses; assemblies 36 bolt-holes short upwardly slots grant reactor vessel and piping loops' centerlines thermal vertical displacements. Thermal expansions biaxial compressions additively seal wall penetrations 4 4A.

Disks 45 bearing either on structural insulation 35, liner 15 or insert plate 32 seal surfaces around wall penetration 4 4A; backing ring 38C, 38 welded to either liner 15 or insert plate 32 comprises outstanding edge bent radially inward into a lip, which confines insulation backing 35 and flange 34 or counter flange 41, imposing structural insulation backing ring 35A bearing surface allowed thermal gaps 43A in the disks, flange and counter flange; insulation backing ring thickness entire surface bears on backing ring 38C or 38 and blocks a slip of insulation ring 35 inside the backing rings, while liner 15 and insert plates 38 radially matching tongue and groove 44A precludes any rotation of insulation backing 35 and permits disks and flanges radial movements granted by gap 43A; at operating loads, insulation backing rings 35, backing rings 35A confine disks 45, counter flanges 41 and flanges 34; each backing ring 35 inverted L-shape is fillet welded on both sides to liner 15 or the insert plates, as a wall penetration backing rings 38 38C pipe restraints—backstops. Cold return legs of primary coolant loops 3 comprise assemblies 36 oversized bolt-holes vertical slots sealed by pressurized caulking under oversized washers; that grants reactor vessel 1, upright steam generators 8 comprising loops cold legs return 3 radial and upright movements allowed by gaps 43A, in addition to upright, axial-radial thermal movements 43 and 43A in loops 3 hot legs. Piping penetration 4, 4A operating temperature thermal expansions force disks 45 and flanges 34 closing of gaps 43, 43A, which forces spool 42 loads transfer to backing rings 38C, 38; thru rings 35 disks 45, turbine paste-fluid lines 40 lubricating seals grooves 37 and interfaces of flanges 34, counter flanges 41 and disks 45, internals of containment wall penetrations 4 4A, where precision fabrications of complete compliments of surfaces, lubricating turbine paste-fluid surfaces in-wall axial pre-stress, thermal and negative tolerances pre-stress in mechanical assemblies and thermal expansion innate biaxial compression effect positive sealing of all containment wall penetrations.

FIG. 3 shows a half sectional elevation view generally taken about a vertical symmetry plane thru high energy piping 3 3A respective containment wall penetrations 4 4A, with the FIG. 2 exchange of spacer 53, for spacer 31; electromagnetic turbine lubricating fluid, instead of lubricating paste-fluid, with fluid lines 51 39; electrical power line 50, into electromagnets 47, with counter flange 41C, flange 34C, disks 45C, backing insulations 35C, backing rings 38C 38, IF surfaces' coatings 81, bolt assemblies 52, and spacer 53 inside diameter with spool 42 outside diameter at operating temperate precise tolerance fit, soft-iron tube 49 embedded in outside diameter with thermal gaps 43B, at retainer disks 48; wherein illustrated, detailed, enumerated and described parts—precision fabrication surfaces complete compliments thermal and negative tolerances pre-stress and in-wall axial pre-stress and thermal expansion innate biaxial compressions embody completely matching complements of mechanical assemblies with electromagnetic assemblies of two ironclad, annular housing electromagnets 47 embedded in structural insulation 35G; fireproof electrical power line 50; electromagnetic fluid supply line 51 branches 39 and concentric grooves 37; electromagnetic and mechanical assemblies constitute in-wall device electrical power means for magnetizing the assemblies and modulating electromagnetic fluid bulk modulus moduli as means for allowing the fluid three directional displacements to grant high energy piping means granted three directional vectorial movement into least stressed disposition thru the wall penetration—attaining the piping means for high flexibility to high rigidity support stiffness; device modulating electrical power to electromagnets, in response to piping stresses extensometer readings, affects the support stiffness granting piping innate movements to low stress dispositions and the penetration seal redundancy; FIG. 3 electromagnetic supply line 51 ties-in into pressurized electromagnetic fluid tank; entirely symmetrical lower elevation view has supply line 51 return to the tank. Iron filings, said turbine paste-fluid amalgamate embodies means for achieving electromagnetic fluid preferred stiffness.

FIG. 4 shows a cross-sectional elevation view taken generally about steam generator 8, base 9, or high-pressure pump 5 (also turbine 21, a generator) in symmetry plane of structural steel support leg 80 entirely rounded thick base plate 79, on elliptical bearing plate 78 and identically elliptical structural insulation plate 76 and stainless steel plate 77, completely bound by elliptical structural insulation rim plate 77A, with stainless steel rim plate 85 anchoring at each support 80 respective in-situ elevations 86 floor elevations 82 that keep high energy lines 3 3A optimally level. Plates 76 77 78 bear on rim plates 77A 85 upwardly extension which positively confines each plate and bounds granted movements of plate 79 over plate 78, along IF coated surfaces interface 81. Plate 79 includes at least four machined parallel channels 88, embodying support 80 vectorial direction thermal movements under operating loads. At least four threaded studs 90, one stud per channel, comprising egg shaped endpoint 88B threaded through its threaded hole in pin arm 89 presses on each of channel 88 grooves, locked by washers, nuts, locknuts and reverse thread lock nuts. Arm plates 84 are welded to plate 85, radial stiffeners 87; channels 88 and studs 90 and endpoints 88B restrict plate 79 movements to channels 88 said vectorial direction; at least two pairs of plates 84, symmetrical about leg 80, welded to plate 84A and plates 82, effectuate further leg 80 anchoring. Plate 79 embodies contact surfaces IF coating 81, with machined 85A, drilled 37 lubricant access paths; electromagnet 83 ironclad housing embodies weldments to plate 85 to stiffeners 87; inside electromagnet 83 electromagnetic fluid, the fluid, covers plate 79, in mechanical electromagnetic complete complements assemblies embodying high energy piping configuration, equipment base plates symmetrical about reactor vessel and turbine-generator upright plane of symmetry; in such configuration, displacements and loadings as affected force are transmitted, in symmetry plane of said configuration, and lateral loadings balanced and bounded within piping walls and equipment casings and upright loads balanced by piping and equipment weight and loads transmitted to base plates; the base plates in-situ elevations are set for high energy piping horizontally optimal routes spawning said plane of symmetry. Electromagnetic assemblies electrical power input effectuates means for modulating the electromagnetic fluid stiffness moduli and bulk modulus that comprise means for dissipating large portions of thermal, static, and atoned static portion of dynamic loads by the assemblies granted movements; remainder small portions of the loads, except for the fluid further atoned dynamic loads portion, within magnetized elasticity range of said fluid, are passed to structures, comprising means for preferred stressing of structures; the fluid inelastic deforming atones the dynamic loads oscillating amplitude short duration peaks portion, by dissipation of the peaks, in dynamic loads damping dissipated peaks as such fluid affects its return to elastic range; wherein, electromagnetic fluid creep affects and attunes the base plates granted major axis creep; the fluid brief excursion into inelastic range is artificial; it is controlled by extensometers, which monitor displacements with power supply sustained means for raising the fluid elastic range with means for raising fluid stiffness; displacements of base plates in the plane of symmetry effectuate movements in that plane of symmetry only granted transverse lateral infinitesimal displacements; symmetry orients major axis of the elliptical plates in the plane of symmetry, affecting horizontal force vector in that plane; pressure pumps 5, one on each side of SG, affect resultant force in said plane of symmetry, for skewed major axis vector sum in that plane. Plate 79 round forms sliding surfaces yield least interfacing areas; square and rectangular plates 79 are likewise contemplated. Minor axes of plates 77A 85 only permit plate 79 grated movements in and along the major axis.

FIG. 4A of FIG. 1A shows a cross-section elevation view generally taken thru symmetry plane of electromagnetic and mechanical complete complements assemblies of bracing devices—for SG 8 upper end of steam line 3A (FIG. 1A); electromagnet ironclad housing 83B welded to radial plate stiffeners 87A, about housing 83B perimeter; the stiffeners, housing welded to floor insert plate 38B around floor opening, floors 12, plate inserts 38A and trust block 38C; steel ring spacers 9A 9B IF surfaces coatings 81; thermal gaps 43A 43B; structural insulation: ring plate 35C, and ring plate 35A—covers of floors 12 opening inside radial stiffener plates 87A, globoid 8C, ring flange 35G; two SG8 four braces 9C welded to hatch 17 frame, eight for trust blocks 38C high energy piping 8 (FIG. 1A) (shown brace is behind SG 8); welded dishes 9D, braces 9C ends' backstops comprising ring 35E; thermal gaps 43A; and structural insulation drip pan 8G. Plate inserts 38A, around SG 8, of floors 12 and trust-blocks walls 38C 8A (FIG. 1A), support pan 8G, flange 35G, and stacked plates 35A 9B 35C 9A. Structural steel framing at trust-block 38 comprises welded plates into Flange 35A welded to plate inserts 38A. Said symmetry plane embodies turbine 21, reactor vessel 1 centerlines symmetry plane. Plates 35A 9B 35C 9A as spacers comprise thermal expansion respective gaps 43A 43B with plates 35A 35E bearing on flange 35G, with the stacked plates 35A 9B 35C 9A in polar direction bearing on flange 35G effect radial displacements, only. Housing 83B and the staked plates and pan 9D, as the assembles prefabricated sets and parts, are lowered in place in half sections and welded, with housing 83B only comprising upper and lower welded section and abutted casings welded, enclosing electromagnetic coils. The coils are wired in parallel, cable circuits to electrical power source. Such electromagnets are preferred, although one wire electromagnetic assemblies are simpler; the fluid fills housing 83B inn annular; the complete complements assemblies of bracing devices embody high energy piping displacements; Said assemblies, in-situ configurations, are set for high energy piping horizontally optimal routes affected in planes of symmetry. Electrical power input to electromagnetic assemblies effectuates means for modulating the electromagnetic fluid stiffness moduli and bulk modulus that comprise means for dissipating large portions of thermal, static and atoned static portion of dynamic loads, by the assemblies granted movements; remainder small portions of the loads, except for the fluid further atoned dynamic loads portion, within magnetized elasticity range of said fluid, are passed to structures, comprising means for preferred stressing of structures; the fluid inelastic deforming attunes the dynamic loads oscillating amplitude short duration peaks portion by dissipation of the peaks, in dynamic loads such damping dissipated peaks the fluid effects to return to elastic state range; the fluid creep attunes the braced member granted elastic movement finite displacements. The fluid brief excursion into inelastic range is artificial; finite to infinitesimal displacements are monitored extensometers and cameras; power input comprising means for raising the fluid elastic strength and stiffness; plates 35A 9B 35C 9A symmetry in said symmetry plane grant very small total movements and in that symmetry plane transverse displacement no more than infinitesimal.

FIG. 5 shows a wall thickness symmetrical cross-sectional elevation view generally taken through centerline, in upright symmetry plane, of precision fabrication, thermally and negative tolerances pre-stressed, steam lines 3A expansion and contraction device 14 (FIG. 1A), and turbine building 21A direction spool 71A to which three spools 74 are successively butt welded—spools 71A 74 outer assemblies—effectuating three inside diameters. Precision, negative tolerances, fabricated two outside diameters of spool 71 and three spools 71B successively butt welded—spools 71 71B inner assembly. Sleeves 73 in centric portions of spools 71 71B in negative tolerance fit are fillet 75A welded both ends; spools 71 71A identical negative tolerance pre-stress engenders the inner, the outer assembly negative tolerance pre-stress and thermal pre-stress added, in entire device 14 pre-stressing fabrication and assembly; spools interfacing surfaces of inside, outside diameters cylindrical surfaces 81 embody interfacing coatings of embedded inorganic fullerenes (IF), MoS₂ or WS₂. Spool 71A constitutes an obtuse angle with a barely sharper angle precision machined a smooth surfaces transition to two larger diameters comprising total effect presses with lead spool 71 and that spool and sleeve 73 whose machined weld 75A matches precisely said barely sharper angle surfaces in device 14 fully closed position and in fully open position comprising entire gap 70. That gap is matched by gap 70, shown in closed position in FIG. 5B, wherein the other of the two smooth transition surfaces matches precisely rim bevel of lead spool 71—with exceptions of a rounded point of spool 71 and spool 71A, first of said two smooth transition surface, comprising the obtuse angle long fillet leg into inside diameter surface. The exceptions, with otherwise fully matching gap 70 surfaces complete compliments, at gap closure, engender suction which induces closing of the device. Spool 71C gap 70 comprises spool 74 and backstop 38A entirely matching interface square ends detailed in FIG. 5A; spools 71B, 74 comprise respective butt welds 75C, 75; the device said fabrication is known in the art; compartment between sleeves 73, and at backstop 38A are pressure filled with electromagnetic fluid through respective portals 51A, 51B, shown as capped; in operation eight portals connect through fluid pressure lines to fluid supply pressurized tank which provides means for circulating the fluid when granted by four electromagnets entirely equal spaced around the device, each entirely horizontal in the upright symmetry plane of reactor vessel 1, turbines 21. The electromagnets anchored in suspension, with ample separation around device 14 effect inline two separate coaxial assemblies. The electromagnets comprise small disk abutting cylindrically oriented coils equal spaced axis, pointed at and equidistant from the spools embedded in in insulation half sleeves. Said coils, in parallel circuits are fireproof cable wired to a power source. In-situ configurations are set for high energy piping horizontally optimal routes effectuating the symmetry plane; electrical power input to electromagnetic assemblies effectuates means for modulating the electromagnetic fluid stiffness moduli and bulk modulus and comprise means for dissipating large portions of axial thermal, static and atoned static portions of dynamic loading in horizontal plane, by said assemblies permitted slow creep movements in reactor vessel and turbine upright plane of symmetry; remainder small portions of the loads, except for the fluid further attuning of dynamic loads portion within magnetized elastic range of the fluid, are passed to structures, comprising means for preferred stressing of structures; the fluid inelastic deforming attunes the dynamic loads oscillating amplitude short duration peaks portion by dissipation of the peaks, in dynamic loads damping dissipated peaks as such fluid effects its return to elastic range. Electromagnetic fluid creep stiffness effects and attunes allowed slow elastic creep in the device. The fluid brief excursion into inelastic range is temporary, extensometers and cameras monitored displacements entirely controlled by power supply effectuating means for raising the fluid elastic limit and increasing stiffness; said coaxial symmetry in the symmetry plane allows the symmetry plane displacements axial movement only, and laterally no more than infinitesimal displacement. Thermal, static and dynamic loads stiffness granted optimal slow creeping in the symmetry plane from reactor vessel 1 to turbines 21 measured by cameras, extensometer readings optimally grant high energy piping loops, base plates and bracings effectuated preferred stressing, displacements.

FIG. 5A illustrates a section view not to scale thru device 14 symmetrical half portion in respect to a longitudinal axis of a backstop assembly enumerated and described toward the end of FIG. 5. FIG. 5B illustrates a section through device 14 closed position with fillets described FIG. 5 shown.

Electromagnetic wall penetrations, base plates, bracings, and expansion and contractions devices function in response to strategic extensometers readings in high energy equipment slow creeping; structures of the devices and confined fluid stiffness—elastic, shear, and bulk moduli spawned by power input into electromagnets preclude well within elastic strain range spurious displacements.

Each device functions in high energy piping loops slow creep in the symmetry plane, comprising electromagnetic means for locking piping system into maximal thermal, mechanical efficiencies.

1. A super plant absolute technologies, comprising an ultra-transport system energy of fluxing total displacements embodied in electromagnetic fluids creep stiffness, cycle bulk power ultra-cycling light fluids by cosmological global gravitational dynamics conforming nullities, energy relativity structures, a relativity energy, a minimum energy balancing, a minimal energy displacement and:
a reactor radially inline to steam generators (SGs), primary coolant loops piping hot legs to the SG, cold legs return portions inside a primary containment, comprising Regions 1;
the reactor, primary coolant loops piping Regions 1, radial inline hot legs from the SG to turbines, condenser units to the SGs, secondary coolant loops cold legs return, Regions 2;
a containment, an annex building a light negative pressure, Regions 2 portion, Regions 3;
cooling water cycling gravitational sink, the hydrosphere, mega bulk power in Regions 4;
and bulk power electrical distribution and epigene environment cycled energy, Regions 5; and means for opposing global air warming, effecting Heat Rate maximum efficiencies of the ultra-transport system and Regions 1-5 ultra-longevity boundaries an ultra-fluxing, an ultra-conserving the bulk power, the mega bulk power sustaining a boundaries perfection.

2. The ultra-transport system according to claim 1, comprising the primary, the secondary high energy piping coolant loop, cycling the bulk power ultra-cycling light fluids' nullities, effects the interactions energy, the relativity energy, the minimum energy balancing and the minimal energy displacement, which unify and bolster overall integrity of the ultra-transport and all of Regions 3.

3. The super plant absolute technologies according to claim 1 wherein Regions 1 and 2, the radially inline piping hot legs controls a self-alignment of the ultra-transport system by wind cone effects granted electromagnetic fluid a creep, a stiffness, displacement response to electrical power input granting the creeping, the stiffness by the electromagnetic fluid in an electromagnetic transducer, the minimum energy balancing of the relativity energy, and the ultra-longevity of the super plant.

4. The displacement response to electrical power input according to claim 3, comprising the fluxing total displacements, effecting the minimum energy balancing of the relativity energy, by spawning the stiffness in the electromagnetic fluid nigh infinitesimal confined creep yield the ultra-longevity of the super plant, the ultra-transport system by effecting dynamic loads damping.

5. The fluxing total displacements according to claim 1, wherein the ultra-transport system comprising the minimum energy balancing of the relativity energy retain low static stresses and dampen, to entirely suppress, dynamic loads by the electromagnetic fluids stiffness and creeping which grant Regions 3 structure the ultra-longevity.

6. The super plant technologies according to claim 1, comprising the relativity energy in Regions 3 comprising displacement energy above the minimum energy balancing, the minimal energy displacement relative sum, which the calibrated electrical power input continually retains.

7. The ultra-transport system, the super plant technologies according to claim 1, comprising the minimum energy balancing, the relativity energy, Regions 3 bulk power, Regions 5 meg bulk power energy transfers flux the ultra-conserving, the ultra-longevity in the boundaries perfection, including electrical energy, in the ultra-longevity, the ultra-conserving Earth's gravitational field.

8. The self-alignment of the ultra-transport system by wind cone effects according to claim 3, comprising the self-alignment spawns absolutely highest energy conserving in the ultra-transport system Regions 3 and engenders absolutely highest Heat Rate mechanical, electrical efficiencies.

9. The super plant absolute technologies according to claim 1 yield the light fluids the ultra-cycling by the cosmological global gravitational dynamics conforming nullities to energy of fluxing total displacements embodied in electromagnetic fluids creep stiffness, the energy relativity structures, the relativity energy, the minimum energy balancing, the minimal energy displacement, the ultra-longevity boundaries, the ultra-fluxing, the ultra-conserving mass energy yielding the boundaries perfection and means for opposing global air warming comprising PMII, FEIIPMII technologies.

10. The super plant absolute technologies according to claim 1 yielding closed systems clustering in the ultra-longevity boundaries embodies the minimum energy balancing and the relativity energy relative fluxing effected by the electromagnetic fluids stiffness, creep, and volume change energy effecting optimally least stresses, strains Regions 3 structures and the ultra-longevity boundaries.

11. The super plant absolute technologies, the ultra-transport system according to claim 3 wherein the ultra-transport system heat energy ultimate transferring by the electrical power input into the transducers, by the minimum energy balancing, the minimal energy displacement, aligning of the ultra-transport system effects the light fluids highest rate cycling, ultimate efficiencies Heat Rate, effecting equal opposite reaction least energy flow from the transducers into Regions 3 structure.

12. The super plant according to claim 1, engendering energy self-structuring genres of the light fluids, the super plant effect by the electromagnetic fluids nigh infinitesimal creep, in small total movement associated with optimal stiffness that configures the ultra-transport system.

13. The cooling water cycling according to claim 1, wherein aqueduct lengths embody the First Fluid Element cross-sections optimal radiation energy transfers by gravity mass energy highest conserving cycling to close potential energy differences between gravitational sink portions and precipitations, condensates, the light fluids flow cooling, epigene crust fluids cycling.

14. The cycling gravitational sink, the hydrosphere, mega bulk power according to claim 1, wherein the Heat Rate maximum efficiencies useful energy transfers effected in the tropopause, troposphere energy action effects useful reaction inside the magnetosphere energy reaction to the EESD, the cosmological global gravitational dynamics magnifying the super plant useful energy.

15. The ultra-transport system according to claim 1, wherein the ultra-transport system cycling the bulk power in the primary, the secondary piping loops and the electromagnetic fluid transducers yield Regions 3 wall penetrations, bracings, and base plates radial, polar and vertical displacements with Regions 3 expansion contraction devices controlling radial, polar and vertical strains radial displacements, comprising Regions 3 polar, vertical, radial respective strains, displacements the containment and the annex building maximally low stresses.

16. The reactor vessel, the hot legs and the turbines according to claim 1, comprise vertical plane symmetry and that plane thermal, static and dynamic loads and displacements symmetry, as well; the electromagnetic fluids electromagnetic devices confine displacements in that plane symmetry comprising vectorial sum in, infinitesimal vectorial transverse sum to that plane. In that plane an axial displacements expansion and contraction devices, the transducers, govern effecting Regions 3 composite construction displacements by the transducers, the Heat Rate maximum efficiencies, with the ultra-longevity and the ultra-conserving in the ultra-transport system and the super plant.

17. The super plant according to claim 1, comprising'a shallow, at grade water retention dish, a stainless steel plate shell structure below grade, embodies water capacity requirements, structural integrity which comprise stainless steel ribs, grade beams, diaphragms and heavy traffic roadway structural subgrade construction, to withstand seismic events energy; the beams, diaphragms, and ribs comprise cutouts which facilitate conformance to laminar flow rates in all instances, verified in hydraulics laboratory; wire reinforced liner enveloped field spliced fiberglass sheets surrounds the shell as a protective cover. Gravity flow, from closest aqueducts location, keeps the dish full, comprising a rare event piping means, shutoff valves, positive controls at all pipe ends inflowing, outflowing water circulations within annex building compartments, and gravity flows flooding of the primary containment; the super plant ancillary construction and berms known in the art shield positively all such piping. The structural integrity, the subgrade effectuates means for supporting mechanical cooling towers' means for effecting the super plant's essential cooling in rare events.

18. The super plant, according to claim 3 comprising a dome floor slab of the primary containment hermetically seals equipment access hatches, above each of the SG; hermetical seal of the access hatches are known in the art. Unbounded longevity of said super plant and the hatches effectuate primary containment polar crane access into the annex building compartments comprising means for replacing, refurbishing the SGs thru the annex building hermetic sliding doors and removable panels; the hatches comprise multiple access means for robotically removing reactor vessel parts.

19. Regions 5 cycling energy in environment according to claim 1, comprising thin, insulation thickness, mostly circular diameters or substantially rounded stacked sheets randomly concentric, nonconcentric, entirely flat surface on each side, stack as book pages of diverse sizes. The sheets generally embody cutout voids along with straight, nigh straight printed circuits, in both faces. A straight or nigh straight printed circuit terminates in a printed connecting to a sheet above, below, or above and below, or connects to any electrical component along a perimeter or on top or under a protruding sheet, a sheets stack, or sheets stacks respective sizes protruding portions or residing in a cutout void or cutout voids; the sheets embody a circuit board or a mother board configuring said electrical components and the cutout voids comprising fluid ducts; the sheets and the printed connecting fuse positively; stacking the sheets stacks the fluid ducts; innate, innate and forced, or innate, induced and forced, or innate and forced and induced once a flow thru cooling an ultimate cooling effect the circuit board or the mother board steady, absolute highest Heat Rate efficiency, yielding concomitantly the ultra-conserving of electrical, the flow thru cooling respective energy.

20. The circuit board, the mother board according to claim 19, comprising an electrical device or the printed circuit, the fluid ducts each cross section relative configurations, spacing dispositions, energy technologies effects a computing algorithms concomitant modeling electric current, ducts fluid thermal radiation outflow energy flowing and the printed circuits and fluid ducts parameters and cross-sections of a prototype. Useful, consumed energy ratios, maximum sums sum set forth the Heat Rate of the circuit board, the mother board and the electrical device, respectively; innate and/or transistor temperature switches turning on-off ventilation fan or fans housed in a manifold or manifolds along respective perimeters of the circuit board, the mother board, and the electrical device yields the ducts fluid flow rate relative to electrical current, engenders a PMII technology.

21. The light fluids and cooling water cycling Regions 1-5 according to claim 1, comprising aqueducts underground lengths engender the EESD environment beneficial, useful energy, which boosts gravitational field strength, magnetic field strength and the light fluids cycling rate, which boosts the boundaries perfection of the energy relativity structures and the magnetosphere, which blurs distinguishing byproduct from product that produces millennia electrical power abundance.

22. The super plant absolute technologies according to claim 1, comprising Regions 4 aqueducts underground lengths, the aqueducts underground lengths, with First Fluid Element cross-sections yielding the MEHC absolute conserving, conforming to PMII, FEIIPMII technologies, the PMII, the FEIIPMII technologies effect principles and methodologies, which connect into cosmological global gravitational dynamics energy, the cosmological global gravitational dynamics, and global insulation, the solar insulation, respective energy, yielding means for connecting all such energy.

23. The super plant, the ultra-transports system according to claim 19, comprising cycling environment energy Regions 5 energy shunt, the energy shunt, including thermal radiation from Regions 1, 2 and 3 to Regions 4 and 5, cycles MEHC absolute conserving energy, the cosmological global gravitational dynamics boosting the boundaries perfection of the ultra-transport system, epigene surface, the super plant, the energy relativity structures and magnetosphere boundaries relatively, respectively; the energy shunt taps into the cosmological gravitational dynamics, the light fluids cycling energy inside the boundaries perfection aforesaid boundaries, from the ultra-transport system to the magnetosphere boundaries, which sustains, boost thermal energy radiating into space, into gravitational sink and concomitantly generates abundant electrical power which ultimately opposes global air warming.

24. The Heat Rate maximum efficiencies useful energy transfers according to claim 14, comprising useful energy transfers effected in the tropopause, troposphere comprise electrical power cycling electrons perpetual fluxing at or higher than Heat Rate 100% efficiency, yielding applied science God particles conservation of environment and the gravitational and the magnetic field strengths.

25. The super plant absolute technology according to claim 1, comprising applied science PMII, FEIIPMII technologies—the PMII, FEIIPMII technologies—and an MEHC absolute conserving—the MEHC absolute conserving of the light fluids cycling Regions 5 embody a max conductivity, the max conductivity to ultimately interconnect, couple and balance the Earth's gravitational sink and the tropopause, troposphere cycled energy and to oppose global air warming in time domain.

26. The super plant absolute technology, the ultra-transport system according to claim 1, comprises the bulk power ultimately aligned routing Regions 1 primary coolant loops, Regions 2 secondary coolant loops, Regions 3 ultra-conserving, ultra-longevity energy cycling, effecting no emission to environment, affecting Regions 4 energy relativity structures max conductivity in the light fluids cycling into gravitational sink and effectuates Regions 5 electrical power distribution.

27. The super plant absolute technology, the ultra-transport system according to claim 1, comprises the bulk power ultimately aligned routing Regions 1 primary coolant loops, Regions 2 secondary coolant loops, Regions 4 cooling water cycling in underground aqueducts lengths and from cooling water source locations to an outflowing affecting Regions 4 portion of hydrosphere ultra-conserving, ultra-cycling max conductivity Region 4 cycling bulk power, into gravitational sink, energy relativity structures in gravitational field cycling, conforming to climatological data.
